(19) United States
(12) Patent Application Publication
(10) Pub. No.: US 2009/0289780 A1
(43) Pub. Date: Nov. 26, 2009

(54) SenCora print system

(76) Inventor: Danette Sue Tenorio-Fox, Mc Donough, GA (US)

Correspondence Address: Danette Sue Tenorio-Fox, 540 Gables Court, Mc Donough, GA, 30253, US

(21) Appl. No.: 12/074,201

(22) Filed: May 21, 2008

(51) Int. Cl. B60Q 1/00; B60R 16/00

(52) U.S. Cl. 340/425.5; 280/727

(57) ABSTRACT

This invention relates to a system that allows senor attribute detections such as fingerprint detections, weight, height, heart rate, breathing and door counting activities of occupants seated with in a private vehicle and as being located in any position of private vehicle including the trunk area have their human attributes detected and more particularly have their human attributes transmitted directly to observing parties such as policing units and or governing authority units for observance of such attributes without the manipulated participation of the private car vehicle. This observance of human attributes from with in private vehicle will aid policing units and governing authorities the ability to observe and possibly identify each human with in the private vehicle without first approaching the vehicle. This system in whole is identified as SenCora Print System and allows real time or delayed time observance of human detected attributes.

### CROSS REFERENCE TO RELATED APPLICATION

Not-Applicable

### STATEMENT REGUARDING FEDERALLY SPONSORED RESEARCH AND DEVELOPMENT

Not-Applicable

### REFERENCE TO SEQUENCE LISTING A TABLE OR A COMPUTER PROGRAM LISTING COMPACT DISC APPENDIX

Not-Applicable

### BACKGROUND OF THE INVENTION

1. Field Of Invention

This invention relates to automobiles and in particular to a system and method for the detection and transferring of sensor detected attributes of occupants seated in any position of the automobile including the trunk of the vehicle. This invention includes the system of transfer of personal sensor detected attributes from with in personal occupied vehicles to governing authorities and policing units. The approximate weight, height, heart rate, breathing detections, fingerprint detection and door counts can be detected and transfered sensor attributes, transmitted and further obtained by policing units and or governing authorities are obtained with out first these out side inities approaching the vehicle. This invention solves a manifold of current public related problems such as allowing policing officers the ability to identify the exact seating, weight, height, heart rate, breathing detections, fingerprint detection and door counts to be available to the policing officer with out first that policing offer approaching the vehicle under observation. It is to be further considered that with the world community shrinking by way of travel, communications and speed of light computer transfers, interacting with in its self on a intricate technological level this invention and its timing will prove to serve as a means to more closely identifing attributes of world guest who may choose to use vehicle and transportation modes as means to comit crimes in one region while relocating them selves to a different region with hopes of not being detected. This current art is drawn towards as to provide a means to policing officers on patrol to identifiy if it is hazardous or reasonably safe to approach an occupant vehicle.

The current invention relates to automobiles and in particular to a system and method for the detection and transferring of sensor detected attributes of occupants seated in any position of the automobile including the trunk of the vehicle. With in the scope of the current art it is to be understood that the following terms and descriptions are used to clarify, describe and articulate the process and intended usage of the current art. Such terminology as, Q1 Occupant Vehicle (identified as 1 in drawing description or depiction) comprising as to be housed internally of Q1 Occupant Vehicle, commonly referred to and described as set forth throughout the description of the current art as containing components consisting of SA location, also known as 100 Sensors A Finger Print Detection means, SB location, also known as 110 Sensor B Weight Detection means, SC location, also known as 120 Sensor C Height Detection means, SD location, also known as 130 Sensor D Breathing Detection means, SE location, also known as 140 Sensor E Heart Rate Detection means and SF location, also known as 340 Sensor F Door Counter means, as well as MZ locations, also known as 150 Micro Controller Node A Finger Print, 160 Micro Controller Node B Weight, 170 Micro Controller Node C Height, 180 Micro Controller Node D Breathing, 190 Micro Controller Node E Heart Rate, 777 Micro Controller Node Z Door and 350 Micro Controller Node Z Engine Battery, With in the scope of the present invention are compents of delivery that function as to further incorporate the current invention described as, Door Jam (also identified as 14 with in drawing description) and Door Jam (also identified as 17 with in drawing description), I 7 location, also known as 250 Item 7 Central Storage and Processing Unit means, PCB location, also known as 210 Power Control Box means, BuB location, also known as 323 Back Up Battery means, EHWE location, also known as 200 Electrical Highway Wire means, 101 location, also known as 203 Ignition On, Ignition Off Over Ride means, a second system as such described as Q1 Occupant Vehicle (also identified as 1 with in drawing description) as well as an additional complete SenCora Print System located with in Q2 Policing Vehicle (also identified as 2 with in drawing description). Comprising as to be utilized by the one same present invention is an undetermined number of 330 S2 Transmission Relay Towers means and 320 S1 Governing Authority Station means.

Thus, my invention being the SenCora Print System will reveal the method and system used to identiy the personal attributes of all occupants who may enter and occupy the vehicle equipped with the SenCora Print System. This system records, store, document and transmits detected attributes of fingerprint and or fingerprint identification numbers detections, heart rate, breathing, approximate height, door activities and pre-programmed biometric information (obtained by each seated occupant) and a system override (feature used only to enhance funtionality and over purpose and use of current art and as to be used in particular circumstances). Override means, that authorities are allowed to disarm the vehicle engine of the SenCora equiptted vehicle containing an IOI location, also known as 203 Ignition On, Ignition Off Over Ride means, in the event of a medical emergency, high speed chase or child abduction the 101 location, also known as 203 Ignition On, Ignition Off Over Ride means can be fully disarmed in order to save lives. This information is then transmitted to policing units who request to obtain the on board vehicle activities or attributes of all occupants requested by governing authorities to be observed in real time or delayed stored time in order to track and trace the path, actions and activities of occupants as they occurred with in the vehicle. In whole the current art identified as SenCora Print System and Method uses sensor detections with in vehicles but these sensor detections and occupant attributes are then made available to policing units and or governing authorities by real time observations and or delayed stored actions as to track and trace prior detected attributes of occupants who may have been in the vehicle. Informational transfers are to occure as deriving from with in the vehicle and then being transferred via transmissions means such as satellite means, radio means and or other means as to transfer detected sensor attributes between a personal vehicle to a policing vehicle or from a policing vehicle to a governing authority station or any combination of the described path of data extraction and reception.

2. Description of Related Art

A wide verity of car detection and communication devices have been developed to transmit data from with in a vehicle to stationary points that provide an added assurance of safety to the occupants of that vehicle.

One prior art introduces hands free in car cellular service, voice recognition, using GPS and Telematrics. Telemetries allows for the use of wireless voice and data systems in a vehicle. This prior art also offers GPS location device equipment with in implemented vehicles. Currently, this prior art and its use of telemetries use a service provider that reacts to situations implemented as being responded by the occupant of the vehicle. This prior art offers engine diagnostics checks and automatic impact crash reporting means as well. Telematrics information was referenced from internet search website location identified as . . . http://www.afromerica.com/columns/neusom/citylights/newtechnologi es.php.

Another prior art is an in car system uses Tele Aid and incorporates GPS location, roadside assistance, on board SOS push button feature, vehicle automatic response center contact that contacts the customer service team in the event the vehicle is being broken into, as well as offers remote control door unlocking service. Tele Aid information was referenced from internet search website location identified as . . . http://forums.mbworld.org/forums/archive/index.php/t-176512.html.

In conclusion another prior art offers the G-Book system providing for GPS, Live Navigation for restaurants and other destinations, informational characteristics such as news and traffic, karaoke music, games and downloadable songs, e-mail, E-commerce, and operator services, driving assist functions, lane deviation alarm, and lane keeping asistance, pre-crash safety asistance, parking assistance and low speed tracking mode. The G-Book system referenced from internet search website location identified as . . . http://news.thomasnet.com/companystory/810721. Reference Specific Problems You involved in the Prior Art which Your Invention is drawn toward.

Police officers of this generation are aware of how deadly a routine traffic stop can be. When approaching vehicles police officers may be facing drivers or occupants of a vehicle who may have a warrant pending or maybe the officer is facing approaching a person or group of persons in an occupied vehicle who may have just committed a serious crime. It also, may be possible that the officer has just approached a vehicle where a passenger in the vehicle is a victim of a kidnapping (such as a small child seated in the vehicle) and the small child is too young to speak for him or her self. In some instances there may be a person in the trunk of a vehicle unaware by the police officer. Although, the reason that the police officer may have stopped the vehicle was for a minor traffic violation the officer would have no way of knowing that a human being was in the trunk of the vehicle, or that the child in the vehicle did not belong to the occupant intruder of the vehicle, or possibly that the vehicle occupant has just committed a serious crime. At times the occupants of the vehicle out of the blue decide they do not want to cooperate with the officer who has stopped them. At that point the life of the officer is in danger at a critical time where there appeared to be a situation that was considered to be under control and of routine procedure. Although, common sense and strong judgment are vital senses that are needed by alert and guarded police officers at all times it has been documented time after time that even this so, called third sense is not enough.

There is a need for police officers of this generation to be offered an edge that will help each patrolling officer know the type of persons they are dealing with even before the officer ever approaches the occupant vehicle. Simple inexpensive technology combined with a non-invasive approach to assessing a routine pull over could save the lives of both police officers and countless numbers of citizens.

Described in the prior art as relates to paragraph [0012] the features offered in selected occupant vehicles such as the G-Book system, live navigation for restaurants and other destinations, informational characteristics such as news and traffic, karaoke music, games and downloadable songs, e-mail and E-commerce are features that add a touch of luxury to the vehicle but does not offer a sense of safety that does not need to be responded by the occupant of the vehicle. The current invention offers the ability of the occupant of the vehicle to simply open the vehicle car door triggering a door open door closed timed and dated recorded action of events. The current invention allows occupant to sit in any position of the vehicle as to trigger weight sensors for the impacts of calculated weight acceptance on booth the car seat and floorboards of the vehicle by pressure applied by the occupant when taking the seated position with in the vehicle. The current invention offers occupant to lean back against the back support of the car seat triggering height detection sensors to detect areas of impact as to be calculated into a perspective height of the occupant leaning back against the car seat back rest of the vehicle. The current invention offers a door handle sensor means located on the outer and door handle regions (but may be implemented with in the interior door handles of the vehicle by perferance of the manufacture), as to receive an applied pressure of Finger Print impression as to determine the identity of the occupant applying the pressure of action. The current invention offers occupant to clip on seat belt mechanism as to allow detections means that detect heart rate and breathing detections from the occupant of the vehicle wearing the seat belt means. As well, the current invention allows an occupant placed in the trunk of the vehicle to have the same described sensor attribute detections occure within the trunk of the vehicle (with the exclusion of the finger print detection and door counter sensor). All the described actions performed by the occupant or occupants entering the vehicle are normal enterance and seated actions taking when entering the embodied vehicle beside clipping on the seat belt as to obtain the attributes of heart beat detection and breathing detection, no other interactive actions are needed by the occupant of the vehicle as to engage in the attribute detection process of the occupants with in the vehicle. The current invention allows for the retrieval, observation and government data comparison of observed attributes obtained by police offers and or government authorities who would assist as to determine an innumerable definition of action impacted occurrences that have occurred or is currently occurring within the vehicle being observed.

Although pertaining to the prior art, live navigation for restaurants and other destinations, informational characteristics such as news and traffic, karaoke music, games and downloadable songs, e-mail and E-commerce additions are implemented with in various types of vehicles and are utilized as both luxury upgrades and safety implied items of securities for occupants, questions of security in respects to our country's citizens and government authorities are still in grave danger of being vonerable to unknown vehicle occupants traveling the streets and highways of the United States of America and the World. Police officers often wonder if occupants of most given vehicles are legal occupants of that vehicle or trespassers in violation of the safety of occupants of such current art equipped vehicles. This question may be more pronounced in the minds of police officers when routine stops are required.

Observing the prior art as referenced to paragraph [0010] introduces hands free in car cellular service, voice recognition, using GPS and Telemetries. However, hands free in car cellular service still offers the following flaws as pertains to the prior art occupants of a vehicle. One, occupant of the prior art vehicle must be able to be located in a position of the vehicle as to be able to reach the hands free cellular unit offered by the prior invention, in the event that there is a hostel take over. Two, if the hands free unit is not willingly manipulated by the occupant of the vehicle as to call out for help, then the occupant of the vehicle may not be able to receive help in time by the customer service department managing the hands free cellular system. Three, occupants of the vehicle may be seated in the rear of the vehicle. In the event an unwelcome intruder inters the vehicle, the un-welcomed intruder may not allow occupants of the vehicle to call out for help. Four, in the event that the customer service department does interject and receive the chance to speak to occupant of the intruded vehicle, the occupant of the vehicle may be coheres by the un-welcomed intruder as to relay and speak only what is coached to them. This of course is a dangerous situation for the occupant of the vehicle to be in, because by saying the wrong word to the customer service representative or the customer service representative saying the wrong words to the occupant in the vehicle, may cause the occupant of the vehicle to loose his or her life by the hands of the panic intruder. Five, if the occupant being in the vehicle is an infant or small child they may not be able to communicate at all with the customer service representative. Although the prior invention may include having a G.P.S. System incorporated in the vehicle, it still lacks the ability offered by the current invention that is to identify the exact human sensor detected attributes of all the occupants seated in the vehicle and transmit these sensor detected human attributes silently (with out conscious manipulation by the occupants seated on the incorporated current art), to a government authority. In addition the prior invention dose not offer the ability offered by the current invention as to allow policing vehicles to scan the Occupant Vehicle or obtain stored or past as well as real time impacts of sensor detected human actions of all human sensor detected attributes of every seated occupant of the vehicle. This action of human attribute detections can as well be observed by booth police officers as well as governing authorities observing occupant actions of impact in delay and real time form taken as well from the trunk of the occupant vehicle.

Further observed prior art as referenced and described in paragraph [0011] a system known as Tele Aid offers at the touch of a button help when it is needed. Help such as roadside assistance, on board SOS push button feature, vehicle automatic response center contact that contacts the customer service team in the event the vehicle is being broken into. As well as offers remote control door unlocking service and a GPS location feature. Each of these aids such as the on board SOS push button feature and roadside assistance feature is offered with in prescribed vehicles at the touch of a button and must be consciously implemented by participation of the occupant of the vehicle, unless the customer service department is trying to speak to the occupant of the vehicle. With in this prior art the following flaws still leaves an open breach to over all safety that is needed by today's society who is frequently vehicle occupants. Flaws such as the prior art described in paragraph [0017] offers touch of the button help when needed. One, passengers or occupants with in the vehicle must be able to manipulate by conscious participation and or interact with this prior art by use of the offered push button features in the event that an unwanted intruder is directly in the vehicle with the occupant. Two, a major flaw of this prior invention for sees that if occupant of the vehicle is seated in the rear of the vehicle, occupant seated in the rear of the vehicle may not be allowed to call out for help let alone reach for the call out feature. Three, in the event that the customer service department does interect and receive the chance to speak to occupant of the vehicle, the occupant of the vehicle may be cohered by the un-welcomed intruder as to relay and speak only what is coached to them. This of course is a dangerous situation for the occupant of the vehicle to be in because by saying the wrong word to the customer service representative or the customer service representative saying the wrong words to the occupant in the vehicle may cause the occupant of the vehicle to loose his or her life by the hands of the panic intruder. Fourth, if the occupant being in the vehicle is an infant or small child they may not be able to communicate at all with the customer service representative. An additional feature offered by one prior art as being offered as a remote control door unlocking service: used in the event when the authorized occupant of the vehicle alerts customer service that the vehicle car door is locked. This feature of the prior art as compared to the current invention of the present art does not allow for a countable record of recorded time accurate door open and door close actions to be stored for the recall and viewing by police officers and or governing authorities. Although, the prior invention may include having a G.P.S. System incorporated in the vehicle it still lacks the ability offered by the current invention and that is to identify the exact human attributes of all the occupants of the vehicle and transmit these attributes silently and with out manipulation by the occupants of the vehicle to a government authority. In addition, the prior invention dose not offer the ability offered by the current invention as to allow policing vehicles to scan the Occupant Vehicle as to obtain stored or past as well as real time sensor detected impacts of actions of all human attributes of every seated occupant of the vehicle including actions of sensor detected impacts that have and or are located in the trunk of that vehicle.

### SUMMARY OF THE INVENTION

It is therefore, an object of the present invention to present a combined individual system that records actions of impact from various points with in a vehicle and more particularity transmits these recorded actions of impacts and activities from with in the vehicle to observing parties such as policing units and governing authorities.

The current invention relates to automobiles and consist of the following components that make up the SenCora Print System as a whole. With in the scope of the current art it is to be understood that the following description of components are used to clarify, describe and articulate the process and intended usage of the current art. Such as, Q1 Occupant Vehicle (identified as 1 with in drawing description) commonly referred to and described as set forth throughout the description of the current art as containing components SA location, also known as 100 Sensor A Finger Print Detection means, SB location, also known as 110 Sensor B Weight Detection means, SC location, also known as 120 Sensor C Height Detection means, SD location, also known as 130 Sensor D Breathing Detection means, SE location, also known as 140 Sensor E Heart Rate Detection means and SF location, also known as 340 Sensor F Door Counter means, as well as Mz locations, also known as 150 Micro Controller Node A Finger Print, 160 Micro Controller Node B Weight, 170 Micro Controller Node C Height, 180 Micro Controller Node D Breathing, 190 Micro Controller Node E Heart Rate and 777 Micro Controller Node Z Door, 350 Micro Controller Node Z Engine Battery, Door Jam (also identified as 14 with in drawing description)and Door Jam (also identified as 17 with in drawing description), I 7 location, also known as 250 Item 7 Central Storage and Processing Unit means, PCB location, also known as 210 Power Control Box means, BuB location, also known as 323 Back Up Battery means, EHWE location, also known as 200 Electrical Highway Wire means, IOI location, also known as 203 Ignition On, Ignition Off Over Ride means, a second system as such described in Q1 Occupant Vehicle(also identified as 1 with in drawing description) as well located with in Q2 Policing Vehicle(also identified as 2 with in drawing description). Comprising as to be utilized by the one same present invention is an undetermined number of 330 S2 Transmission Relay Towers means and 320 S1 Governing Authority Station means

### ADVANTAGES OF THE INVENTION

The advantages of the current invention being identified as the SenCora Print System can identify the personal attributes of all occupants who may enter and occupy the vehicle equipped with the SenCora Print System by means that record, store, document and transmits the attributes of fingerprint and or fingerprint assigned identification numbers, heart rate, breathing, approximate height, door open door close activities and pre-programmed biometric information (obtained by each seated occupant) and a system override (to be implemented in particular circumstances). Override feature means, authorities are allowed to disarm the vehicle engine in the event of a medical emergency, high speed chase or child abduction that is in pursuit. Advantages of the SenCora Print System information collected from with in the Q1 Occupant Vehicle (also identified as 1 with in drawing description) is then transmitted to policing units who request to obtain the on board vehicle activities or attributes of all occupants or such detected attributes as requested by govern authorities to be observed in real time or delayed stored time in order to track and trace the path, actions and activities of occupants as they occurred with in the Q1 Occupant Vehicle. In whole the current art identified as SenCora Print System uses sensor detections with in vehicles but these sensor detections and occupant attributes are then made available to policing units and or governing authorities by real time observations and or delayed stored actions to be previewed as to track and trace prior detected attributes of occupants who may priorly have occupied the Q1 Occupant Vehicle.

Thus, the advantages of the current invention allows policing and governing authorities the ability to identify specific sensor detected attributes from any position of the observed Q1 Occupant Vehicle (equipped with the SenCora Print System) including any action occurring with in the trunk of that vehicle with out the policing unit or governing authorities first approaching the vehicle.

It is therefore, an object of the present invention to present a combined individual system that records actions of impact from various points with in a vehicle and more particularity transmits these recorded actions of impacts and activities from with in the vehicle to observing parties such as policing units and governing authorities.

The current art identified as SenCora Print System uses sensor detections with in the vehicle but these sensor detections and occupant attributes are then made available to policing units and or governing authorities by real time observations and or delayed stored actions as to track and trace prior detected attributes of occupants who were in the vehicle.

The current invention offers the ability of the occupant of the vehicle to simply open the vehicle car door triggering a door open door closed timed recorded action event. The current invention allows occupant to sit in any position of the vehicle as to trigger weight sensors for the impacts of calculated weight acceptance on both the car seat and floorboards of the vehicle. The current invention offers occupant to lean back against the back support of the car seat triggering height detection sensors to detect areas of impact as to be calculated into a perspective height of the occupant leaning back against the car seat back rest of the vehicle. The current invention offers a door handle sensor means that can be implemented and located on both the outer and inner door handle regions, as to receive an applied pressure of Finger Print impression as to determine the identity of the occupant applying the pressure of action to the door handle. The current invention offers occupant to clip on seat belt mechanism as to allow harness strap of the seat belt to detect heart rate and breathing detections (by the use of incorporated sensor detection means) from the occupant of the vehicle wearing the seat belt means. All the described actions performed by the occupant or occupants entering the vehicle are normal actions taking when entering a vehicle but no other interactive actions are needed by the occupant of the vehicle as to engage in the attribute detection process of the occupants with in the SenCora Print equitpted vehicle. The current invention allows for the retrieval, observation and government data comparison of observed occupant attributes obtained by police offers and or governing authorities who would assist as to determine the observation of an innumerable definition of action impacted occurrences that have occurred or is currently occurring within the vehicle being observed.

All the described actions performed by the occupant or occupants entering the vehicle are normal actions taking when entering a vehicle but no other interactive actions are needed by the occupant of the vehicle as to engage in the attrabute detection process of the occupants with in the vehicle. The retrieval, observation and government data comparison of observed attributes obtained by police offers and or government authorities would assist as to determine an innumerable definition of action impacted occurrences that have occurred or is currently occurring within the vehicle being observed.

Further, objects features and advantages of this invention will become readily apparent to persons skilled in the art after a review of the following description, with reference to the drawings and claims that are described through the specification.

A System connected to a detection, transmission and communication network format by wireless and wire dedicated means operating externally and internally of the object identified as Q1 Occupant Vehicle (also identified as 1 with in drawing description) and Q2 Policing Vehicle (also identified as 2 with in drawing description); Comprising, a Microcomputer identified as the 250 Item 7 Central Storage and Processing Unit means, for the storing of preset biometric and non-biometric data and for the receiving, documentation, and transmitting of sensor activities stored or transmitted externally and or internally of the 250 Item 7 Central Storage and Processing Unit within the object called the Q1 Occupant Vehicle and Q2 Policing Vehicle, a group of specific sensor detection means identified as 100 Sensors A Finger Print Detection means, 110 Sensor B Weight Detection means, 120 Sensor C Height Detection means, 130 Sensor D Breathing Detection means, 140 Sensor E Heart Rate Detection means and 340 Sensor F Door Open Door Close Counter means for the acquiring of received actions of impact internally of the object called the vehicle or further identified interchangeably as SenCora Print System and Q1 Occupant Vehicle (also identified as 1 with in drawing description) and Q2 Policing Vehicle(also identified as 2 with in drawing description), that affects the specific sensor area of received actions of impact, a group of current market use transmission means further identified as Micro Controllers further identified as Micro Controller Nodes Z means Identified as MZ Locations, 150 Micro Controller Node A Finger Print, 160 Micro Controller Node B Weight, 170 Micro Controller Node C Height, 180 Micro Controller Node D Breathing, 190 Micro Controller Node E Heart Rate, 777 Micro Controller Node Z Door and 350 Micro Controller Node Engine Battery with in the scope of this invention, used for the receiving and transferring of sensor impacted actions from each sensor detector means of their given sensor detection reception types to be forwarded to 250 Item 7 Central Storage and Processing Unit means, a 210 Power Control Box means used to control the hard wire power line valve as to release or not to release power to the various hard wire power supply lines carrying a more robust power supply through out the vehicle to areas receiving continuous actions of impact. A 323 Back Up Battery means for the use of the 250 Item 7 Central Storage and Processing Unit to pull a more robust source of continual power when the 250 Item 7 Central Storage and Processing Unit on board power supply is exhausted of power and or the main engine battery is not supplying a more robust power supply to the 250 Item 7 Central Storage and Processing Unit, a further means identified as an 203 Ignition On, Ignition Off Over Ride means, to be manipulated as to be remotely enabled or disabled by observing 320 SI Governing Authorities at the time the observed embodied vehicle is discovered to be engaged in high speed chase.

A next system consisting a complete SenCora Print System located within a Q2 Policing Vehicle (also identified as 2 with in drawing description) and a third described SenCora Print System located in a stationary location identified as 320 S1 Governing Authority means that receives 250 Item 7 Central Storage and Processing sensor means detected and transmitted information, formulates a net work of vehicle network communications via satellite and or radio waves for the use of the current invention identified as SenCora Print System located in the object identified as the Q1 Occupant Vehicle (also identified as 1 with in drawing description) to be viewed by Q2 Policing Vehicle (also identified as 2 with in drawing description) and or 320 S1 Governing Authorities in observing the activities from with in the first placed SenCora Print system of the Q1 Occupant Vehicle(also identified as 1 with in drawing description).

With in the current invention all mentioned parts and components described are used to improve public safety by allowing policing units and governing authorities the advantage of observing human attributes located with in an equipped SenCora Print vehicle. Based on some of the public safty challenges discussed in paragraph

the purpose for policing observation of sensor impacted occurrences from with in Q1 Occupant Vehicle (also identified as 1 with in drawing description) equipted with the SenCora Print System would aid in the determination of exact number of occupants seated in any position of the vehicle including the trunk of the vehicle, identify the approximate weight, height, breathing detection, finger print detection and time car doors opened and closed.

### BRIEF DESCRIPTION OF THE SEVERAL VIEWS OF DRAWINGS

FIG. 1 is a schematic view of the entire current invention (with the exclusion of FIG. 3 side view of SF location, 340 Sensor F Door Open, Door Closed sensor) characteristics encumbering all components located with in vehicle in accordance with the present art.

FIG. 1 is a schematic view depicting Q1 Occupant Vehicle (as being identified as 1 with in drawing description).

FIG. 2 is a schematic view depicting the described placement of SA location, 100 Senor A Finger Print Detection Sensor means as being located in Region F interior of vehicle incorporated into or onto 310 Item 12 Steering Wheel Grip Post.

FIG. 2 further is a schematic view depicting 100 Sensor A Finger Print Detection means as being located externally of and on Item 6 Exterior Door Handel of Q1 Occupant Vehicle (also identified Q1 Occupant Vehicle and as 1 with in drawing description) as being located in the Region F, Door A position, Region G Door C position, Region X Door B position and Region G Door D position as being incorporated into or onto external door handles of vehicle.

FIG. 3 is a side view of 340 Sensor F, Door Open Door Close sensor pads located on Item 14 Door Jam of vehicle car door and Item 17 Door Jam of vehicle car door, (Presumed as to be implemented and located on all door car jams of vehicle with in the current invention).

FIG. 4 is a schematic view of 150 Micro Controller Node Z Finger Print means placed with in Region F of Q1 Occupant Vehicle. 150 Micro Controller Nodes Z Finger Print means placed with in Region F of vehicle as to receive all actions of impacts from all 100 Sensors A Finger Print Detection means detections occurring from with in or externally of Q1 Occupant Vehicle (also identified as 2 with in drawing description).

FIG. 4 further depicting a schematic view of 180 Micro Controller Node Z Breathing means located in Region X and 777 Micro Controller Node Z Door Open, Door Closed as being located on a two in one micro control node as to receive action of impact signals from all 130 Sensor D Breathing Detection menas and all 340 Door Open Door Close Counter means occurring from with in the vehicle.

FIG. 4 further depicts an schematic view of 160 Micro Controller Node Z Weight and 190 Micro Controller Node Z Heart Rate means located in region G. 160 Micro Controller Node Z Weight and 190 Micro Controller Node E Heart Rate in region G consists of two in one micro control node means receiving action of impact signals from all 110 Sensor B Weight Detection Sensor means and all 140 Sensor E Heart Rate Detection means occurring from with in the vehicle.

FIG. 4 further depicts a schematic view of 170 Micro Controller Node Z Height means located in region O of vehicle. 170 Micro Controller Node C Height receives action of impact signals from all 120 Sensor C Height Detection Sensor means.

FIG. 4 further depicts a schematic view of 350 Micro Controller Node Z Engine Battery located in dash board of vehicle which receives demand by 250 Item 7 Central Storage and Processing when a more robust power supply is needed to supply detecting sensors incorporated into Q1 Occupant vehicle (also identified as 1 with in drawing description) that have been impacted with an action of impact extending beyond twenty seconds of initial impact.

FIG. 5 depicts a schematic view of 280 Item 4 Floor Boards of vehicle as to show location of where 110 Sensor B Weight sensor means of regions G Rear Passenger Position of vehicle, F Front Drivers Position of vehicle, O Rear Drivers Position of vehicle and region X Front Passenger position of vehicle will be implemented.

FIG. 5 further depicts a schematic view of 240 Item 2 Car Seat or Couch of vehicle as to show location of where 110 Sensor B Weight sensor means of regions G Rear Passenger Position of vehicle, Region F Front Drivers Position of vehicle, Region O Rear Drivers Position of vehicle and Region X Front Passenger position of vehicle will be implemented.

FIG. 5 further depicts a schematic view of 290 Item 5 Trunk Board of vehicle as to show location of where sensors 110 Sensor B Weight Detection, 120 C Height Detection means, 130 Sensor D Breathing Detection means and 140 Sensor E Heart Rate Detection means will be located for sensor detections.

FIG. 5 further depicts a schematic view of 260 Item 3 Car Seat Back Rest of vehicle as to show location of where 120 Sensors C Height Detection means and 140 Sensor E Heart Rate Detection means will be intcorpated in regions G Rear Passenger Position of vehicle, Region F Front Drivers Position of vehicle, Region O Rear Drivers Position of vehicle and region X Front Passenger position of vehicle.

FIG. 5 in conclusion further depicts 310 Item 12 Steering Wheel Grip Post as to show location where 100 Sensor A Finger Print will be located for sensor detection.

FIG. 6 depicts an overhead schematic view of sensor 120 C Height sensor means located within regions G Rear Passenger Position of vehicle, Region F Front Drivers Position of vehicle, Region O Rear Drivers Position of vehicle and Region X Front Passenger Position of vehicle as being located in 260 Item 3 Car Seat Back Rest.

FIG. 6 depicts an overhead schematic view of sensor 140 E Heart Rate sensor means located within regions G Rear Passenger Position of vehicle, F Front Drivers Position of vehicle, Region O Rear Drivers Position of vehicle and Region X Front Passenger Position of vehicle as being located in 260 Item 3 Car Seat Back Rest.

FIG. 6 depicts can be placed, incorporated or a fixed to 260 Item 3 Car Seat Back Rest and 290 Item 5 Trunk Board of Vehicle featured to by those skilled in the present art and can be incorporated into the current invention by way of gluing, bolted down, etched, infused, embedded not excluding any other means deemed necessary as to affix sensor detection means by those skilled in the art.

FIG. 6 in conclusion depicts 140 Sensor E Heart Rate and 120 Sensor C Height as being located with in 290 Region P Trunk of vehicle.

FIG. 7 depicts an schematic view of 110 Sensor B Weight sensor means as implemented within region P as being implemented into 290 Item 5 Trunk Board of vehicle.

FIG. 7 further depicts an overhead schematic view of sensors 130 Sensor D Breathing Detection means incorporated into 230 Item 1 Seat Belt Harness Strap located in regions G Rear Passenger Position of vehicle, Region F Front Drivers Position of vehicle, Region O Rear Drivers Position of vehicle and Region X Front Passenger Position of vehicle.

FIG. 7 further depicts and schematic view of 130 Sensor D Breathing Detection means located in region P as being incorporated into 290 Item 5 Trunk Board of vehicle.

FIG. 8 Depicts an schematic view of 250 Item 7 Central Storage and Processing Unit as being applied to the main skeleton frame of the vehicle.

FIG. 8 further depicts the EHWE also identified as the 200 Electrical Highway Wire as being connected to 250 Item 7 Central Storage and Processing Unit and 323 BuB Back Up Battery.

FIG. 8 further depicts 323 BuB, Back Up Battery as being connected to EHWE also identified as the 200 Electrical Highway Wire line.

FIG. 8 in conclusion depicts EHWE also identified as the 200 Electrical Highway as being connected to 323 BuB, Back Up Battery. 320 BuB, Back Up Battery is used to supply a source of additional power to the 250 Item 7 Central Storage and Processing Unit in the event no other power source with in the vehicle is capable of supplying power to the 250 Item 7 Central Storage and Processing Unit.

FIG. 9 depicts a schematic view of complete EHWE also identified as the 200 Electrical Highway Wire hardwire lay out of the current invention. The complete hardwire layout is a trail of hard wiring that carries a continual source of steady robust power to all areas of sensor, impacted areas that requires a constant flow of power.

FIG. 9 further depicts a schematic view of EHWE also identified as the 200 Electrical Highway Wire layout as running from the 220 Car Engine Battery means to 210 Power Control Box means located in the dash board of vehicle.

FIG. 9 further depicts a schematic view of EHWE also identified as the 200 Electrical Highway Wire layout as running from 210 Power Control Box means located in the dash board of vehicle to 310 Item 12 Steering Wheel means located with in Region F Front Drivers Position of vehicle.

FIG. 9 further depicts a view of EHWE also identified as the 200 Electrical Highway Wire layout as running from 310 Item 12 Steering Wheel means located in Region F Front Drivers Position of vehicle and Region X Front Passenger Position of vehicle. Where the 280 Item 4 Floor Board of vehicle will be located and as to house and incorporate the 110 Sensor B Weight Detection sensor means. The 200 Electrical Highway Wire delivers a more roust post beyond 20 seconds of initial impact.

FIG. 9 further depicts a view of EHWE also identified as the 200 Electrical Highway Wire layout as running from 280 Item 4 Floor Board of vehicle to 240 Item 2 Car Seat or Couch means located in Region F Front Drivers Position of vehicle and Region X Front Passenger Position of vehicle. Where the 240 Item 2 Car Seat or Couch of vehicle will be located and as to house and incorporate the 110 Sensor B Weight Detection sensor means. The 200 Electrical Highway Wire delivers a more roust post beyond 20 seconds of initial impact.

FIG. 9 further depicts a view of EHWE also identified as the 200 Electrical Highway Wire layout as running from 240 Item 2 Car Seat or Couch of vehicle to 260 Item 3 Car Seat Back Rest means located in Region F Front Drivers Position of vehicle and Region X Front Passenger Position of vehicle. Where the 260 Item 3 Car Seat Back Rest of vehicle will be located and as to house and incorporate the 120 Sensor C Height Detection means and the 140 Sensor E Heart Rate means are to be located. The 200 Electrical Highway Wire delivers a more roust post beyond 20 seconds of initial impact.

FIG. 9 further depicts view of EHWE also identified as the 200 Electrical Highway Wire layout as running through the center of the vehicle and is depicted as entering 250 Item 7 Central Storage and Processing Unit.

FIG. 9 Further depicts a view of EHWE also identified as the 200 Electrical Highway Wire layout as exiting 250 Item 7 Central Storage and Processing Unit and entering 280 Item 4 Floor Board of vehicle located in Regions G Rear Passenger Position of vehicle and Region O Rear Drivers Position of vehicle. Where the 280 Item 4 Floor Board of vehicle will be located and as to house and incorporate the 110 Sensor B Weight Detection sensors sensors are to be located. The 200 Electrical Highway Wire delivers a more roust post beyond 20 seconds of initial impact.

FIG. 9 further depicts a view of EHWE also identified as the 200 Electrical Highway Wire layout as running from 280 Item 4 Floor Board of vehicle to 240 Item 2 Car Seat or Couch means located in Regions G Rear Passenger Position of vehicle and Region O Rear Drivers Position of vehicle. Where the 240 Item 2 Car Seat or Couch of vehicle will be located and as to house and incorporate the 110 Sensor B Weight Detection sensor means. The 200 Electrical Highway Wire delivers a more roust post beyond 20 seconds of initial impact.

FIG. 9 further depicts a view of EHWE also identified as the 200 Electrical Highway Wire layout as running from 240 Item 2 Car Seat or Couch of vehicle to 260 Item 3 Car Seat Back Rest means located in Regions G Rear Passenger Position of vehicle and Region O Rear Drivers Position of vehicle. Where the 260 Item 3 Car Seat Back Rest of vehicle will be located and as to house and incorporate the 120 Sensor C Height Detection means and the 140 Sensor E Heart Rate means are to be located. The 200 Electrical Highway Wire delivers a more roust post beyond 20 seconds of initial impact.

FIG. 9 further depicts a view of EHWE also identified as the 200 Electrical Highway Wire layout as running from 250 Item 7 Central Storage and Processing Unit to 323 BuB, Back Up Battery where 323 BuB, Back Up Battery supplies power to the 250 Item 7 Central Storage and Processing Unit in the event that the 250 Item 7 Central Storage and Processing Unit incorporated battery or the 220 Engine Battery fails to supply needed power.

FIG. 9 in conclusion EHWE also identified as the 200 Electrical Highway Wire layout depicts a schematic view of 200 EHWE means as being located with in the 290 Item 5 Trunk Board of vehicle where EHWE also identified as the 200 Electrical Highway Wire layout supplies power to sensors 110 Sensor B Weight Detection means, 120 C Height Detection means, 130 Sensor D Breathing Detection means and 140 Sensor E Heart Rate Detection means as to be located and or incorporated into the 290 Item 5 Trunk Board of vehicle.

FIG. 10 Depicts Q2 Policing Vehicle's (identified as 2 with in drawing description) 250 Item 7 Central Storage and Processing Unit requesting sensor data attributes from Q1 Occupant Vehicle's (identified as 1 with in drawing description) 250 Item 7 Central Storage and Processing Unit, depicted by Path 12.

FIG. 10 Depicts Q2 Policing Vehicle (identified as 2 with in drawing description) 250 Item 7 Central Storage and Processing Unit receiving sensor data attributes from Q1 Occupant Vehicle (identified as 1 with in drawing description) 250 Item 7 Central Storage and Processing Unit, depicted by Path 8.

FIG. 10 Depicts Q2 Policing Vehicle (identified as 2 with in drawing description) 250 Item 7 Central Storage and Processing Unit sending wireless communication means to 330 S2 Transmission and Relay Tower requesting that 320 S1 Governing Authority Station verify all requested sensor data attributes and personal Q1 Occupant Vehicle (identified as 1 with in drawing description) owner and family data history, as to be matched with detection readings as transmitted from with in the 250 Item 7 Central Storage and Processing Unit located with in the Q1 Occupant Vehile, depicted by Path 10 from Q2 Policing Vehilce's (identified as 2 with in drawing description) 250 Item 7 Central Storage and Processing Unit.

FIG. 10 further depicts Q2 Policing Vehicle (identified as 2 with in drawing description) 250 Item 7 Central Storage and Processing Unit wireless communication means to 330 S2 Transmission and Relay Tower requesting that 320 S1 Governing Authority Station to verify all requested sensor data attributes and personal Q1 Occupant Vehicle (also identified as 1 with in drawing description) owner and family data history be matched with detection readings; where said information is also depicted as Path 10 as from Q2 Policing Vehicle (also identified as 2 with in drawing description).

FIG. 10 further depicts 330 S2 Transmission and Relay Tower requesting 320 S1 Governing Authority Station to verify all requested sensor data attributes and personal Q1 Occupant Vehicle (also identified as 1 with in drawing description) owner and family data history be matched with detection readings; where said information is identified as Path 14 from 330 S2 Transmission and Relay Tower.

FIG. 10 further depicts 320 S1 Governing Authority Station responding to Q2 Policing Vehicle (also identified as 2 with in drawing description) 250 Item 7 Central Storage and Processing Unit by sending completed identity match information as well any new finding to 330 S2 Transmission and Relay Tower Depicted in Path 9 from 320 S1 Governing Authority Station as depicted by Path 9.

FIG. 10 further depicts 330 S2 Transmission and Relay Tower transmitting completed identity match information as well any new finding to Q2 Policing Vehicle (also identified as 2 with in drawing description) 250 Item 7 Central Storage and Processing Unit for review identified by Path 19.

FIG. 10 further depicts Q2 Policing Vehicle (also identified as 2 with in drawing description) 250 Item 7 Central Storage and Processing Unit request that 320 S1 Governing Authority Station disables the 203 Ignition On, Ignition Off Demand of the Q1 Occupant Vehicle (also identified as 1 with in drawing description) this request sent to 330 S2 Transmission and Relay Tower transmitting identified as depicted by Path 10.

FIG. 10 further depicts 330 S2 Transmission and Relay Tower fuher relays to 320 S1 Governing Authority Station request to disable the 203 Ignition On, Ignition Off Demand of the Q1 Occupant Vehicle (also identified as 1 with in drawing description) identified by Path 14.

FIG. 10 further depicts 320 S1 Governing Authority Station receives request from 330 S2 Transmission and Relay Tower to disable 203 IOI identified as the Ignition Off Demand of the Q1 Occupant Vehicle (also identified as 1 with in drawing description) also depicted as Path 14.

FIG. 10 further depicts 320 SI Governing Authority Station receives request from 330 S2 Transmission and Relay Tower to disable 203 IOI identified as the Ignition Off Demand of the Q1 Occupant Vehicle (also identified as 1 with in drawing description) and grants the request to disable also depicted as Path 14.

FIG. 10 further depicts 320 S1 Governing Station sends the granted response to disarm 203 101, Ignition On, Ignition Off of the Q1 Occupant Vehicle (also identified as 1 with in drawing description) and sends granted response to 330 S2 Transmission and Relay Tower to be forwarded to Q2 Policing Vehicle (also identified as 2 with in drawing description) whom initial request was made as depicted by Path 9.

FIG. 10 further depicts 330 S2 Transmission and Relay Tower forwards request to disables the 203 Ignition On, Ignition Off Demand of the Q1 Occupant Vehicle (also identified as 1 with in drawing description) to both Q2 Policing Vehicle's (also identified as 2 with in drawing description) 250 Item 7 Central Storage and Processing Unit and Q1 Occupant Vehicle's (also identified as 1 with in drawing description) 250 Item 7 Central Storage and Processing Unit as depicted by both Path 19 and Path 18.

FIG. 10 further depicts 330 S2 Transmission and Relay Tower downloads request to disable the 203 Ignition On, Ignition Off Demand of Q1 Occupant Vehicle's (also identified as 1 with in drawing description) and Q2 Policing Vehicle's (also identified as 2 with in drawing description) 250 Item 7 Central Storage and Processing Units identified by Path 19 and Path 18.

FIG. 10 further depicts Q1 Occupant Vehicle's (also identified as 1 with in drawing description) and Q2 Policing Vehicle's (also identified as 2 with in drawing description) 250 Item 7 Central Storage and Processing Units both receives the demand to disarm the 203 Ignition On, Ignition Off Demand of the Q1 Occupant Vehicle (also identified as 1 with in drawing description) as relayed by 330 S2 Transmission and Relay Tower in response Q1 Occupant Vehicle (also identified as 1 with in drawing description) comes to a rolling stop.

FIG. 11 depicts a complete flow chart of path of action as they occure from beginning to end. However, it is to be conveyed that the path of actions shown are not the final paths of actions that are to be understood as a complete conclution to paths of actions that may be taken. Variations of paths will depend upon variouse combinations of selective paths of impacts, chosen by the party or parties entering and or exiting the vehicle. Sensor feed power demands depending on longevity of SenCora Print use as well as variations of manufacture implementations are to be taken in consideration of obtainable path variations to be utilized, as well as determined sensors selective for vehicle usage will play a small percentage in path determinations and course of path usage.

FIG. 11 depicts a flow chart outlining the external and internal paths of actions as they pertain to the system of actions as are related to the SenCora Print System.

FIG. 11 further depicts external paths as expressed as the first contact path of actions as Q1 Occupant Vehicle (identified as 1 in drawing descrition) to have action of impacts applied to first contact 100 (Sensor A Finger Print) as applied to 300 (Item 6 Exterior Door Handel) as receiving a first point of impact.

FIG. 11 further depicts second contact of path of actions as Q1 Occupant Vehicle (identified as 1 in drawing descrition) to have action of impacts applied to second contact 340 (Door Counter Sensor) as receiving a door open action to 14 (Door Jam) and 17 (Door Jam) as occupant has opened the vehicle car door.

FIG. 11 further depicts 150 (Micro Controller Node Fingerprint) and 777 (Micro Controller Node Door) as receiving a wireless transmission of action of impacts as in relation to 100 applied to 300 and 340 applied to 14 and 17.

FIG. 11 further depicts 150 (Micro Controller Node Fingerprint) and 777 (Micro Controller Node Door) as transmitting said actions of impacts of paragragh [0088] to 250 (Item 7 Central Stoarge and Processing Unit).

FIG. 11 further depicts 250 (Item 7 Central Stoarge and Processing Unit) as documenting and storing paths of actions as delivered and relayed by 150 (Micro Controller Node Fingerprint) and 777 (Micro Controller Node Door) as referenced in paragraghs [0088] and [0089].

FIG. 11 further depicts Q1 Occupant Vehicle (identified as 1 in drawing depictions) interior paths of actions as occurring with in the vehicle.

FIG. 11 further depicts third point of contact made by occupant entering 1 vehicle as impacting the following sensors 110 (Weight) as applied to 240 (Item 2 Car Seat or Couch) and fourth point of action of impact received to 120 (Sensor C Height Detection) and a simutanious point of applied action to 140 (Sensor E Heart Rate) as both applied to 260 (Item 2 Car Seat or Couch).

FIG. 11 further depicts 160 (Micro Controller Weight), 170 (Micro Controller Height) and 190 (Micro Controller Heart Rate)as receiving a wireless transmission of action of impacts as in relation to 110 applied to 240, 120 and 140 both applied to 260 as referenced in Paragraph [0092].

FIG. 11 further depicts a fifth point of contact made by occupant to 110 (Sensor B Weight) as applied to 280 (Item 4 Floor Boards).

FIG. 11 further depicts 160 (Micro Controller Weight) as receiving a wireless transmission of action of impacts as in relation to 110 applied to 280 as referenced in Paragraph [0094].

FIG. 11 further depicts a sixth point of contact made by occupant to 130 (Sensor D Breathing) and 140 (Sensor E Heart Rate) as applied to 230 (Item 1 Seat Belt Harness Strap).

FIG. 11 further depicts 180 (Micro Controller D Breathing) and 190 (Micro Controller E Heart Rate) as receiving a wireless transmission of action of impacts as in relation to 130 and 140 applied to 230 as referenced in Paragraph [0096].

FIG. 11 further depicts a seventh point of contact made by occupant to 100 (Sensor A FingerPrint) as applied to 310 (Item 12 Steering Wheel Grip Post).

FIG. 11 further depicts 150 (Micro Controller A Finger Print) as receiving a wireless transmission of action of impacts as in relation to 100 applied to 310 as referenced in Paragraph [0098].

FIG. 11 further depicts an eighth point of contact made by an additional occupant located with in 290 (Item 5 Trunk Board of Vehicle) to 110 (Sensor B Weight), 120 (Sensor C Height), 130 (Sensor D Breathing) and 140 (Sensor E Heart Rate) as applied to 290 (Item 5 Trunk Board of Vehicle).

FIG. 11 further depicts 160 (Micro Controller B Weight), 170 (Micro Controller Height), 180 (Micro Controller Breathing) and 190 (Micro Controller Heart Rate) as receiving a wireless transmission of action of impacts as in relation to 110, 120, 130 and 140 as applied to 290 as referenced in Paragraph [0100].

FIG. 11 further depicts all impacts of actions and transmissions displayed actions to each sensors related transmitter micro controller as represented in paragraphes [0084], [0085], [0086], [0087], [0088], [0089], [0090], [0091], [0092], [0093], [0094], [0095], [0096], [0097], [0098], [0099], [0100] and [0101] as being by wireless transmission means impact of actions transmitted to 250 (Item 7 Central Storage and Processing Unit) located with in 1 for data transmission in real time or stored data received for later review.

FIG. 11 further depicts a Real Time Transmission path as being one path of action to be taken in relations to the current invention.

FIG. 11 further depicts 1 (Q1 Occupant Vehicle's ) 250 (Item 7 Central Storage and Processing Unit) as transmitting via wireless means indicated actions of impacts as referred to paragraphs [0084], [0085], [0086], [0087], [0088], [0089], [0090], [0091], [0092], [0093], [0094], [0095], [0096], [0097], [0098], [0099], [0100] and [0101] to 2(Q2 Policing Unit's) 250 Item 7 Central Storage and Processing Unit.

2 views downloaded information on an in vehicle view monitor means located with the 2 (Q2 Policing Vehicle).

2 (Q2 Policing Unit's) 250 Item 7 Central Storage and Processing Unit sends actions of impacts and data to 330 (Transmission Tower), with the request to verify and enhance data.

330 (Transmission Tower) received request to enhance data.

330 (Transmission Tower) received request to enhance data and forwards request to 320 (Governing Authority Station).

320 (Governing Authority Station) receives request to verify and enhance data from 330 Tranmission Tower).

320 (Governing Authority Station) reviews request and ehances data and sends the enhancements to 330 (Transmission Tower).

330 (Tranmission Tower) forwards the enhancement data to 2 (Q2 Policing Unit's) 250 Item 7 Central Storage and Processing Unit for data review.

2 (Q2 Policing Unit's) 250 Item 7 Entral Storage and Processing Unit receives enhanced data and views data on its view monitor means obtaining sensor attributes of occupants located with in the 1 (Q1 Occupant Vehicle).

End of first Path of Internal External attribute detection and transfer.

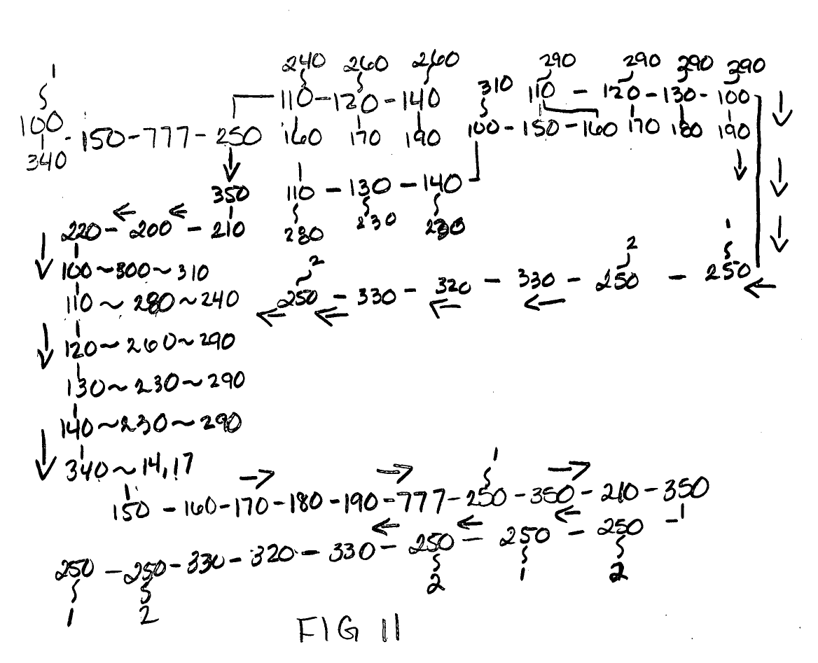

FIG. 11 depicts next path of actions as being external by means of wireless and hard wire process of paths of actions.

FIG. 11 further depicts all impacts of actions and transmitted displayed actions to each sensors related transmitter micro controller as represented in paragraphes [0084], [0085], [0086], [0087], [0088], [0089], [0090], [0091], [0092], [0093], [0094], [0095], [0096], [0097], [0098], [0099], [0100] and [0101] as being delivered by wireless transmission means and impact of actions transmitted to 250 (Item 7 Central Storage and Processing Unit) located with in 1 (Q1 Occupant Vehicle) for data transmission in real time or stored data received for later reviewing and observation by 2 and or 320.

250 (Item 7 Entral Storage and Processing Unit) located with in 1 (Q1 Occupant Vehicle) after first twenty seconds of initial sensor detection of impacts from actions of impacts occuring in relation to paragraph [0115] sends via wireless transmission to 350 (Micro Controller Engine Battery) a request for additional robust power to be feed to all internal sensor mates that are being impacted with a continual impact of action within the 1 (Q1 Occupant Vehicle).

350 (Micro Controller Engine Battery) receives wireless transmittal for a more robust power supply to be released from 220 Engine Battery.

350 (Micro Controller Engine Battery) forwards wireless transmittal request for a more robust power supply to be released from 220 Engine Battery to 210 Power Control Box.

210 (Power Control Box) contains all power control valves to open and close power to all sensors in need of a continual source oe power.

210 (Power Control Box) receives wireless directions to open and or close valves and contains with in its structure 200 (Electrical Highway Wire means) as to assist in the delivery of a more robust power though out the vehicle when needed.

210 (Power Control Box) releases through 200 (Electrical Highway Wire means) the direction for 220 (Engine Battery) to release power to all indicated impacted sensors as referenced in paragraph [0015], this direction sent from 210 (Power Control Box).

220 (Engine Battery) receives demand to release power to all indicated impacted sensors as referenced in paragraph [0115].

220 (Engine Battery) more robust power releases power to all indicated impacted sensors as referenced in paragraph [0115] by use of 200 (Electrical Highway Wire means).

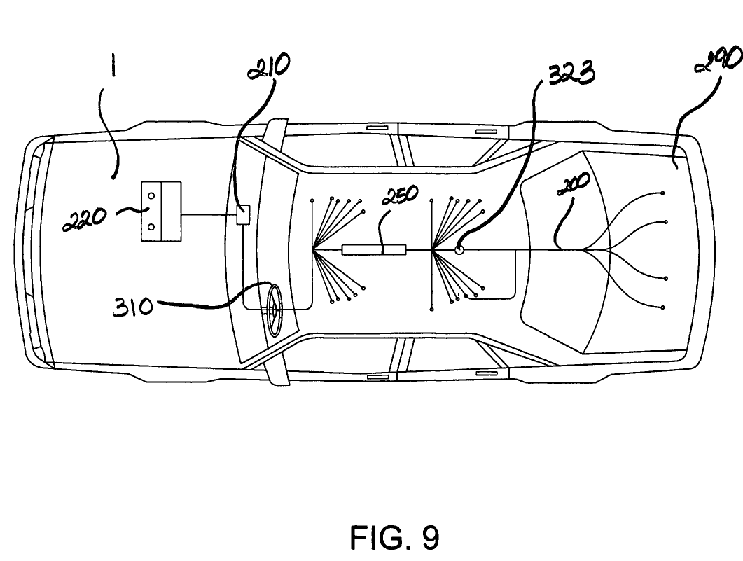

200 (Electrical Highway Wire means) as depicted in FIG. 9 carries the robust power from the 220 (Engine Battery) to impacted sensors requiring a continual source of power as indicated in paragraph [0015].

250 Item 7 Central Storage and Processing Unit sends a wireless request for confirmation that power has been opened to 350 (Micro Control Node Engine Battery).

350 (Micro Control Node Engine Battery) sends wireless request to 210 (Power Control Box) for confirmation power is opened to sensors as referenced in paragraph [0015].

210 (Power Control Box) receives that power is open to to all continually impacted sensors as referenced in paragraph [0015].

210 (Power Control Box) transmits confirmation that power is open to to all continually impacted sensors as referenced in paragraph [0015] to 350 (Micro Control Node Engine Battery).

FIG. 11 further depicts 350 (Micro Control Node Engine Battery) receives and transmits that power is open to to all continually impacted sensors as referenced in paragraph [0015] to 250 (Item 7 Central Storage and Processing Unit).

FIG. 11 further depicts 250 (Item 7 Central Storage and Processing Unit) receives transmition confirmation that power is open to all sensors referenced in paragraph [0015].

With in FIG. 11 this ends internal paths of communication as pertains to SenCora Print System.

FIG. 11 further depicts 2 (Q2 Policing Unit's) 250 (Item 7 Central Storage and Processing Unit) request for attribute detection, from with in the 1(Q1 Occupant Vehicle's) 250 (Item 7 Central Storage and Processing Unit) via wireless means.

FIG. 11 further depicts 1(Q1 Occupant Vehicle's) 250 (Item 7 Central Storage and Processing Unit) receives request to release attribute detection, from with in it's 250 (Item 7 Central Storage and Processing Unit) via wireless means.

FIG. 11 further depicts 1(Q1 Occupant Vehicle's) 250 (Item 7 Central Storage and Processing Unit) releases all current and prior sensor detected attributes that have occurred with in the vehicle.

FIG. 11 farther depicts 2 (Q2 Policing Unit's) 250 (Item 7 Central Storage and Processing Unit) receives attribute detection, from with in the 1(Q1 Occupant Vehicle's) 250 (Item 7 Central Storage and Processing Unit) via wireless means.

FIG. 11 further depicts 2 (Q2 Policing Unit's) 250 (Item 7 Central Storage and Processing Unit) views attribute detection, from with in the 1(Q1 Occupant Vehicle's) 250 (Item 7 Central Storage and Processing Unit) on its in vehicle view monitor.

FIG. 11 further depicts 2 (Q2 Policing Unit's) 250 (Item 7 Central Storage and Processing Unit) sends request to 320 (Governing Authority) to enhance data, disarm 203 (Ignition On, Ignition off means) from within the 1(Q1 Occupant Vehicle's) 250 (Item 7 Central Storage and Processing Unit) via wireless means to 330 (Transmission and Relay Tower).

FIG. 11 further depicts 330 (Transmission and Relay Tower) forwards request from (Q1 Occupant Vehicle's) 250 (Item 7 Central Storage and Processing Unit), via wireless means to 320 (Governing Authority Station).

FIG. 11 further depicts 320 (Governing Authority Station) means receives request and observes the request to enhance data and disarm the 203 (Ignition On, Ignition Off means) of the Q1 (Occupant Vehicle).

FIG. 11 further depicts 320 (Governing Authority Station) enhances data and approaves to disarm 203 (Ignition On, Ignition Off means) of the Q1 (Occupant Vehicle) via wireless means.

FIG. 11 further depicts 320 (Governing Authority Station) sends the enhanced data and approval to disarm 203 (Ignition On, Ignition Off means) of the 1 (Q1 Occupant Vehicle's) 250 (Item 7 Central Storage and Processing Unit) via wireless means to 330 (Transmission and Relay Tower).

FIG. 11 further depicts 330 (Transmission and Relay Tower) forwards approved data enhancement and disarming of the 203 (Ignition On, Ignition Off means) for 1 (Q1Occupant Vehicle) to both 1(Q1 Occupant Vehicle) and 2 (Q2 Policing Unit's) 250 (Item 7 Central Storage and Processing Unit).

FIG. 11 further depicts 2 (Q2 Policing Unit) views data received by 330 (Transmission and Relay Tower) on its in vehicle view monitor.

FIG. 11 further depicts 1(Q1 Occupant Vehicle) 250 (Item 7 Central Storage and Processing Unit) receives the disbarment signal of its 203 (Ignition On, Ignition Off means) and comes to a rolling stop.

FIG. 11 further depicts this ends the action of impacts paths as perterning to internal andextemal of the current invention.

FIG. 11 further depicts please note that these paths are only to be conyed as a sample of the various paths that could be followed as exampled with in the cuurent invention and is understood that those skilled in the art may add additional paths of actions with out departing from the original objective of the current invention identified as the SenCora Print system.

### DETAILED DESCRIPTION OF THE INVENTION

It is therefore, an object of the present invention to present a combined individual system that records actions of human or object inflected impacts from various points within a Q1 Occupant Vehicle(also identified as 1 with in drawing description) and more particularly transmit these recorded actions of impacts and activities to observing parties such as Q2 Policing Vehicle (also identified as 2 with in drawing description who may demand certain or all sensor impacted regions from with in the Q1 Occupant Vehicle (also identified as 1 with in drawing description)where the same impacted regions of impact information may be transmitted to 320 S1 Governing Authorities by means such as 330 S2 Transmission Relay Towers means by wireless communication means. Thus, allowing these Q2 Policing Vehicle (also identified as 2 with in drawing description) and 320 S1 Governing Authority means the ability to identify specific attributes of each seated occupant of the observed Q1 Occupant Vehicle (also identified as 1 with in drawing description) with out the Q2 Policing Vehicle (also identified as 2 with in drawing description (also identified as 2 with in drawing description) patrol officer or 320 S1 Governing Authority first approaching the Q1 occupant vehicle.

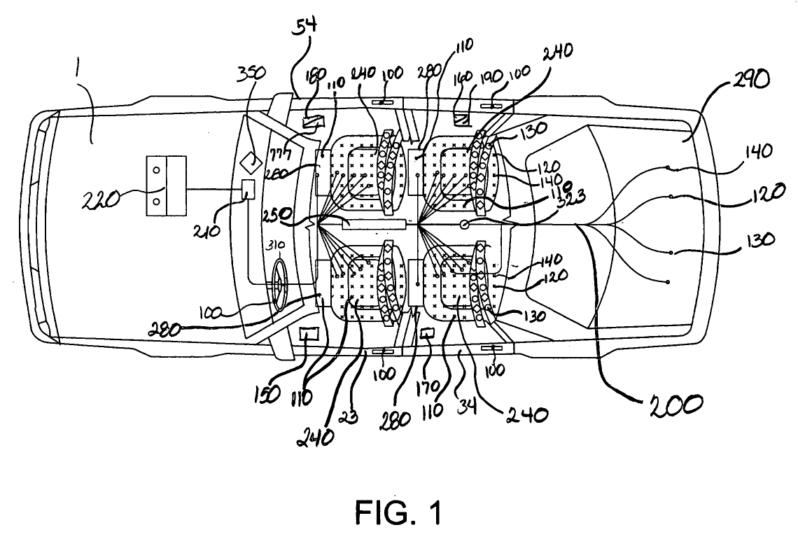

FIG. 1 depicts a system that is composed of the following market available components identified in FIG. 1 as being located within Q1 Occupant Vehicle (also identified as 1 with in drawing description) comprising as to house internally of Q1 Occupant Vehicle, commonly referred to and described as set forth throughout the description of the current invention as SA location, also known as 100 Sensor A Finger Print Detection means, SB location, also known as 110 Sensor B Weight Detection means, SC location, also known as 120 Sensor C Height Detection means, SD location, also known as 130 Sensor D Breathing Detection means, SE location, also known as 140 Sensor E Heart Rate Detection means and SF location, also known as 340 Sensor F Door Counter means, as well as MZ locations, also known as 150 Micro Controller Node A Finger Print means, 160 Micro Controller Node B Weight means, 170 Micro Controller Node C Height means, 180 Micro Controller Node D Breathing means, 190 Micro Controller Node E Heart Rate menas and 350 Micro Controller Node Z Engine Battery, I 7 location, also known as 250 Item 7 Central Storage and Processing Unit means, PCB location, also known as 210 Power Control Box means, BuB location, also known as 320 Back Up Battery means, EHWE location, also known as 200 Electrical Highway Wire means, 101 location, also known as 203 Ignition On, Ignition Off Over Ride means, a second system as such described in Q1 Occupant Vehicle as well located with in Q2 Policing Vehicle. Comprising as to be utilized by the one same present invention is an undetermined number of 330 S2 Transmission Relay Towers means and 320 S1 Governing Authority Station means.

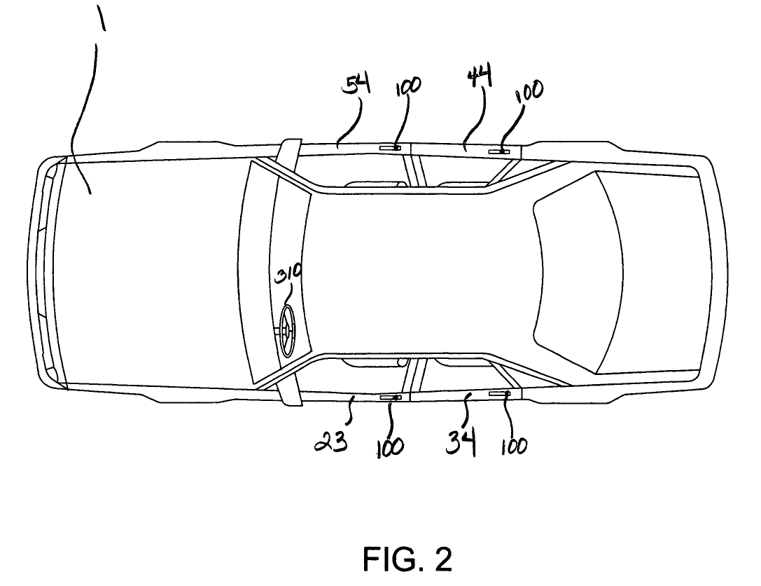

Identified through out the scope of the present invention are the locations of the Q1 Occupant Vehicle Door locations identified by FIG. 1 and FIG. 2. Door locations will be referred to as Door 23, Door A, Region F, Front Drivers Position, Door 54, Door B, Region X, Front Passengers Position, Door 34, Door C, Region O, Rear Drivers Position and Door 44, Door D Region G, Rear Passenger Position(as collectively being identified as 300 Item 6 Exterior Vehicle Door Handel). These door descriptions as pertaining to the present invention may also be referred as being located internally or externally of Q1 Occupant Vehicle (also identified as 1 with in drawing description).

### Sensor A is Comprised of (What is Made of)

With in the scope of the present invention the first sensor means to receive a point of impact is SA location, also known as 100 Sensors A Finger Print Detection means as depicted in FIG. 1 and FIG. 2.

SA location, also known as 100 Sensors A Finger Print Detection means as depicted in FIG. 2 is depicted as being located externally of Door 54, Door D, Region G, Rear Passenger Position, Door 23, Door A, Region F, Front Drivers Position, Door 34, Door C, Region O, Rear Drivers Position and Door 44, Door B, Region X, Front Passengers Position (as collectively being identified as 300 Item 6 Exterior Vehicle Door Handel).

SA location, also known as 100 Sensor A Finger Print Detection means, is applied to 300 Item 6 Exterior Vehicle Door Handles Vehicle door handle also know as Door 23, Door A, Region F, Front Drivers Position, Door 44, Door B, Region X, Front Passengers Position, Door 34, Door C, Region O, Rear Drivers Position, Door 54, Door D Region G, Rear Passenger Position(as being collectively identified as 300 Item 6 Exterior Vehicle Door Handel) as Best mode of obtaining a Finger Print sensor reading means, is preprogrammed to detect Finger Print patterns by use of a Capacitance Scanning Mechanism.

Capacitance Scanning Mechanism is a marketable means that makes up a simple fingerprint-scanning device. A Capacitance Scanner is a Finger Print sensor that detects Finger Print patterns. Capacitance Scanner is recognized as being the best, selected fingerprint-scanning device, by comparison with in the scope of this invention. The Capacitance Scanner is made up of one or more semiconductor chips, which has an array of tiny cells each cell includes two conductor plates, covered with an insulting layer. The cells are smaller than the width of one ridge of a fingernail. The sensor is connected to an integrator, an electrical circuit built around the inverting operational amplifier. The inverting amplifier is a complex semiconductor device, made up of a number of transistors, resistors and capacitors. With the amplifier, an inverting amplifier alerts on one current based on fluctuations in another current. The inverting amplifier thus, directly alerts the supply voltage. The alternation is based on the relative voltage of two inputs, called the inverting terminal and the non-inverting terminal. The non-inverting terminal is connected to reference voltage supply, (in this case power is drawn from the battery that is directly designed onto the Capacitance Finger Print Detector) and a feed back loop, which is also connected to amplifier out-put includes the two conductor plates. The two conductor plates from a basic capacitor, enhances an electrical component that can store up charge. The surface of the finger acts as a third capacitance plate separated by the insulating layers in the cell structure and in the case of the finger print valleys a pocket of air. Varying the distance between the capacitor plates (example by moving the finger closer or further away from the conductor plates) changes the total capacitor. Because of this quality the capacitor under a ridge would have a greater capacitance than the capacitor in a cell under the valley. The Finger Print voltage reads output and determines whether it is characteristic of a ridge or a valley. The processor can put together an overall picture of the fingerprint, similar to the image captured by an optical scanner.

100 Sensor A Finger Print Detection Senor in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors' usability factor. The description as described within the scope of this invention is offered as an example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method.

The recommended environments for each sensor incorporated with in the scope of this invention is as follows or applied to each sensor according to manufacture recommendations. All components incorporated into system being SenCora Print System are low cost, highly effective, market available sensors and computer components.

It is recommended that sensors located on the exterior side of the vehicle (such as 300 Item 6 Exterior Vehicle Door Handel Vehicle) be made to endure and conform to temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

It is further recommended that sensors located with in the interior of the vehicle be made to endure and conform to the recommendations temperatures of −40 degrees Celsius to +85 degrees Celsius. Vibration stress per component with in the SenCora Print System should be able to with stand reduced to extreme vibration conditions. Each sensor and component should be able to with stand water and saltwater sprays, oils, brake fluids, solvents, fuels, ect. Thermal shock of reduced to high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the current invention once the entering occupant's fingers or thumb comes into contact with the Capacitance Finger Print Detector means, Identified as 100 Sensor A Finger Print Detection means as an action of impact, this contact causes wireless communication of impacted action of impact to be transmitted to the next means described as MZ location, also known as 150 Micro Controller Nodes Z Finger Print means used to receive and further transmit the transmissions of impacted actions from the first point of contact of the 300 Item 6 Exterior Vehicle Door Handles.

FIG. 2 depicts SA location, also known as 100 Sensors A Finger Print Detection means, as to be in one manor the best described method for applying the present invention as in perspective to 100 Sensor A Finger Print Detection means as recommended to be housed with in a thin flexible sensor mat that is incorporated into its region of detection by graphing, under laid, gluing, bolting or any other means necessary needed as to incorporate 100 Sensors A Finger Print Detection Sensors means to Item 6 Exterior Vehicle Door Handles Vehicle of Q1 Occupant Vehicle doors: 300 Item 6 Exterior Vehicle Door Handles Vehicle door handle also know as Door 23, Door A, Region F, Front Drivers Position, Door 44, Door B, Region X, Front Passengers Position, Door 34, Door C, Region O, Rear Drivers Position, Door 54, Door D Region G, Rear Passenger Position As Depicted in FIG. 1. Each sensor with in the scope of the SenCora Print System is housed with in a thin flexible sensor mat that is incorporated into its region of detection.

It is left to those skilled in the art of application of 100 Sensor A Finger Print Detection means to 300 Item 6 Exterior Vehicle Door Handles Vehicle door handle also know as Door 23, Door A, Region F, Front Drivers Position, Door 44, Door B, Region X, Front Passengers Position, Door 34, Door C, Region O, Rear Drivers Position, Door 54, Door D Region G, Rear Passenger Position location externally of Q1 Occupant Vehicle for proper application but as not to depart from the sincerity of the current invention.

### Sensor A is Used How

The following is a process of action as pertains to external 100 Sensor A Finger Print Detection means externally located of 300 Item 6 Exterior Vehicle Door Handles Vehicle door handle also know as Door 23, Door A, Region F, Front Drivers Position, Door 44, Door B, Region X, Front Passengers Position, Door 34, Door C, Region O, Rear Drivers Position, Door 54, Door D Region G, Rear Passenger Position of Q1 Occupant Vehicle (identified as 1 in drawing description).

FIG. 2 depicts the exterior locations of Doors Q1 Occupant Vehicle (identified as 1 in drawing description) car doors described as doors 23, Door A, Region F, Front Drivers Position, Door 44, Door B, Region X, Front Passengers Position, Door 34, Door C, Region O, Rear Drivers Position, Door 54, Door D Region G, Rear Passenger.

### Process of Action

Occupant approaches Q1 Occupant Vehicle and extends his or her unobstructed hand toward the Q1 Occupant Vehicle car door of location Door 23, Door A, Region F, Front Drivers Position, exterior of Q1 Occupant Vehicle (identified as 1 in drawing description).

Occupant fingers and thumb are placed on the 300 Item 6 Exterior Vehicle Door Handel of Door 23, Door A, Region F, Front Drivers Position exterior of Q1 Occupant Vehicle (identified as 1 in drawing description).

Occupant's fingers and thumb causes pressure to be applied to Door 23, Door A, Region F, Front Drivers Position exterior of 300 Item 6 Exterior Vehicle Door Handel location of the Q1 Occupant Vehicle (identified as 1 in drawing description).

100 Sensor A Finger Print Detection means incorporated to Door 23, Door A, Region F, Front Drivers exterior position location receives the applied pressure of action made by the entering occupant's fingers and thumb-print. Applied pressure is received to entering occupant detected finger print will be detected by 100 Sensor A Finger Print Detection means.

Pertaining to 100 Sensor A Finger Print Detection means, a numeric number may be assigned to entering occupant of the Q1 Occupant Vehicle; simply means that a number code can be applied by the memory of the 250 Item 7 Central Storage and Processing Unit to Identify the entering occupant as a common user of the Q1 Occupant Vehicle . However, an identifiable finger print is attached to the assigned numeric code of the common user of the entering occupant of the Q1 Occupant Vehicle as to be stored in the memory of the 250 Item 7 Central Storage and Processing Unit with in the Q1 Occupant Vehicle (identified as 1 in drawing description).

The assigned numeric code assigned to the common user is identified by the Department of Motor Vehicle records or the documented assigned number code of the common entering occupant of the Q1 Occupant Vehicle (identified as 1 in drawing description) are identified by the 320 S1 Governing Authority which has access to the entering occupant's true Finger Print pattern under review by access to the Q1 Occupant Vehicle (identified as 1 in drawing description). 250 Item 7 Central Storage and Processing Unit.

SA location, identified as 100 Sensor A Detection means detects a readable fingerprint, thumbprint or non-detectible finger print pattern as (being identified as an impact of action applied to Door 23, Door A, Region F, Front Drivers Position exterior of vehicle upon impact type received by 100 Sensor A Finger Print Detection means from the Region F Front Drivers Position by entering occupant of the Q1 Occupant Vehicle (identified as 1 in drawing description).

SA location, identified as 100 Sensor A Detection means are self supported by power deriving from the 100 Sensor A Detection means its self. As referenced in paragraph [0000].

100 Sensor A Detection means as well as each sensor detection means described through out the scope of the current invention supplies it own individual power supply upon initial impact of action occurring within the first twenty seconds of occupant action of initial impact.

Within the scope of the current invention once the entering occupant's fingers or thumb comes into contact with the Capacitance Finger Print Detector means identified as 100 Sensor A Finger Print Detection means, applied to 300 Item 6 Exterior Vehicle Door Handles of Door 23, Door A, Region F, Front Drivers Position of Q1 Occupant Vehicle (identified as 1 in drawing description), as an action of impact, this contact causes wireless communication of described action of impact to be transmitted to the next means described as MZ location, also known as 150 Micro Controller Nodes Z Finger Print means used to receive and further transmit transmissions of actions of impacts occurred by finger print or pressures of received impact to Door locations of 23, Door A, 54, Door B, 34, Door C and 44, Door D located in Region F Front Drivers Position, Region X, Front Passengers Position, Region O, Rear Drivers Position and Region G, Rear Passenger Position external and internally of Q1 Occupant Vehicle (identified as 1 in drawing description).

Detectable identifiable finger print and or non-identifiable actions of impacts received by 300 Item 6 Exterior Vehicle Door Handles of Region F Front Drivers Position, as being incorporated onto 23, Door A of Q1 Occupant Vehicle (identified as 1 in drawing description), are then transmitted actions are sent by wireless communication, to MZ location, 150 Micro Controller Node Z Fingerprint.

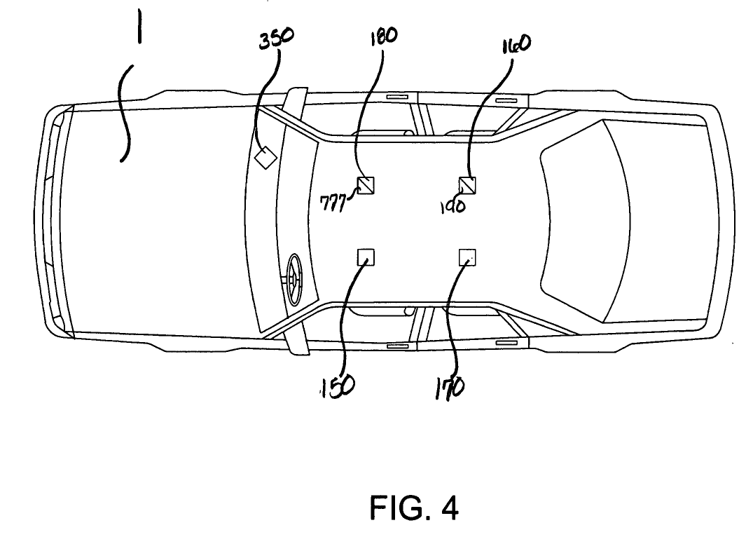

The location of received action of impact transmittals of the entering occupant's finger print is relayed to MZ location, identified as 150 Micro Controller Node Z Finger Print which receives all actions of impacts from all 100 Sensor A Finger Print Detection means occurring from with in or externally of the Q1 Occupant Vehicle of doors 23, Door A, 54, Door B, 34, Door C and 44, Door D locations. MZ location, Identified as MZ location, 150 Micro Controller Node Z Finger Print is referenced by FIG. 4 of [0000].

Actions of impact that occurs with in the first twenty seconds of initial Finger Print impact to 300 Item 6 Exterior Vehicle Door Handles also known as door locations Door 23, Door A, Region F, Front Drivers Position, Door 54, Door B, Region X, Front Passengers Position, Door 34, Door C, Region O, Rear Drivers Position, Door 44, Door D Region G, Rear Passenger Position exterior of Q1 Occupant Vehicle (identified as 1 in drawing description) are transmitted to Mz location, 150 Micro Controller Node Z Finger Print Detection means.

With in this example it is to be understood that Door 23, Door A, Region F, Front Drivers Position of Q1 Occupant Vehicle is the area where described action of impact is received to the 300 Item 6 Exterior Vehicle Door Handel incorporated with SA location identified as 100 Sensor A Detection means.

SA location identified as 100 Sensor A Detection means are supported by power deriving from the 100 Sensor A Detection means individual power supply built into its own feature as being a sensor.

100 Sensor A Finger Print Detection means being located externally of 300 Item 6 Exterior Vehicle Door Handles Door 23, Door A, Region F, Front Drivers Position, Door 54, Door B, Region X, Front Passengers Position, Door 34, Door C, Region O, Rear Drivers Position, Door 44, Door D Region G, Rear Passenger Position (collectively known as 300 Item 6 Exterior of Vehcile) exterior of Q1 Occupant Vehicle identified (as 1 in drawing description); operates on a beaconing network. In a beaconing network system sensors transmit beacons to confirm their presents to other network system sensors. This allows sensors that are not affected by action or contact to sleep between beacons. This nonuse of unnecessary sensor activity lowers the sensor duty cycle and extends its battery life. Beacon intervals may range from 12.36 milliseconds to 15.36 ms*2₁₄=251.65824 seconds at 250 kbit/s from 24 milliseconds to 24 ms*2₁₄=393.216 seconds at 40 kbit/s and 48 milliseconds at 48 ms*2₁₄=786.432 seconds at 200 kbit/s; to obtain the benefits of low product cost or may be under manufacture recommended or best applied beacon intervals settings suitable to the present invention identified as SenCora Print System by those skilled in the present art.

100 Sensor A Detection means as well as each sensor detection means described through out the scope of the current invention supplies it own individual power supply upon initial impact of action occurring with in the first twenty seconds on impact. An alternate power source deriving from the BuB location, also known as 220 Engine Battery means as depicted in FIG. 9 serves as the more robust long term power source that supplies each sensor detection means of its sensor type with continual, long term power beyond the first twenty seconds of initial sensor impact, as actions of impact occur against located sensor detection means.

Transmitted wireless communication means of the first twenty seconds of initial finger print impact as pertaining to the 100 Sensor A Detection means is then further relayed as the detected finger print pattern (indicated impact of pressure received action with no print detection, or identifiable numeric assigned code of entering occupant's finger print as detected) as well as location of finger print impact of action is transmitted via wireless transmission from the 300 Item 6 Exterior Vehicle Door Handel, Region F Front Drivers Position to MZ location, 150 Micro Controller Node Z Finger Print.

MZ location, 150 Micro Controller Node Z Finger Print Detection means is transmitted via wireless transmission mean such as wireless radio transmission means or injected by best source of wireless transmission means by those skilled in the art to 250 Item 7 Central Storage and Processing Unit. MZ location, 150 Micro Controller Node Z Finger Print is on a pitch (frequency) that can't be identified by any other MZ location, Micro Controller Node of its assigned frequency pitch with in the Q1 Occupant Vehicle.

MZ location, 150 Micro Controller Node Z Finger Print further transmits received action of impact to the 250 Item 7 Central Storage and Processing Unit for storage of information, where transmitted received action of impact transmitted to 250 Item 7 Central Storage and Processing Unit can be viewed via wireless means to Q2 Policing identified as 2 in drawing description) Vehicles and or 320 S1 Governing Authorities.

250 Item 7 Central Storage and Processing Unit receives the transmission of Finger Print detection or non-detection and location of occurrence from MZ location, 150 Micro Controller Node Z Finger Print and documents the time, date and location of occurrence of the Finger Print pattern that was detected.

250 Item 7 Central Storage and Processing Unit retains and or transmits all actions of SA locations, identified as 100 Sensor A Finger Print Detections means from 100 Sensor A detection regions of impact, to observing Q2 Police Units (identified as 2 in drawing description) or 320 S1 Governing Authorities who request on board viewing and real time or stored actions of occurrences from with the Q1 Occupant Vehicle (identified as 1 in drawing description).

100 Sensor A Finger Print Detection means being located externally on Door 23, Door A, Region F, Front Drivers Position, Door 54, Door B, Region X, Front Passengers Position, Door 34, Door C, Region O, Rear Drivers Position, Door 44, Door D Region G, Rear Passenger Position exterior of Q1 Occupant Vehicle (identified as 1 in drawing description); operates on a beaconing network. In a beaconing network system sensors (such as sensors detection means described within the scope of the current invention as being 100 Sensor A Fingerprint, 110 Senor B Weight, 120 Sensor C Height, 130 Sensor D Breathing, 140 Sensor E Heart Rate and 340 Sensor F Door Counter) transmit beacons to confirm their presents to other network receivers identified as MZ Micro Controller Node Z locations of its given sensor detection type.

100 Sensors A Detection means transmit action to MZ location, 150 Micro Controller Node Z Fingerprint. This allows 100 Sensor A Finger Print sensors that are not affected by action or contact to sleep between beacons. This nonuse of unnecessary sensor activity lowers the sensor duty cycle and extends its life.

Occupant completes entrance of Door 23, Door A, Region F, Front Drivers Position exterior of Q1 Occupant Vehicle (identified as 1 in drawing description) as removing his fingers and thumb from the D1, Door A vehicle entrance handle externally located being 300 Item 6 External Vehicle Door Handel.

Power there for is no longer flowing to the 100 Sensor A Finger Print Detection means. 23, Door A Front Drivers Position, thus indicating to 100 Sensor A Detection means of finger print has ended at location 23, Door A externally of Q1 Occupant Vehicle.

When location of impact of position 23, Door A Front Drivers location, is no longer impacted by action of impact as to no indication of finger print is detected from 100 Sensor A Finger Print Detection means incorporated into 300 Item 6 Exterior Vehicle Door Handles, 100 Sensor A Finger Print means no longer sends impacted actions of finger print or pressure applied transmitted actions to MZ location, 150 Micro Controller Node Z Finger Print.

Mz location, 150 Micro Controller Node Z Finger Print no longer receives or sends received transmittals of recorded actions of impacts to 250 Item 7 Central Storage and Processing Unit.

This would conclude the external 100 Sensor A Detection of Finger Print Detection means as it applies to the 300 Item 6 Exterior Vehicle Door Handles of vehicle door locations of 23, Door A Front Drivers location of the Q1 Occupant Vehicle (identified as 1 in drawing description) implemented by the entering occupant.

### Sensor A is Compared to What is Old

On the market there is a system called the Se Cu On-Auto Finger Print Immobilizer. This is a device that is installed inside the vehicle and which does not allow the vehicle to be used without Finger Print verification even if the key is not used. The system immobilizes your car in your absence and prevents it from theft or use by unauthorized persons. Vehicle owner can authorize his or her family members or friends Finger Print clearance, allowing them access to use and drive the vehicle. This fingerprinting device comes in two parts Finger Print control unit and fingerprinting scanning unit. This device is installed on the dashboard of the vehicle while the control unit is installed inside the deck. This device holds up to 100 fingerprints and can be reset by changing the pin code.

### What is New

Unlike the Se Cu On-Auto: Finger Print Car Immobilizer the SenCora Print System is recommended to have a Capacitance Finger Detection Means to be incorporated or applied onto the Q1 Occupant Vehicle's 300 Item 6 Exterior Vehicle Door Handles of the Q1 Occupant Vehicle door locations of Door 23, Door A, Region F, Front Drivers Position, Door 54, Door B, Region X, Front Passengers Position, Door 34, Door C, Region O, Rear Drivers Position, Door 44, Door D Region G, Rear Passenger Position exterior of Q1 Occupant Vehicle (identified as 1 in drawing description) as well as internally of the Q1 Occupant Vehicle not to exclude being applied into or onto the steering wheel grip post identified as 310 Item 12 Steering Wheel Grip Post of the Q1 Occupant Vehicle. Thus, when an occupant enters the Q1 Occupant Vehicle (identified as 1 in drawing description) door a finger print impression is made on the door handle causing the impression to detect a finger print pattern. This impression of the finger print is detected and either a numerically assigned number or code or the impression of the finger print is transferred (via wireless communication means) to the MZ location, 150 Micro Controller Node Z Finger Print means then further transmits finger print impression or assigned number code to the 250 Item 7 Central Storage and Processing Unit to be stored for comparative print matches. This portion of the invention may further provide quick evidence to who is actually entering and exiting the Q1 occupant vehicle. What is identified as new with in this portion of SenCora Print System is that the actual finger print of the occupant can be indicated in form or by action of impact and later viewed by Q2 Policing Units and or 320 S1 Governing Authority Station by real time or stored events of occurrences.

Further what is new in the current invention being the SenCora Print System an observing officer may retrieve (via wireless means) a real time check of 100 Sensor A Door location Door 23, Door A, Region F, Front Drivers Position, Door 54, Door B, Region X, Front Passengers Position, Door 34, Door C, Region O, Rear Drivers Position, Door 44, Door D Region G, Rear Passenger Position exterior of Q1 Occupant Vehicle (identified as 1 in drawing description) the officer would be able to review the exact time each occupant entered and exited the vehicle. Unlike the Se Cu On-Auto: Finger Print Car Immobilizer what is new with in this portion of the SenCora Print System is that the 100 Sensor A is located on the 300 Item 6 Exterior Vehicle Door Handles of the Q1 Occupant Vehicle (identified as 1 in drawing description), the occupant simply grips the doorpost Identified as 300 Item 6 Exterior Vehicle Door Handles of the door handle of door position Door 23, Door A, Region F, Front Drivers Position, Door 54, Door B, Region X, Front Passengers Position, Door 34, Door C, Region O, Rear Drivers Position, Door 44, Door D Region G, Rear Passenger Position exterior of Q1 Occupant Vehicle (identified as 1 in drawing description), of the Q1 Occupant Vehicle; a print impression can be detected, as long as the hand is unimpaired with coverings such as gloves. While with the Se Cu On-Auto: Finger Print Car Immobilizer this finger print detection is mounted on the dashboard of the vehicle while the SenCora Print System is incorporated into the actual door handles of the vehicle. Once finger print detection is made then the finger print impression is stored within the 250 Item 7 Central Processing Unit of the Q1 Occupant Vehicle to be viewed by policing officers or governing authorities via wireless transmission when needed for occupant identification. In addition, the Se Cu On Finger Print Car Immobilizer is designed to authorize One Hundred fingerprints while the SenCora Print System accepts all fingerprint impartations and or preloaded numeric codes assigned to common users of the Q1 Occupant Vehicle. Although the SenCora Print System 100 Sensor A Finger Print Detection means is not assigned to be used as a mechanism that immobilizes a vehicle it's true presence with in the scope of the present invention is to allow policing authorities and or governing officials the ability to view in both real time and or delayed viewing of all identifiable finger print impressions or numerically assigned codes of each occupant entering and or exiting the vehicle equipped with the SenCora Print System and Method for identifying purposes. Finger print detection by the SenCora Print System can be observed by a policing officers' in car view monitor and compared to other relevant detected sensor actions with in the Q1 Occupant Vehicle (identified as 1 in drawing description) equipped with the SenCora Print System, coupled with documented police data base records.

Each sensor with in the scope of the SenCora Print System is housed with in a thin flexible sensor mat that is incorporated into its region of detection and or realized easily by the human eye to be unlike the Se Cu On-Auto; Finger Print Car immobilizer Scanning Unit. The 100 Sensor A Finger Print Detection means would allow Q2 Policing Vehicles (identified as 2 in drawing description) and or 320 S2 Governing Authorities the ability to detect if the driver or any of the occupants are the owner of the Q1 Occupant Vehicle or if the driver or the occupants are a non-owner by verification of print detections viewed by externally located Q2 Policing Authorities (identified as 2 in drawing description) or 320 SI Governing Authorities. This complete observation would be totally undetected by the occupants of the Q1 Occupant Vehicle (identified as 1 in drawing description) at the time of initial use by the occupant and at the time of surveillance by the Q2 Policing Unit (identified as 2 in drawing description)and or the 320 S1 Governing Authority. Surveillance actions viewed by the policing officer would be downloaded into the 250 Item 7 Central Storage and Processing Unit of the Q1 Occupant Vehicle (identified as 1 in drawing description), to be viewed by the owner of the Q1 Occupant Vehicle (when owner of the Q1 Occupant Vehicle) request of his or her Department of Motor Vehicle an activity report.

As described in paragraph [0000] and [0000] in reference to FIG. 2 the description of SA locations, also known as 100 Sensors A Finger Print Detection Sensors means, serves as one way the finger print detection means can be composed as to be utilized with in the scope of this invention. According to this current invention those who are skilled in the current art may use any necessary finger print detection means to obtain the results of finger print detections. This description is not intended to limit the scope or application of this invention in that the invention is susceptible to modification, variation and change, without departing from spirit of the current invention described.

### 2^{nd} Contact Sensor F is Comprised of (What is Made of)

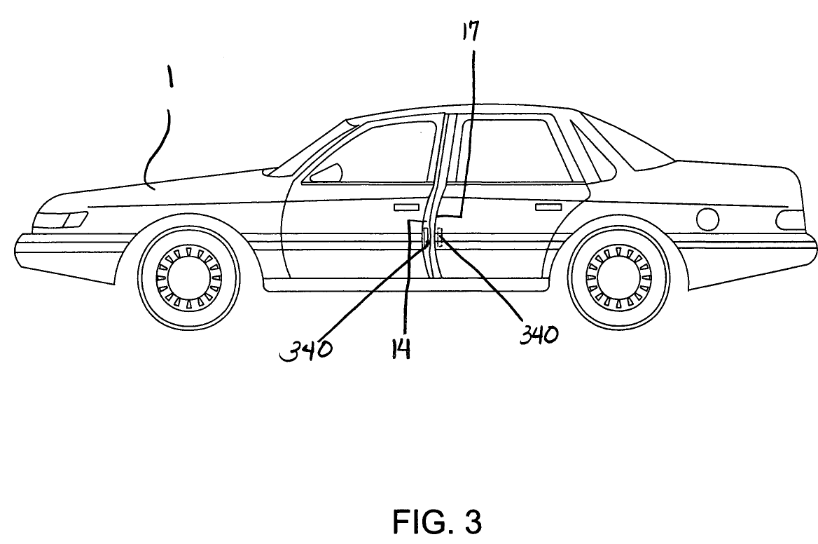

With in the scope of the present invention the next sensor means to receive a point of impact is SF location, also known as 340 Sensor F Door Counter Sensor means as depicted in FIG. 3.

SF location, also known as 340 Sensor F Door Counter Sensor means as depicted in FIG. 2 is depicted as being located externally of Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

SF location, also known as 340 Sensors F Door Counter Sensor means, is applied to Door 23, Door A, Region F, Front Drivers Position, Door 54, Door B, Region X, Front Passengers Position, Door 34, Door C, Region O, Rear Drivers Position, Door 44, Door D Region G, Rear Passenger Position as best mode of obtaining a door counter sensor reading means.

SF location, also known as 340 Sensor F Door Counter Sensor means in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors' usability factor. The description as described within the scope of this invention is offered as an example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method.

The recommended environments for each sensor incorporated with in the scope of this invention is as follows or applied to each sensor according to manufacture recommendations. All components incorporated into system being SenCora Print System are low cost, highly effective, market available sensors and computer components.

It is recommended that sensors located on the exterior side of the vehicle (such as SF location, also known as 340 Sensor F Door Counter Sensor means) be made to endure and conform to temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

It is further recommended that sensors located with in the interior of the vehicle be made to endure and conform to the recommendations temperatures of −40 degrees Celsius to +85 degrees Celsius. Vibration stress per component with in the SenCora Print System should be able to with stand reduced to extreme vibration conditions. Each sensor and component should be able to with stand water and saltwater sprays, oils, brake fluids, solvents, fuels, ect. Thermal shock of reduced to high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the current invention once the entering occupant comes into contact with the door handles of externally placed sensors of Door 44, Door D, Region G, Rear Passenger Position, Door 23, Door A, Region F, Front Drivers Position, Door 34, Door C, Region O, Rear Drivers Position and Door 54, Door B, Region X, Front Passengers Position as to open the vehicle car door by entrance of exterior vehicle door handles the door open action causes a wireless communication of action of door open action to be transmitted to the next means described as MZ location, also known as 777 Micro Controller Node Z Door means used to receive and further transmit actions from the door open action point of activity of Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

FIG. 3 depicts SF location, also known as 340 Sensors F Door Counter Sensor means, as to be in one manor the best described method for applying the present invention as in perspective to SF location, also known as 340 Sensors F Door Counter Sensor means as recommended to be housed with in a thin flexible sensor mat that is incorporated into its region of detection by graphing, under laid, gluing, bolting or any other means necessary needed as to incorporate SF location, also known as 340 Sensors F Door Counter Sensor means to exterior vehicle door jams of Q1 Occupant Vehicle (identified as 1 in drawing description) doors: Exterior vehicle Door jams incorporating the SF location, also known as 340 Sensors F Door Counter Sensor means are located and identified as located onto the door jams of Door 44, Door D, Region G, Rear Passenger Position, Door 23, Door A, Region F, Front Drivers Position, Door 34, Door C, Region O, Rear Drivers Position and Door 54, Door B, Region X, Front Passengers Position locations being considered exterior of Q1 Occupant Vehicle(identified as 1 in drawing description).

Each sensor with in the scope of the SenCora Print System is housed with in a thin flexible sensor mat that is incorporated into its region of detection.

It is left to those skilled in the art of application of SF location, also known as 340 Sensors F Door Counter Sensor means applied to exterior vehicle doorjams of Q1 Occupant Vehicle (identified as 1 in drawing description) further located and identified as Door 44, Door D, Region G, Rear Passenger Position, Door 23, Door A, Region F, Front Drivers Position, Door 34, Door C, Region O, Rear Drivers Position and Door 54, Door B, Region X, Front Passengers Position placed externally of Q1 Occupant Vehicle door jams for proper application by those skilled in the current art but as not to depart from the sincerity of the current invention or change its purpose of use there of.

The following is a process of action as pertains to external SF location, also known as 340 Sensors F Door Counter Sensor means externally located of exterior vehicle door located in position known as Door 44, Door D, Region G, Rear Passenger Position, Door 23, Door A, Region F, Front Drivers Position, Door 34, Door C, Region O, Rear Drivers Position and Door 54, Door B, Region X, Front Passengers Position of Q1 Occupant Vehicle (identified as 1 in drawing description).

FIG. 2 depicts the exterior locations of doors of Q1 Occupant Vehicle (identified as 1 in drawing description) car doors described as Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

Occupant approaches Q1 Occupant Vehicle (identified as 1 in drawing description) and extends his or her unobstructed hand toward the Q1 Occupant Vehicle car door 44, Door D exterior of Q1 Occupant Vehicle (identified as 1 in drawing description) of location Region G, Rear Passenger Position of Vehicle, exterior of Q1 Occupant Vehicle.

Occupant fingers and thumb are placed on the door handle of 44, Door D exterior of Q1 Occupant Vehicle of location Region G, Rear Passenger Position of Vehicle, exterior of Q1 Occupant Vehicle (identified as 1 in drawing description).

Occupant's fingers and thumb causes pressure to be applied to 44, Door D exterior of Q1 Occupant Vehicle (identified as 1 in drawing description) of location Region G, Rear Passenger Position of Vehicle, exterior of Q1 Occupant Vehicle.

SF location, also known as 340 Sensors F Door Counter Sensor means incorporated to 44, Door D exterior of location Region G, Rear Passenger Position of Q1 Occupant Vehicle (identified as 1 in drawing description) exterior door location, of Q1 Occupant Vehicle (identified as 1 in drawing description), receives the action made by the entering occupant pulling the door handle of 44, Door D exterior of location Region G, Rear Passenger Position.

44, Door D exterior of Region G, Rear Passenger Position of Q1 Occupant Vehicle (identified as 1 in drawing description) door is in the open position.

340 Sensors F Door Counter Sensor means sensor detection mat is located on the door jam of vehicle door 44, Door D exterior of Region G, Rear Passenger Position.

340 Sensor F Door Counter Sensor means and sensor detection mats are also located on Doors Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

44, Door D exterior of Region G, Rear Passenger Position of Q1 Occupant Vehicle (identified as 1 in drawing description) door is in the open position, 340 Sensor F Door Counter Sensor means sensor detection mat located on the door jam of the vehicle door is no longer in direct contact with the rib means. As depicted in FIG. 3.

Rib means of Q1 Occupant Vehicle (identified as 1 in drawing description) described as: the metal frame that is used to separate the front door position from the back door position of a vehicle and aids as to supply a lock brace for said door, allowing the vehicle door to be manually or electronically locked in a secured position once the vehicle car door is in the closed position.

Occupant opens 44, Door D exterior of Region G, Rear Passenger Position of Q1 Occupant Vehicle (identified as 1 in drawing description) door. Door is in the open position, sensor detection mat consisting of 340 Sensors F Door Counter Sensor means located on the door jam of the vehicle door is no longer in direct contact with the rib of the vehicle as depicted in FIG. 3.

340 Sensor F Door Counter Sensor means is incorporated into or onto the sensor mat located on the door jam of the vehicle door 44, Door D exterior of location Region G Passenger Position. As Depicted in FIG. 3.

44, Door D exterior location Region G Rear Passenger Position of Q1 Occupant Vehicle (identified as 1 in drawing description) is in the open position and no longer in direct contact with door jam of the vehicle car door, causing a none detection of 340 Sensor F Door Counter Sensor means as depicted in FIG. 3.

This none detection, non contact of 340 Sensor F Door Counter Sensor means incorporated into the 340 Sensors F Door Counter Sensor means detection mat would be interpreted as door open action by the 340 Sensors F Door Counter Sensor means.

340 Sensor F Door Counter Sensor means are self supported by power deriving from the 340 Sensor F Door Counter Sensor means its self.

340 Sensor F Door Counter Sensor means as well as each sensor detection means described through out the scope of the current invention supplies its own individual power supply upon initial impact of action occurring within the first twenty seconds of occupant action of initial door open door close action.

Within the scope of the current invention once the entering occupant opens vehicle car door and comes into contact with the exterior door handle of 44, Door D exterior location Region G Rear Passenger Position of Q1 Occupant Vehicle, applied to exterior vehicle door handles of Region G Rear Drivers Position, 340 Sensor F Door Counter Sensor means as being incorporated into or onto sensor detection mat is located on the rib of vehicle of 44, Door D of Q1 Occupant Vehicle (identified as 1 in drawing description) as door open action. This contact (door open action) causes a wireless communication of described action to be transmitted to the next means described as MZ location, also known as 777 Micro Controller Node Z Doors means.

MZ location, also known as 777 Micro Controller Node Z Doors means is used to receive and further transmit door open door close actions detections of activity to door location D4, Door D located in Region G Rear Passenger Position, externally of Q1 Occupant Vehicle (identified as 1 in drawing description).

Detectable door open door close actions are then transmitted actions sent by wireless communication from 340 Sensor F Door Counter Sensor mate area of detection, to MZ location, 777 Micro Controller Node Z Doors. The location of received action of door open detection transmittals of the entering occupant's door open action is relayed to MZ location, identified as 777 Micro Controller Node Z Doors which receives all actions of activities from all 340 Sensor F Door Counter Sensor means occurring from the external and internal side of the Q1 Occupant Vehicle (identified as 1 in drawing description) doors Door 44, Door D, Region G, Rear Passenger Position, Door 23, Door A, Region F, Front Drivers Position, Door 34, Door C, Region O, Rear Drivers Position and Door 54, Door B, Region X, Front Passengers Position locations where area of action occurred. MZ location, Identified as MZ location, 777 Micro Controller Node Z Doors is referenced by FIG. 4 depiction.

Actions of activities as a door open or door close action that occurs with in the first twenty seconds of initial door open door close action of activity to exterior vehicle doors known as door locations Door 44, Door D, Region G, Rear Passenger Position, Door 23, Door A, Region F, Front Drivers Position, Door 34, Door C, Region O, Rear Drivers Position and Door 54, Door B, Region X, Front Passengers Position are transmitted to MZ location, 777 Micro Controller Node Z Door Detection means.

340 Sensor F Door Counter Sensor means supported by power deriving from the 340 Sensor F Door Counter Sensor means individual power supply built into the 340 Sensor F Door Counter Sensor means own feature as being a sensor.

340 Sensor F Door Counter Sensor means being located externally of exterior vehicle door handles 23, Door A, 54, Door B, 34, Door C, and 44, Door D of the object being the Q1 Occupant Vehicle (identified as 1 in drawing description); operates on a beaconing network. In a beaconing network system sensors transmit beacons to confirm their presents to other network system sensors. This allows sensors that are not affected by action or contact to sleep between beacons. This nonuse of unnecessary sensor activity lowers the sensor duty cycle and extends its battery life. Beacon intervals may range from 12.36 milliseconds to 15.36 ms*2₁₄=251.65824 seconds at 250 kbit/s from 24 milliseconds to 24 ms*2₁₄=393.216 seconds at 40 kbit/s and 48 milliseconds at 48 ms*2₁₄=786.432 seconds at 200 kbit/s; to obtain the benefits of low product cost or may be under manufacture recommended or best applied beacon intervals settings suitable to the present invention identified as SenCora Print System.

340 Sensor F Door Counter Sensor means as well as each sensor detection means described through out the scope of the current invention supplies it own individual power supply upon initial impact of action occurring with in the first twenty seconds on impact. An alternate power source deriving from the 220 Engine Battery means as depicted in FIG. 9 serves as the more robust long term power source that supplies each sensor detection means of its sensor type with continual, long term power beyond the first twenty seconds of initial sensor impact, as actions of impact or actions of activity occur against located sensor detection means.

Transmitted wireless communication means of the first twenty seconds of initial door open door close activity or action as pertaining to the 340 Sensor F Door Counter Sensor means is then further relayed as the detected door open or door closed activity are transmitted via wireless transmission from the exterior vehicle door handle, Region D Rear Passengers Position to MZ location, 777 Micro Controller Node Z Doors.

MZ location, 777 Micro Controller Node Z Doors transmits via wireless transmission means, such as wireless radio transmission means (or implemented by best source of wireless transmission means by those skilled in the present art) to 250 Item 7 Central Storage and Processing Unit.

Mz location, 777 Micro Controller Node Z Doors is on a pitch (frequency) that can't be identified by any other MZ location, Micro Controller Node of its assigned frequency pitch with in the Q1 Occupant Vehicle.

MZ location, 777 Micro Controller Node Z Doors further transmits received action of activates to the 250 Item 7 Central Storage and Processing Unit for storage of information, where transmitted received action of impact transmitted to 250 Item 7 Central Storage and Processing Unit can be viewed via wireless means by Q2 Policing Vehicles and or 320 S1 Governing Authorities by either real time viewing or delayed time viewing of occurred actions of impact detected by each affected sensor documented.

250 Item 7 Central Storage and Processing Unit receives the transmission of door open or door closed detection and location of occurrence from Mz location, 777 Micro Controller Node Z Doors and documents the time, date and location of occurrence of the door open or door close action of activity that was detected from Door D4, Door D of location Region G Rear Passengers Position from with in the Q1 Occupant Vehicle (identified as 1 in drawing description).

250 Item 7 Central Storage and Processing Unit retains and or transmits all actions of 340 Sensor F Door Counter Detection means from Region G Rear Passengers Position, to observing Q2 Police Officer units on board 250 Item 7 Central Storage and Processing Unit or 320 S1 Governing Authorities who request on board viewing and real time or stored actions of occurrences from with in the Q1 Occupant Vehicle (identified as 1 in drawing description).

340 Sensor F Door Counter Detection means being located externally of Doors Door 44, Door D, Region G, Rear Passenger Position, Door 23, Door A, Region F, Front Drivers Position, Door 34, Door C, Region O, Rear Drivers Position and Door 54, Door B, Region X, Front Passengers Position of the object being the Q1 Occupant Vehicle (identified as 1 in drawing description); operates on a beaconing network. (In a beaconing network system sensors such as sensors detection means described within the scope of the current invention as being 100 Sensor A Fingerprint, 110 Sensor B Weight, 120 Sensor C Height, 130 Sensor D Breathing, 140 Sensor E Heart Rate and 340 Sensor F Door Counter) transmitted beacons confirm their presents to other network receivers identified as MZ locations of its given sensor detection types.

340 Sensor F Door Counter Detection means transmits detected actions of activities to MZ location, 777 Micro Controller Node Z Doors from the 44, Door D door position of activity. This allows 340 Sensor F Door Counter Detection means sensors that are not affected by actions of door detection activities or senor detection mat to vehicle door jam contact not receiving an action of activity to sleep between beacons. This nonuse of unnecessary sensor activity lowers the sensor duty cycle and extends its life.

Occupant completes entrance of Door 44, Door D, Region G, Rear Passenger Position door position of Q1 Occupant Vehicle (identified as 1 in drawing description) as removing his fingers and thumb from the Door 44, Door D, Region G, Rear Passenger Position vehicle entrance handle externally located of vehicle door handle.

340 Sensor F Detection mat located on Door 44, Door D, Region G, door jam is in direct contact with sensor mat located on rib (Rib of Q1 Occupant Vehicle described as: the metal frame that is used to separate the front door position from the back door position of a vehicle and aids as to supply a lock brace for said door, allowing the vehicle door to be manually or electronically locked in a secured position once the vehicle car door is in the closed position) of 44, Door D, door position of location Region G Rear Passengers Position of Q1 Occupant Vehicle will have a detectable reading of 44, Door D door position is in the closed position.

340 Sensor F Door Counter Detection means and 340 Sensor F Door Counter Detection means located on rib of vehicle in direct contact with each other delivers a door closed detection.

Door closed detection indicated by 340 Sensor F Door Counter Detection means and 340 Sensor F Door Counter Detection means located on rib of vehicle in direct contact with each other is a door closed action that is transmitted to Mz location, 777 Micro Controller Node Z Doors.

MZ location, 777 Micro Controller Node Z Doors sends via wireless transmission, door closed detection transmission to 250 Item 7 Central Storage and Processing Unit.

250 Item 7 Central Storage and Processing Unit, documents this received transmittal by date, time and region of activity.

Power there for is no longer flowing to the 340 Sensor F Door Counter Detection means sensor detection mat of 44, Door D door position, location Region G Rear Passenger Position, thus indicating to 340 Sensor F Door Counter Detection means door open action has ended and is now in the door closed position of location 44, Door D door position, location Region G Rear Passenger Position, externally of Q1 Occupant Vehicle.

When Door 44, Door D door position activity is in the closed position from within location Region G Rear Passenger Position, no detection reading of activity is no longer indicated from 340 Sensor F Door Counter Detection means detection mat and 340 Sensor F Door Counter Detection means no longer sends detected actions of occurrences to MZ location, 777 Micro Controller Node Z Doors.

MZ location, 777 Micro Controller Node Z Doors no longer receives or sends received transmittals of recorded actions of activities to 250 Item 7 Central Storage and Processing Unit.

This would conclude the external 340 Sensor F Door Counter Detection means detection as it applies to the exterior vehicle door locations of vehicle door location identified as Doors Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

With in the given example this would as well conclude the external 340 Sensor F Door Counter Detection means detection as it applies to the exterior vehicle door location of Door 44, Door D, Region G, and Rear Passenger Position of the Q1 Occupant Vehicle (identified as 1 in drawing description).

Although, particular embodiments of the current invention have been described and illustrated herein, it is recognized that modifications and variations may be implemented or incorporated by those skilled in the art and consequently, it is intended that the claims be interpreted as to freely add or adjust required modifications and equivalents as to obtain the intended nature of the object of the current invention described as SenCora Print System.

On the market there are an innumerable amount of door indication and or door counter systems detection devices. With in the scope of the present art however it is to be noted that the 340 Sensor F Door Counter means is a typical sensor device that is as well as all sensor devices with in the scope of the prior art market available devices not particularly new in creation in relations to current art. Prior market available door open detection devices are used to alert shop owners of entering and exiting parties as well as used in a manor as to count the number of occupants that enter and exit an establishment.

340 Sensor F Door Counter Sensor is used together with described additional sensors with in the present art to produce an end result that determines the viewing of human attributes from a transportation stand point as to allow out side sources such as equipped SenCora Print policing vehicles identified as Q2 Policing Vehicles (identified as 2 in drawing description) and 320 S1 Governing Authorities who may request on board viewing, real time or stored actions of door open door closed actions of occurrences that have or is deriving from with in the Q1 Occupant Vehicle (identified as 1 in drawing description) with out Q2 Policing Vehicles (identified as 1 in drawing description) approaching the vehicle. However, 340 Sensor F Door Counter means used together with the combined SenCora Print device as a whole will produce an end result that determines the viewing of the number of times and frequency vehicle car doors are in motion as well as the exact time vehicle cars doors are in the open position from a transportation stand point further allowing out side sources such as Q2 Policing Vehicles (identified as 2 in drawing description) and 320 S1 Governing Authorities to view sensor detections with out approaching the vehicle serving as the objective of utilizing the 340 Sensor F Door Counter means.

### 3^{rd} Contact Sensor B as Applied 240 Item 2 Car Seat or Couch of Vehicle

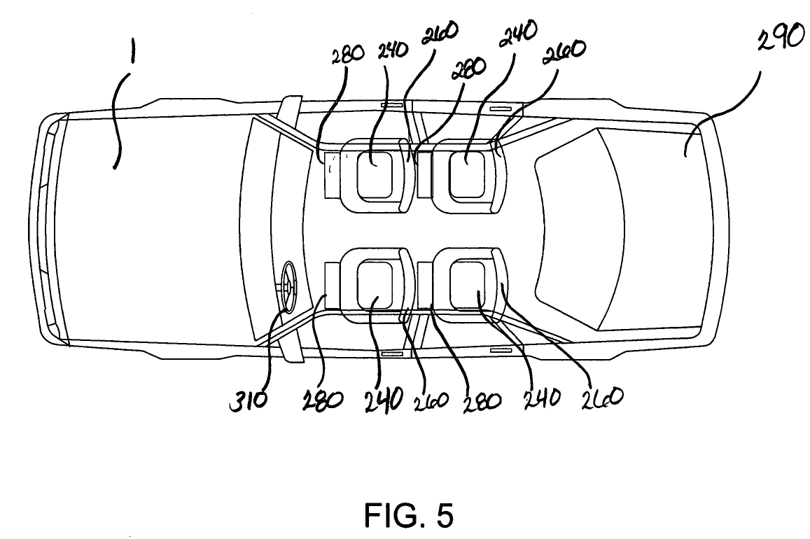

With in the scope of the present invention the next sensor means to receive a point of impact is the SB location, also Identified as 110 Sensors B Weight Detection means as being incorporated into 240 Item 2 Car Seat and or Couch, of Q1 Occupant Vehicle (identified as 1 in drawing description) as depicted in FIG. 5.

SB location, also known as SB Location, 110 Sensor B Weight Detection means as depicted in FIG. 5 as being incorporated into 240 Item 2 Car Seat and or Couch, is also depicted as being located in Region's F, Front Drivers Position, Region X Front Passenger's Position, Region O Rear Drivers Position and Region G Rear Passenger's Position internally of the Q1 Occupant Vehicle (identified as 1 in drawing description).

SB location, also known as 110 Sensors B Weight Detection means, is applied to 240 Item 2 Car Seat or Couch of Region F Front Drivers Position, Region X Front Passenger's Position, Region O Rear Drivers Position and Region G Rear Passenger's Position is internally located with in Q1 Occupant Vehicle (identified as 1 in drawing description).

SB Location, 110 Sensor B Weight Detection means as being applied to 240 Item 2 Car Seat and or Couch, of the Q1 Occupant Vehicle in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors usability factor. This sensor technology as applied to 240 Item 2 Car Seat or Couch of Q1 Occupant Vehicle is recommended to be sandwiched between two thin flexible polyester sheets which have electronically conductive electrodes deposited in various patterns. The in-side surface of one sheet forms a row pattern, while the inner surface forms employees a column pattern. The spacing between the rows and columns varies according to sensor application and can be as small as 0.5 mm.

The recommended environments for each sensor incorporated with in the scope of this invention is as follows or applied to each sensor according to manufacture recommendations. All components incorporated on to 110 Sensor B Weight Detection means of the Q1 Occupant Vehicle system being identified as the SenCora Print System are low cost, highly effective, market available sensors and computer components.

It is further recommended that sensors more particularly 110 Sensor B Weight Detection means located with in the interior of the vehicle be made to endure and conform to the recommendations temperatures of −40 degrees Celsius to +85 degrees Celsius. Vibration stress per component with in the SenCora Print System should be able to with stand reduced to extreme vibration conditions. Each sensor and component should be able to with stand water and saltwater sprays, oils, brake fluids, solvents, fuels, ect. Thermal shock of reduced to high-temperature operation plus frequent cold-water splashing as well as being equipped with a variance of other protective factors that would enhance the life of each component under normal to extreme vehicle circumstances.

It is further recommended that sensors located with in the exterior of the vehicle is made to endure and conform to the recommendations temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the present invention once the entering occupant's body is seated properly as in the seated position of the Region G, Rear Passenger Position and comes into contact with the 240 Item 2 Car Seat or Couch located with in the Q1 Occupant Vehicle (identified as 1 in drawing description) with in the impacted region, a wireless communication of the impacted action of area impact caused by the seated occupant is then transmitted to the next means described as MZ location, also known as 160 Micro Controller Node Z Weight means.

### Sensor B Weight Detection Means Attached to the 240 Item 2 Car Seat or Couch

FIG. 5 depicts SB location, also known as 110 Sensor B Weight Detection means, as being applied to 240 Item 2 Car Seat and or Couch internally of Q1 Occupant Vehicle to be in one manor the best described method for applying the present invention.

In perspective to SB location, also known as 110 Sensor B Weight Detection means, applied to 240 Item 2 Car Seat and or Couch (internally located within Q1 Occupant Vehicle) is recommended to be housed with in a thin, durable, flexible, plastic sensor mat that is incorporated onto 240 Item 2 Car Seat and or Couch being applied just beneath the first layer of the 240 Item 2 Car Seat and or Couch or applied to the exterior surface of the 240 Item 2 Car Seat and or Couch internally of Q1 Occupant Vehicle (identified as 1 in drawing description) of Regions F Front Drivers Position, Region X Front Passenger's Position, Region O Rear Drivers Position and Region G Rear Passenger's Position internally located with in Q1 Occupant Vehicle (identified as 1 in drawing description) and as being incorporated or applied to the 240 Item 2 Car Seat and or Couch by graphing, under laid, gluing, bolting or any other means necessary needed by those skilled in the art.

This SB location, Identified as 110 Sensor B Weight Detection means recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. This housing unit for the SB location, Identified as 110 Sensor B Weight Detection means and as being incorporated within 240 Item 2 Car Seat or Couch of Q1 Occupant Vehicle.

### How Sensor B is Used

110 Sensor B Weight Detection means as applied to 240 Item 2 Car Seat or Couch (internally located within Q1 Occupant Vehicle) receives the occupants weight or pressure applied as occupant being seated on 240 Item 2 Car Seat or Couch, while simultaneously the occupant is leaning as to be applying pressure with his or her back to the 260 Item 3 Car Seat Back Rest of Q1 Occupant Vehicle located in Region G Rear Passenger Position of Q1 Occupant Vehicle (identified as 1 in drawing description).

240 Item 2 Car Seat or Couch of vehicle are located in Region F Front Drivers Position, Region X Front Passenger's Position, Region O Rear Drivers Position and Region G Rear Passenger's Position incorporated with SB location, Sensor B Weight Detection means with in the 240 Item 2 Car Seat or Couch of vehicle. Each 110 Sensor B Weight Detection means in its given region may share the same sensor mat but each sensor will have its own tracing path as not to touch or cross over a sensor trace path that is designed to detect a different sensor action.

110 Sensor SB location, Sensor B Weight Detection means regional sensor mat areas do not share additional sensor detection sensors.

SA location, 100 Sensor A Fingerprint Detection means, SC location, 120 Sensor C Height Detection means, SD location, 130 Sensor D Breathing Detection means and SE location, 140 Sensor E Heart Rate Detection means do not share the same sensor detection mats with SB location, 110 Sensor B Weight Detection means as being incorporated into 240 Item 2 Car Seat Couch or any region located with in the Q1 Occupant Vehicle (identified as 1 in drawing description).

Occupant is seated on 240 Item 2 Car Seat or Couch of vehicle as in a seated position.

Occupant is leaning with his back against 260 Item 3 Car Seat Backrest of vehicle as to apply pressure to 260 Item 3 Car Seat Backrest.

Occupant is applying pressure to 240 Item 2 Car Seat or Couch of vehicle with his or her gluteus maximus while applying pressure with the back of the thigh as one normally is seated on a seat or couch in the seated position.

SB location, 110 Sensor B Weight incorporated into 240 Item 2 Car Seat or Couch of the Region G Rear Passenger Position of the vehicle is now detecting pressure of weight from the seated occupant's thighs and gluteus maximus area and occupant is seated on the 240 Item 2 Car Seat or Couch of the Q1 Occupant Vehicle (identified as 1 in drawing description).

Sensor SB location, 110 Sensor B Weight detects weight of occupant and transmits the detection of the impact of action as appied to the 240 Item 2 Car Seat or Couch by wireless transmission means to Mz location, 160 Micro Control Node Z Weight Detection means.

MZ location, 160 Micro Control Node Z Weight. Detection then transmits detected 110 Sensor B Weight Detection action of impact coming from Region G being Rear Passengers Position of Q1 Occupant Vehicle, to 250 Item 7 Central Storage and Processing Unit.

MZ Location, 160 Micro Control Node Z Weight Detection is transmitted by way of wireless transmission. MZ location, 160 Micro Control Node Z Weight Detection means is on a pitch (frequency) that can not be identified by any other Micro Controller Node Z means within the Q1 Occupant Vehicle (identified as 1 in drawing description).

MZ location, 160 Micro Control Node Z Weight Detection means then further transmits wireless transmission of the received action of impact to 250 Item 7 Central Storage and Processing Unit for date, time, and impact of region where action of impact occurred for comparable data filing.

250 Item 7 Central Storage and Processing Unit retains and transmits all actions of 110 Sensor B Weight Detections from Region G Rear Passengers Position of Q1 Occupant Vehicle (identified as 1 in drawing description) to observing Q2 Policing Units (identified as 2 in drawing description)and or 320 S1 Governing Authority stations who request on board viewing of real time or stored actions of occurrences recorded by the 250 Item 7 Central Storage and Processing Unit located with in the Q1 Occupant Vehicle's SenCora Print System.

However, after the first twenty seconds of received action of impact, 110 Sensor B Weight Detection means housed with in sensor detection mat incorporated into 240 Item 2 Car Seat or Couch of Region G Rear Passenger Position of the vehicle, has detected a pressure or indicated action of impact. 110 Sensor B Weight Detections mat would no longer draw power from its self but would then power down causing a preprogrammed command for a continual power supply from the 220 Engine Battery to take over as a continual source of power to all 110 Sensor B Weight Detections means housed with in the sensor detection mat, more particularly incorporated with in the 240 Item 2 Car Seat or Couch of Region G Rear Passengers Position of Q1 Occupant Vehicle (identified as 1 in drawing description).

The demand or alternative source of continual robust power will come from the direction of the 250 Item 7 Central Storage and Processing Unit. 250 Item 7 Central Storage and Processing Unit will receive transmission from 160 MZ location Micro Control Node Weight Detection means, Region G Rear Passengers Position of Q1 Occupant Vehicle (identified as 1 in drawing description) where initial area of impact occurred.

250 Item 7 Central Storage and Processing Unit then receives this transmitted action of impact from 160 MZ location, Micro Control Node Z Weight Detection means Region G Rear Passengers Position and sends out a wireless transmittal to 350 Micro Controller Node Z Engine Battery to awake 210 Power Control Box.

350 Micro Controller Node Z Engine Battery relays to 210 Power Control Box to awake and open power valve to 110 Sensor B Weight Detection mat located in Region G Rear Passengers Position of Q1 Occupant Vehicle (identified as 1 in drawing description).

210 Power Control Box responds by wireless demand and wakens to the response of 350 Micro Controller Node Z Engine Battery, thus opening the power valve to 110 Sensor B Weight Detection mat of Region G Rear Passengers Position of Q1 Occupant Vehicle (identified as 1 in drawing description).

210 Power Control Box is hard wired or as to be connected by identifiable means known as the 200 Electrical Highway Wire means to the 210 Power Control Box.

Upon the 210 Power Control Box receiving the demand to open power to 110 Sensor B Weight Detection also known as the 200 Electrical Highway Wire means hardwired line, power is released from the 220 Engine Battery back to the 210 Power Control Box power line.

With in the 210 Power Control Box multiple sensor power lines representing each type of detection sensor is contained with in the 210 Power Control Box release line.

Power is released from the 220 Engine Battery through the 210 Power Control Box release line and is directed to flow through to the 110 Sensor B Weight Detection line by demand of the 210 Power Control Box.

200 Electrical Highway Wire means carries the hard wired commanded and transferred power flow to the 210 Power Control Box then to 110 Sensor B Weight Detection line with in the 210 Power Control Box. Each type of sensor power line through out the scope of the current invention is contained with in the 210 Power Control Box.

200 Electrical Highway Wire means supplies power to the 110 Sensor B Weight Detection mat where impact of action such as a pressure of application and weight detection has occurred.

200 Electrical Highway Wire means is incased with in a durable plastic casing and has multiple sensor lines housed with in the same durable plastic casing. Once sensor power line exits the 210 Power Control Box and has been traced to the 240 Item 2 Car Seat or Couch of region of impact. The 110 Sensor B Weight Detection mat incorporated with in the 240 Item 2 Car Seat or Couch of Region F Front Drivers Position of the Q1 Occupant Vehicle (identified as 1 in drawing description), the 210 Power Control line is thinned out and is incorporated into the 240 Item 2 Car Seat or Couch comprising of the 110 Sensor B Weight Detection mat.

This insulated tracing 200 Electrical Highway Wire means line as pertains to all interior sensors that requires a more robust power supply will be provided the method of insulation as being housed with in durable plastic casing accommodation in order to deliver this more robust power supply when an action of impact beyond twenty seconds of initial impact is required.

110 Sensor B Weight Detection line runs from the 210 Power Control Box to the 110 Sensor B Weight Detection mat region of impact being Region F Front Drivers Position following the exampled path currency as being located with in the of Q1 Occupant Vehicle. Dipiction as observed in FIG. 9 displays where all paths of the 200 Electrical Highway Wire means lines are placed as to deliver a more robust power supply when demanded by action of impact beyond twenty seconds of initial impact is required. As well, FIG. 1 shows a depiction of all aspects of 200 Electrical Highway Wire means lines and sensor detection mat areas including 110 Sensor B Weight Detection line of the Region F Front Drivers Position.

110 Sensor B Weight Detection hard wired power line also identified as 200 Electrical Highway Wire means runs from the 210 Power Box that is located with in the dashboard of the Q1 Occupant Vehicle. 110 Sensor B Weight Detection Line follows a path that leads to the 110 Sensor B Weight Detection mat as can be observed in FIG. 1 drawing.

110 Sensor B Weight Detection line also identified as 200 Electrical Highway Wire means, thins out as to be incorporated into the 110 Sensor B Weight Detection mat incorporated in the 240 Item 2 Car Seat or Couch of Region G Rear Passengers Position of Q1 Occupant Vehicle (identified as 1 in drawing description).

110 Sensor B Weight Detection hard wire line also identified as 200 Electrical Highway Wire means delivers the needed more robust power supply to the 110 Sensor B Weight Detection mat incorporated in the 240 Item 2 Car Seat or Couch of Region G Rear Passengers Position of Q1 Occupant Vehicle (identified as 1 in drawing description).

110 Sensor B Weight Detection mat incorporated in the 240 Item 2 Car Seat or Couch of Region G Rear Passengers Position of Q1 Occupant Vehicle (identified as 1 in drawing description) detects the continual impact of action as long as an action of impact is being applied to the 240 Item 2 Car Seat or Couch of Q1 Occupant Vehicle (identified as 1 in drawing description).

110 Sensor B Weight detects and transmits weight action of impact by wireless transmission means to 160 Micro Controller Node Z Weight Detection.

160 Micro Controller Node Z Weight Detection then transmits detected 110 Sensor B Weight Detection actions of impact deriving from Region G Rear Passengers Position of Q1 Occupant Vehicle to 250 Item 7 Central Storage and Processing Unit. 160 Micro Controller Node Z Weight Detection means is transmitted by way of wireless transmission means that is on a pitch (frequency) that can not be identified by any other Micro Controller Node Z with in the Q1 Occupant Vehicle (identified as 1 in drawing description).

160 Micro Controller Node Z Weight Detection then further transmits the received action of impact to 250 Item 7 Central Storage and Processing Unit for date, time, and impacted region where action of impact occurred and comparable data is filed away for future viewing.

250 Item 7 Central Storage and Processing Unit retains and or transmits all actions of 110 Sensor B Weight Detection actions of impact from Region G Rear Passengers Position of Q1 Occupant Vehicle to Q2 Policing Units (identified as 2 in drawing description) and or 320 S1 Governing Authorities who may request such information in either real time or delayed time for future viewing.

250 Item 7 Central Storage and Processing Unit sends out a wireless demand for confirmation that 110 Sensor B Weight Detection mat of Region G Rear Passenger's Position is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that 110 Sensor B Weight Detection mat is receiving power from the 220 Engine Battery.

350 Micro Controller Node Z Engine Battery further transmits the wireless demand to confirm that power valve was opened to 110 Sensor B Weight Detection to 210 Power Control Box.

210 Power Control Box receives wireless transmittal demand from 350 Micro Controller Node Z Engine Battery. 210 Power Control Box sends back a wireless response to 350 Micro Control Node Z Engine Battery confirming that 110 Sensor B Weight Detection valve is open and receiving power fed to Region G Rear Passengers Position of Q1 Occupant Vehicle, 110 Sensor B Weight Detection mat of Region G Rear Passengers Position of Q1 Occupant Vehicle (identified as 1 in drawing description) is receiving an action of impact.

350 Micro Controller Node Z Engine Battery receives wireless transmission from 210 Power Control Box confirmation that that power valve was opened and further transmits the confirmation to 250 Item 7 Central Storage and Processing Unit.

250 Item 7 Central Storage and Processing Unit then records the exact time, date region of activity of each twenty seconds of impact received to region of activity being Region G Rear Passengers Position of Q1 Occupant Vehicle (identified as 1 in drawing description).

When region (being Region G Rear Passenger Position) is no longer impacted by an action of activity as to no indication of weight detection is detected from the 110 Sensor B Weight Detection mat incorporated into the 240 Item 2 Car Seat or Couch of the Q1 Occupant Vehicle; 160 Micro Controller Node Z Weight Detection means no longer sends action of impact received transmittals to 250 Item 7 Central Storage and Processing Unit.

250 Item 7 Central Storage and Processing Unit sends a wireless demand to 350 Micro Controller Node Z Engine Battery to close and confirm that 220 Engine Battery power to 110 Sensor B Weight Detection mat has stopped.

350 Micro Controller Node Z Engine Battery wirelessly transmits this demand to that power has stopped to the 210 Power Control Box of Q1 Occupant Vehicle (identified as 1 in drawing description).

210 Power Control Box, receives the demand to close 110 Sensor B Weight Detection valve and to confirm that power has been closed.

210 Power Control Box closes the power from the receiving line of the 110 Sensor B Weight Detection mat thus meaning that power valve to 110 Sensor B Weight Detection mat is closed and is not delivering power any longer.

Power therefore is no longer flowing to the 110 Sensor B Weight Detection mat incorporated into 240 Item 2 Car Seat or Couch and 210 Power Control Box relays a wireless transmission to 350 Micro Controller Node Z Engine Battery that valve is closed and power has ended.

350 Micro Controller Node Z Engine Battery by wireless transmission sends the confirmation that valve is closed to 250 Item 7 Central Storage and Processing Unit confirming valve is closed to 110 Sensor B Weight Detection mat incorpoarated into 240 Item 2 Car Seat or Couch of Region G Rear Passenger Position of Q1 Occupant Vehicle (identified as 1 in drawing description).

250 Item 7 Central Storage and Processing Unit documents the confirmation by date, time, and region of occurrences and compares date to past actions of impacts as priorly recorded by the 250 Item 7 Central Storage and Processing Unit.

### 4^{th} Contact Sensor C Height and Sensor E Heart Rate 260 Item 3 Car Seat Back Rest of Q1 Occupant Vehicle

With in the scope of the present invention the next sensor means to receive a point of impact is the SB location, Identified as 120 Sensors C Height Detection means and 140 Sensor E Heart Rate Detection means as being incorporated into 260 Item 3 Car Seat Back Rest of Q1 Occupant Vehicle is depicted in FIG. 5.

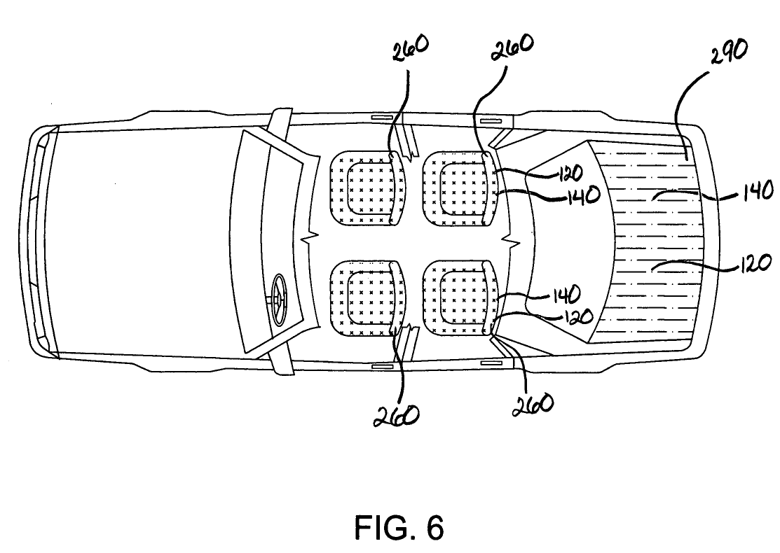

SB location, also known as SB Location, 120 Sensors C Height Detection means and 140 Sensor E Heart Rate Detection means as depicted in FIG. 1 and FIG. 6 as being incorporated into or onto 260 Item 3 Car Seat Back Rest, is also depicted as being located in Region's F, Front Drivers Position, Region X Front Passenger's Position, Region O Rear Drivers Position and Region G Rear Passenger's Position internally of the Q1 Occupant Vehicle.

SB location, also known as 120 Sensors C Height Detection means and 140 Sensor E Heart Rate Detection means as applied to 260 Item 3 Car Seat Back Rest of Region's F Front Drivers Position, Region X Front Passenger's Position, Region O Rear Drivers Position and Region G Rear Passenger's Position are internally located with in Q1 Occupant Vehicle (identified as 1 in drawing description).

SB Location, 120 Sensors C Height Detection means and 140 Sensor E Heart Rate Detection means as being applied to 260 Item 3 Car Seat Back Rest, of the Q1 Occupant Vehicle in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors usability factor. This sensor technology as applied to 260 Item 3 Car Seat Back Rest of Q1 Occupant Vehicle is recommended to be sandwiched between two thin flexible polyester sheets which have electronically conductive electrodes deposited in various patterns. The in-side surface of one sheet forms a row pattern, while the inner surface forms employees a column pattern. The spacing between the rows and columns varies according to sensor application and can be as small as 0.5 mm.

The recommended environments for each sensor incorporated with in the scope of this invention is as follows or applied to each sensor according to manufacture recommendations. All components incorporated on to both 120 Sensors C Height Detection means and 140 Sensor E Heart Rate Detection means of the Q1 Occupant Vehicle (identified as 1 in drawing description) system being identified as the SenCora Print System are low cost, highly effective, market available sensors and computer components.

It is recommended that sensors more particularly sensors 120 Sensors C Height Detection means and 140 Sensor E Heart Rate Detection means are to be located on the interior side of the vehicle be made to endure and conform to temperatures of −40 degrees Celsius to +85 degrees Celsius. With a vibration stress lever being of reduced levels, able to with stand water spray, with a thermal shock factor of reduced rate of change as well as other protective factors that would enhance the life of each component under normal to extreme vehicle circumstances.

It is further recommended that sensors located with in the exterior of the vehicle is made to endure and conform to the recommendations temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the present invention once the entering occupant's body is seated properly as in the seated position of the Region O, Rear Driver Position as to be leaning with his back and applying pressure with his back to the 260 Item 3 Car Seat Back Rest as being located in the Region O Rear Driver Position of the Q1 Occupant Vehicle (identified as 1 in drawing description) with in the area impact of action region, a wireless communication of the impacted actions of impacts caused by the seated occupant whoms back is applying pressure of applied action to the 260 Item 3 Car Seat Back Rest of Q1 Occupant Vehicle is then transmitted to the next means described as MZ location, also known as 170 Micro Controller Node Z Height means and MZ location, 190 Micro Control Node Z Heart Rate Detection means.

### Sensor C Height Detection Means and Sensor E Heart Rate Means Attached to the 260 Item 3 Car Seat Back Rest

FIG. 6 depicts 120 Sensors C Height Detection means and 140 Sensor E Heart Rate means as being applied to 260 Item 3 Car Seat Back Rest internally of Q1 Occupant Vehicle (identified as 1 in drawing description) to be in one manor the best described method for applying the present invention.

In perspective to 120 Sensors C Height Detection means and 140 Sensor E Heart Rate means, applied to 260 Item 3 Car Seat Back Rest (internally located within Q1 Occupant Vehicle) is recommended to be housed with in a thin, durable, flexible, plastic sensor mat that is or incorporated onto or into 260 Item 3 Car Seat Back Rest being applied just beneath the first layer of the 260 Item 3 Car Seat Back Rest or applied to the exterior surface of the 260 Item 3 Car Seat Back Rest internally of Q1 Occupant Vehicle (identified as 1 in drawing description) of Regions F Front Drivers Position, Region X Front Passenger's Position, Region O Rear Drivers Position and Region G Rear Passenger's Position internally located with in Q1 Occupant Vehicle (identified as 1 in drawing description) and as being incorporated or applied to the 260 Item 3 Car Seat Back Rest by graphing, under laid, gluing, bolting or any other means necessary needed by those skilled in the art.

The 120 Sensors C Height Detection means and 140 Sensor E Heart Rate means recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. This housing unit for 120 Sensors C Height Detection means and 140 Sensor E Heart Rate means and as being incorporated within 260 Item 3 Car Seat Back Rest of Q1 Occupant Vehicle.

It is to be understood that 120 Sensors C Height Detection means and 140 Sensor E Heart Rate means while incorporated into or onto 260 Item 3 Car Seat Back Rest located in the Region's of Regions F Front Drivers Position, Region X Front Passenger's Position, Region O Rear Drivers Position and Region G Rear Passenger's Position internally located with in Q1 Occupant Vehicle (identified as 1 in drawing description) are recommended to be incorporated in the following way.

260 Item 3 Car Seat Back Rest incorporated with 120 Sensor C Height Detection mat is sectioned off in one inch sections in a horizontal pattern with in the incorporated 260 Item 3 Car Seat Back Rest area. Each section of the 120 Sensor C Height mat is calculated into approximate height ranges. As pressure is applied to one or more of the height range sections, the last height range section area to have a continual source of pressure applied to it will be the indication of the approximate height of the occupant leaning with his back on the 260 Item 3 Car Seat Back Rest sensor panel of the vehicle.

120 Sensor C Height Detection mat incorporated into the 260 Item 3 Car Seat Back Rest of vehicle is sectioned off into five section panels. Each panel section is approximately one inch in height and covers the entire width of the 260 Item 3 Car Seat Back Rest area section panels. This 260 Item 3 Car Seat Back Rest area section panel are incorporated with 120 Sensor C Height detection sensor mat that covers the entire 260 Item 3 Car Seat Back Rest area located in Region's F Front Drivers Position, Region X Front Passenger's Position, Region O Rear Drivers Position and Region G Rear Passenger's Position. This path of action in description covers activity with in the Region O, Rear Driver Position of Vehicle.

The 120 Sensor C Height detection mat located with in Region's F Front Drivers Position, Region X Front Passenger's Position, Region O Rear Drivers Position and Region G Rear Passenger's Position are sectioned off into five horizontal section panels. Each 120 Sensor C Height detection panels have a lower, middle and upper height detection range assigned to each sensor mat section panel.

120 Sensors C Height Detection means is housed with in the same sensor detection mat as 140 Sensor E Heart Rate means but neither sensor types do not cross sensor detection paths. 140 Sensor E Heart Rate means is recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. Each sensor sharing the same sensor detection mat will not cross sensor detection paths nor will not cross contaminate sensor detections received upon actions of impacts and will not interfere with height panel detections detection of impacts received by the 260 Item 3 Car Seat Back Rest areas.

120 Sensors C Height Detection means and 140 Sensor E Heart Rate means as applied into or onto 260 Item 3 Car Seat Back Rest (internally located within Q1 Occupant Vehicle) receives the occupants actions of impacts of applied pressure of height and applied sound indications of heart beat as occupant is leaning with his back against 260 Item 3 Car Seat Back Rest, located in Region O, Rear Driver Position of Q1 Occupant Vehicle.

260 Item 3 Car Seat Back Rest of vehicle are located in Region's F Front Drivers Position, Region X Front Passenger's Position, Region O Rear Drivers Position and Region G Rear Passenger's Position and are incorporated with 120 Sensors C Height Detection means and 140 Sensor E Heart Rate means with in the 260 Item 3 Car Seat Back Rest of vehicle. Each sensor detection means in its given region may share the same sensor mat but each sensor will have its own tracing path as not to touch or cross over a sensor trace path that is designed to detect a different sensor action.

260 Item 3 Car Seat Back Rest of Q1 Occupant Vehicle are located in Region's F Front Drivers Position, Region X Front Passenger's Position, Region O Rear Drivers Position and Region G Rear Passenger's Position and are incorporated with 120 Sensor C Height Detection means and 140 Sensor E Heart Rate Detection means both located with in the 260 Item 3 Car Seat Back Rest of Q1 Occupant Vehicle. 120 Sensor C Height Detection means and 140 Sensor E Heart Rate Detection means in its given region may share the same sensor mat but each sensor will have its own tracing path as not to touch or cross over a sensor trace path that is designed to detect a different sensor action.

140 Sensor E Heart Rate Detection means and 120 Sensor C Height Detection means regional sensor mat areas do share additional sensor detection mats as being in Region P Trunk of Q1 Occupant Vehicle (identified as 1 in drawing description). As depicted in FIG. 6.

140 Sensor E Heart Rate Detection means and 120 Sensor C Height Detection means do share the same sensor detection mats but do not share the same sensor mat tracing paths. 140 Sensor E Heart Rate Detection means and 120 Sensor C Height Detection means incorporated into Region P Trunk of Q1 Occupant Vehicle (identified as 1 in drawing description) is identified in FIG. 6.

Occupant is seated on 240 Item 2 Car Seat or Couch of vehicle as in a seated position.

Occupant is leaning with his or back against 260 Item 3 Car Seat Back Rest of vehicle as to apply pressure to the 260 Item 3 Car Seat Back Rest with his back.

Occupant is applying pressure to 260 Item 3 Car Seat Back Rest of vehicle with his back (or lumbar) as one normally sits and leans back as to apply pressure to the car seat back rest of the 260 Item 3 Car Seat Back Rest of Q1 Occupant Vehicle (identified as 1 in drawing description) and as to be in a seated position.

120 Sensor C Height means and 140 Sensor E Heart Rate means incorporated into 260 Item 3 Car Seat Back Rest of Region O Rear Driver Position of the Q1 Occupant Vehicle (identified as 1 in drawing description) is now detecting pressure of height and heart beat detection from the seated occupant's back as the back of the occupant comes into contact with the 260 Item 3 Car Seat Back Rest, Region O Rear Driver Position of the Q1 Occupant Vehicle.

260 Item 3 Car Seat Back Rest of vehicle as located in Region O Rear Driver position of Q1 Occupant Vehicle (identified as 1 in drawing description) contains 120 Sensor C Height Detection means and 140 Sensor E Heart Rate means sensor detection mat.

Described is the first of two actions occurring with in the 260 Item 3 Car Seat Back Rest, Region O Rear Driver Position of Q1 Occupant Vehicle as seated occupant is appling pressure to the incorporated Sensor C Height Detection means and 140 Sensor E Heart Rate means sensor detection mat.

120 Sensor C Height Detection mat receives action of impact from the occupants back. As the occupant leans back against the 260 Item 3 Car Seat Back Rest of vehicle chair or couch the seated occupant's spine also known as the vertebrae of the back applies pressure to the 260 Item 3 Car Seat Back Rest.

Occupant's spine as it applies pressure to the 260 Item 3 Car Seat Back Rest area only impacts the 120 Sensor C Height Detection sensors that has received an impacted action of pressure applied by the occupant's back. 120 Sensor C Height Detection mat receives applied pressure only where pressure is applied. 120 Sensor C Height Detection sensors that are not being impacted with an action will sleep as will not report actions of impact.

As occupant's spine or vertebrae curves, as being the natural curve of the human back, only the back and spine area that applied a pressure of impact as to apply pressure to the 120 Sensor C Height Detection sensor mat located within the 260 Item 3 Car Seat Back Rest area will report an action of impact received to 250 Item 7 Central Storage and Processing Unit.

120 Sensor C Height Detection mat is sectioned off in one inch sections in a horizontal pattern with in the incorporated 260 Item 3 Car Seat Back Rest area. Each section of the 120 Sensor C Height Detection mat is calculated (as meaning each section is divided) into approximate height ranges. As pressure is applied to one or more of the height range sections, the last height range section area to have a continual source of pressure applied to it will be the indication of the approximate height of the occupant leaning with his back against the 260 Item 3 Car Seat Back Rest sensor panel receiving the impact of action.

120 Sensor C Height Detection mat incorporated into the 260 Item 3 Car Seat Back Rest of vehicle is sectioned off into five section panels. Each panel section is approximately one inch in height and covers the entire width of the 260 Item 3 Car Seat Back Rest area. This 260 Item 3 Car Seat Back Rest area section panels are incorporated with 120 Sensor C Height detection sensor mat that covers the entire 260 Item 3 Car Seat Back Rest area are as well located in Region's F Front Drivers Position, Region X Front Passenger's Position, Region O Rear Drivers Position and Region G Rear Passenger's Position. This path of action covers activity with in the Region O Rear Drivers Position of Vehicle.

Each of the 120 Sensor C Height Detection sensor mat located with in Region's F Front Drivers Position, Region X Front Passenger's Position, Region O Rear Drivers Position and Region G Rear Passenger's Position are sectioned off into five horizontal section panels. Each 120 Sensor C Height detection panels have a lower, middle and upper height detection range assigned to each sensor mat section panel.

The lower 120 Sensor C Height Detection panel, located with in 260 Item 3 Car Seat Back Rest represents, panel one with a height detection reading of 2.0 feet, the middle portion of section panel one of the 120 Sensor C Height Detection mat offers a height detection reading of 2.5 feet and the top portion of the 120 Sensor C Height Detection mat section one panel offers a height detection reading representing 2.99 feet, indicating that the lower lumbar of the occupant's back is applying continual pressure to the entire panel one section.

Panel two located just above panel one, representing the lowest section of panel two offers a 120 Sensor C Height Detection reading of 3.0 feet, the middle portion of the panel two 120 Sensor C Height Detection sensor offers a reading of 3.5 feet and the top portion of panel two offers a 120 Sensor C Height detection reading representing 3.99 feet.

Panel three located just above panel two, representing the lowest section of panel three offers a 120 Sensor C Height detection reading of 4.0 feet, the middle portion of the panel three 120 Sensor C Height Detection sensor offers a reading of 4.5 feet and the top portion of panel three offers a 120 Sensor C Height Detection reading representing 4.99 feet.

Panel four located just above panel three, representing the lowest section of panel four offers a 120 Sensor C Height detection reading of 5.0 feet, the middle portion of the panel four 120 Sensor C Height Detection sensor offers a reading of 5.5 feet and the top portion of panel four offers a 120 Sensor C Height Detection reading representing 5.99 feet.

Panel five located just above panel four, representing the lowest section of panel five offers a 120 Sensor C Height Detection reading of 6.0 feet, the middle portion of the panel five 120 Sensor C Height Detection sensor offers a reading of 6.5 feet and the top portion of panel five offers a 120 Sensor C Height Detection reading representing 7.00 feet.

As the occupant leans back with his back applying pressure to the different sections of the 120 Sensor C Height Detection mat that is sectioned off by height detection panels, of Region O Rear Drivers Position of vehicle, each 120 Sensor C Height Detection panels that is impacted with an applied action of impact pressure will awake and detect an action of applied pressure. The 120 Sensor C Height Detection panel sections that are not impacted with an applied pressure will not respond or report an action of activity. 120 Sensor C Height Detection sensor mat covers the entire 260 Item 3 Car Seat Back Rest in the positions of Region's F Front Drivers Position, Region X Front Passenger's Position, Region O Rear Drivers Position and Region G Rear Passenger's Position. This path of action covers activity occurring with in the Region O Rear Drivers Position of vehicle.

Manufactures in their given field as to applying sensor mats with in the given sensor housing outlined as Items requiring sensor mats with in the SenCora Print System embodied vehicle may adjust the sensor height detection range per panel in such a manor as to have height readings read seated occupant's that are taller than 7 feet in height. This recommendation should be however incorporated by industry standards; as well as each height range panel should be adjusted to accommodate the make and interior seating size of the vehicle. The seat size and height for any manufacture vehicle needs to be taken into account when implementing the SenCora Print System into any standard vehicle. Manufacture in their given field of profession can apply seat sensor mat height detection panels that would include the scope of the population on a standard bases.

As occupant leans with his back against 260 Item 3 Car Seat Back Rest the lower lumbar of the of the back touches the 120 Sensor C Height mat that is closest to 240 Item 2 Car Seat or Couch of the vehicle representing panel number one.

Height range for panel number one starts at 2.0 feet while the highest point of panel number one represents a height range of 2.99 feet. Seated occupant impacts 120 Sensor C Height Detection mat of panel one, range two thus impacting only half of panel one, range two with his lower lumbar back area In other words only less than half of the lower lumbar of the occupant comes into contact with panel one, while range two receives a continued lower lumbar contact reading a range of 2.5 feet.

Occupant's lumbar or (back) makes contacts with panel number three panel ranges located just above panel two, representing the lowest section of panel three impacting 120 Sensor C Height Detection reading range of 4.0 feet, the middle portion of the panel three 120 Sensor C Height Detection sensor offers a reading range of 4.5 feet and the top portion of panel three offers a 120 Sensor C Height detection reading range representing 4.99 feet.

120 Sensor C Height Detection mat panel number four however receives an impact of pressure applied by the seated occupants back.

120 Sensor C Height Detection mat panel five has a contact made to it by seated occupants back and shoulder blade section of occupant's body. This action of impact of pressure applied by the back of the seated occupant's shoulder blades does stop at the lowest point of section five height panel detection range one representing a 6.0 feet height range of the seated occupant of the vehicle.

The prior paragraph outlines area of impact implemented by seated occupant occurring within Region O Rear Drivers Position to 120 Sensor C Height Detection mat incorporated into 260 Item 3 Car Seat Back Rest located above 240 Item 2 Car Seat or Couch.

Action of impact caused by continual contact to lowest portion to the fifth 120 Sensor C Height Detection mat section range one calculates to a height range detection of 6.0 feet as the presumed height of the seated occupant, located in Region O Rear Drivers position of the Q1 Occupant Vehicle.

120 Sensor C Height Detection transmits applied action of impact as 120 Sensor C Height, located in Region O Rear Drivers position, Applied to 260 Item 3 Car Seat Back Rest, panel one, panel two panel four and panel five impacted, approximated height presumed as 6.0 feet tall and transmitted to the 170 Micro Controller Node Z Height.

The following sensor detection being 140 Sensor E Heart Rate Detection is occurring simultaneously to the 120 Sensor C Height Detection within the 260 Item 3 Car Seat Back Rest of the Q1 Occupant Vehicle.

260 Item 3 Car Seat Back Rest of vehicle are located in Region O Rear Driver position of Q1 Occupant Vehicle incorporated with 140 Sensor E Heart Rate means sensor detection mat.

140 Sensor E Heart Rate means is housed with in the same sensor detection mat as 120 Sensor C Height Detection mat but do not cross sensor detection paths. 140 Sensor E Heart Rate means is recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. Each sensor sharing the same sensor detection mat will not cross sensor detection paths and will not cross contaminate sensor detections received upon actions of impacts and will not interfere with height panel detections to the 260 Item 3 Car Seat Back Rest area detections of impacts.

140 Sensor E Heart Rate Detection means and 120 Sensor C Height Detection means regional sensor mat areas do share additional sensor detection mats as being in Region P Trunk of Q1 Occupant Vehicle (identified as 1 in drawing description).

140 Sensor E Heart Rate Detection means and 120 Sensor C Height Detection means do share the same sensor detection mats but do not share the same sensor mat tracing paths.

Occupant is leaning with his or back against 260 Item 3 Car Seat Back Rest of vehicle as to apply pressure to the 260 Item 3 Car Seat Back Rest with his back.

Occupant is applying pressure to 260 Item 3 Car Seat Back Rest of vehicle with his back (or lumbar) as one normally sits and leans back as to apply pressure to the car seat back rest of the 260 Item 3 Car Seat Back Rest of Q1 Occupant Vehicle and as to be in a seated position.

140 Sensor E Heart Rate means incorporated into 260 Item 3 Car Seat Back Rest of Region O Rear Driver Position of the Q1 Occupant Vehicle (identified as 1 in drawing description) is now detecting pressure of vibration of heart beat from the seated occupant's back as the back comes into contact with the 260 Item 3 Care Seat Back Rest, Region O Rear Driver Position of the Q1 Occupant Vehicle (identified as 1 in drawing description).

140 Sensor E Heart Rate means mat receives action of impact from the occupants back. As the occupant leans back against the 260 Item 3 Car Seat Back Rest of vehicle chair or couch the occupants back applies pressure to the 260 Item 3 Car Seat Back Rest area of the 260 Item 3 Car Seat Back Rest of Q1 Occupant Vehicle.

Occupant's back as it applies pressure to the 260 Item 3 Car Seat Back Rest area only impacts the 140 Sensor E Heart Rate Detection means sensors that received an impacted action of pressure applied by the occupant's back. 140 Sensor E Heart Rate Detection means Detection mat receives detection of heart beat through the occupant's back in the form of a vibration and or detection of heart beats as when the occupant's heart beats from with in his body.

Vibration detected heart beats are detected by the 140 Sensor E Heart Rate Detection sensor incorporated into or onto the 140 Sensor E Heart Rate Detection mat where the occupant's back came into contact with the 260 Item 3 Car Seat Back Rest.

140 Sensor E Heart Rate Detection means sensors that are not being impacted with an action will sleep as will not report actions of impact if there is no prossure applied to the 260 Item 3 Car Seat Back Rest unimpacted panel.

The next action described is an action that is simultaneous to the previously described action.

120 Sensor C Height means and 140 Sensor E Heart Rate means sensor detection mats share the same sensor mat but each sensor will have its own sensor tracing path as not to touch or cross over each others sensor trace path. 120 Sensor C Height means and 140 Sensor E Heart Rate means are designed to detect their own sensor detections of impacts.

120 Sensor C Height means and 140 Sensor E Heart Rate means incorporated into 260 Item 3 Car Seat Back Rest in Region O, Rear Driver Position of Q1 Occupant Vehicle is now detecting simultaneously pressure of height recived to the impacted 120 Sensor C Height means by way of detection of vibrations of heart beat and by way of 140 Sensor E Heart Rate means to the 260 Item 3 Car Seat Back Rest, caused by the occupant's back or lumbar section as occupant applying pressure leaning with his back against the 260 Item 3 Car Seat Back Rest incorporated by both senor types.

120 Sensor C Height means and 140 Sensor E Heart Rate means both detects the height and heart rate of occupant as an action of impact and transmits actions by wireless radio transmission to MZ location, 170 Micro Control Node Z Height Detection means and MZ location, 190 Micro Control Node Z Heart Rate Detection means.

MZ location, 170 Micro Control Node Z [symbol] means and MZ location, 190 Micro Control Node [symbol] Detection means transmits detected 120 Sensor C [symbol] 140 Sensor E Heart Rate means detections of action [symbol] coming from Region O, Rear Driver Position of Q1 [symbol] to 250 Item 7 Central Storage and Processing Unit. [symbol] Micro Control Node Z Height Detection means and [symbol] Micro Control Node Z Heart Rate Detection means is [symbol] way of wireless transmission such as by radio. MZ location, [symbol] Control Node Z Height Detection means and MZ location, 190 Micro Control Node Z Heart Rate Detection means is on a pitch (frequency) that can not be identified by any other Micro Controller Node Z means within the Q1 Occupant Vehicle (identified as 1 in drawing description). MZ location, Micro Controller Nodes and their locations are depicted in FIG. 4.

Mz location, 170 Micro Control Node Z Height Detection means and MZ location, 190 Micro Control Node Z Heart Rate Detection means then further transmits the received action of impact to 250 Item 7 Central Storage and Processing Unit for date, time, and impact of region where action of impact occurred for comparable data filing and storage of information.

250 Item 7 Central Storage and Processing Unit retains and transmits all actions of 120 Sensor C Height means and 140 Sensor E Heart Rate means from Region O, Rear Driver Position of Q1 Occupant Vehicle (identified as 1 in drawing description) to observing Q2 Policing Units and or 320 S1 Governing Authority stations who request on board viewing of real time or stored actions of occurrences recorded by the 250 Item 7 Central Storage and Processing Unit located with in the Q1 Occupant Vehicle's SenCora Print System.

However, after the first twenty seconds of received action of impact, 120 Sensor C Height means and 140 Sensor E Heart Rate means housed with in a sensor detection mat has detected pressure or indicated actions of impacts. 120 Sensor C Height means and 140 Sensor E Heart Rate means sensors would no longer draw power from its self but would then power down causing a preprogrammed command for a continual power supply from the 220 Engine Battery to take over as a continual source of power to sensor means housed with in the sensor detection mat incorporated with in the 260 Item 3 Car Seat Back Rest of Region O, Rear Driver Position of Q1 Occupant Vehicle that is receiving an impact of action.

The demand or alternative source of continual robust power will come from the direction of the 250 Item 7 Central Storage and Processing Unit. 250 Item 7 Central Storage and Processing Unit will receive transmission from MZ location, 170 Micro Control Node Z Height Detection means and MZ location, 190 Micro Control Node Z Heart Rate Detection means of Region O, Rear Driver Position of Q1 Occupant Vehicle where initial area of impact occurred.

250 Item 7 Central Storage and Processing Unit then receives this transmitted action of impact from MZ location, 170 Micro Control Node Z Height Detection means and MZ location, 190 Micro Control Node Z Heart Rate Detection means Region O, Rear Driver Position and sends out a wireless transmittal to 350 Micro Controller Node Z Engine Battery to awake PCB location, also known as 210 Power Control Box means.

350 Micro Controller Node Z Engine Battery relays to PCB location, also known as 210 Power Control Box means to awake and open power valve to 120 Sensor C Height means and 140 Sensor E Heart Rate means located in Region O, Rear Driver Position of Q1 Occupant Vehicle.

PCB location, also known as 210 Power Control Box means responds by wireless demand, wakens to the response of 350 Micro Controller Node Z Engine Battery, thus opening the power valve to Sensor C Height Detection means and 140 Sensor E Heart Rate Detection means sensor mat of Region O, Rear Driver Position of Q1 Occupant Vehicle.

PCB location, also known as 210 Power Control Box means is hard wired or as to be connected by identifiable means known as the 200 Electrical Highway Wire means to the 210 Power Control Box. As depicted in FIG. 1 and FIG. 9.

Upon the PCB location, also known as 210 Power Control Box means receiving the demand to open power to 120 Sensor C Height means and 140 Sensor E Heart Rate means hardwired line, power is released from the 220 Engine Battery through the 210 Power Control Box power line.

Within the PCB location, also known as 210 Power Control Box means multiple sensor power lines representing each type of detection sensor is contained with in the 210 Power Control Box release line.

Power is released from the 220 Engine Battery through the PCB location, also known as 210 Power Control Box means release line and is directed to flow through to the 120 Sensor C Height Detection means and 140 Sensor E Heart Rate Detection means detection line by demand of the PCB location, also known as 210 Power Control Box means.

200 Electrical Highway Wire means carries the hard wired commanded and transferred power flow to the PCB location, also known as 210 Power Control Box means to 120 Sensor C Height Detection means and 140 Sensor E Heart Rate Detection means line with in the 210 Power Control Box. Each type of sensor power line through out the scope of the current invention is contained with in the PCB location, also known as 210 Power Control Box means.

200 Electrical Highway Wire means supplies power to the 120 Sensor C Height Detection means and 140 Sensor E Heart Rate Detection means detection mat where impacts of actions such as a pressure of application and heart rate detections has occurred.

200 Electrical Highway Wire means is incased with in a durable plastic casing and has multiple sensor lines housed with in the same durable plastic casing. Once sensor power lines exits the PCB location, also known as 210 Power Control Box means and has been traced to the 260 Item 3 Car Seat Back Rest detection mat of Region O, Rear Driver Position of Q1 Occupant Vehicle (identified as 1 in drawing description), the 210 Power Control line is thinned out and is incorporated into the 260 Item 3 Car Seat Back Rest comprising of the 120 Sensor C Height Detection means and 140 Sensor E Heart Rate means detection mat.

This insulated tracing 200 Electrical Highway Wire means line as pertains to all interior sensors that requires a more robust power supply will be provided the method of insulation as being housed with in durable plastic casing accommodation in order to deliver this more robust power supply when an action of impact beyond twenty seconds of initial impact is required.

120 Sensor C Height Detection means and 140 Sensor E Heart Rate Detection means detection mat detection line runs from the PCB location, also known as 210 Power Control Box means to the 120 Sensor C Height Detection means and 140 Sensor E Heart Rate Detection means detection mat region of impact being Region O, Rear Driver Position following the exampled path currency as being located with in the of Q1 Occupant Vehicle (identified as 1 in drawing description).

200 Electrical Highway Wire means line as pertains to all interior sensors that requires a more robust power supply is depicted in FIG. 9.

120 Sensor C Height means and 140 Sensor E Heart Rate means hard wired power line runs from the 210 Power Box that is located with in the dashboard of the Q1 Occupant Vehicle (identified as 1 in drawing description). 120 Sensor C Height means and 140 Sensor E Heart Rate means power line, follows a path that leads to the 120 Sensor C Height means and 140 Sensor E Heart Rate means detection mat.

120 Sensor C Height means and 140 Sensor E Heart Rate means detection line, thins out as to be incorporated into the 120 Sensor C Height means and 140 Sensor E Heart Rate means detection mat.

120 Sensor C Height means and 140 Sensor E Heart Rate means hard wire line delivers the needed more robust power supply to the 120 Sensor C Height means and 140 Sensor E Heart Rate means detection mat.

120 Sensor C Height means and 140 Sensor E Heart Rate means mat incorporated in the 260 Item 3 Car Seat Back Rest Region O, Rear Driver Position of Q1 Occupant Vehicle (identified as 1 in drawing description) detects the continual impact of action as long as an action of impact is being applied to the 260 Item 3 Car Seat Back Rest Region of Q1 Occupant Vehicle (identified as 1 in drawing description).

120 Sensor C Height means and 140 Sensor E Heart Rate means mat detects and transmits actions of impacts by wireless means such as radio transmission means to MZ location, 170 Micro Control Node Z Height Detection means and MZ location, 190 Micro Control Node Z Heart Rate Detection means detection.

MZ location, 170 Micro Control Node Z Height Detection means and MZ location, 190 Micro Control Node Z Heart Rate Detection means then transmits detected 120 Sensor C Height means and 140 Sensor E Heart Rate means detection actions of impacts deriving from of Region O, Rear Driver Position of Q1 Occupant Vehicle (identified as 1 in drawing description) to 250 Item 7 Central Storage and Processing Unit. MZ location, 170 Micro Control Node Z Height Detection means and MZ location, 190 Micro Control Node Z Heart Rate Detection means transmitted by way of wireless transmission means such as radio transmission is on a pitch (frequency) that can not be identified by any other Micro Controller Node Z with in the Q1 Occupant Vehicle (identified as 1 in drawing description).

MZ location, 170 Micro Control Node Z Height Detection means and MZ location, 190 Micro Control Node Z Heart Rate Detection means detection then further transmits the received actions of impacts to 250 Item 7 Central Storage and Processing Unit for date, time, and impacted region where action of impact occurred and comparable data is filed away for future viewing.

250 Item 7 Central Storage and Processing Unit retains and or transmits all actions of 120 Sensor C Height means and 140 Sensor E Heart Rate means mat detection actions of impacts from Region O, Rear Driver Position of Q1 Occupant Vehicle (identified as 1 in drawing description) to Q2 Policing Units and or 320 S1 Governing Authorities who may request such information in either real time or delayed time for future viewing.

250 Item 7 Central Storage and Processing Unit sends out a wireless demand for confirmation that 120 Sensor C Height means and 140 Sensor E Heart Rate means mat is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that 120 Sensor C Height means and 140 Sensor E Heart Rate means detection mat is receiving power from the 220 Engine Battery.

350 Micro Controller Node Z Engine Battery further transmits the wireless demand to confirm that power valve was opened to 120 Sensor C Height means and 140 Sensor E Heart Rate means detection to PCB location, also known as 210 Power Control Box means.

PCB location, also known as 210 Power Control Box means receives wireless transmittal demand from 350 Micro Controller Node Z Engine Battery. PCB location, also known as 210 Power Control Box means sends back a wireless response to 350 Micro Control Node Z Engine Battery confirming that 120 Sensor C Height means and 140 Sensor E Heart Rate means detection valve is open and receiving power fed to the Region O, Rear Driver Position of Q1 Occupant Vehicle, 120 Sensor C Height means and 140 Sensor E Heart Rate means detection mat of Region O, Rear Driver Position of Q1 Occupant Vehicle receiving actions of impacts.

350 Micro Controller Node Z Engine Battery receives transmission from PCB location, also known as 210 Power Control Box means confirmation and further transmits the confirmation that 120 Sensor C Height means and 140 Sensor E Heart Rate means detection valve is open and receiving power fed to the Region O, Rear Driver Position of Q1 Occupant Vehicle (identified as 1 in drawing description) to 250 Item 7 Central Storage and Processing Unit.

250 Item 7 Central Storage and Processing Unit then records the exact time, date region of activity of each twenty seconds of impact received to region of activity.

When region (such as Region O, Rear Driver Position) is no longer impacted by actions of activity as to no indication of height or heart beat detections is detected from the 120 Sensor C Height means and 140 Sensor E Heart Rate means detection mat incorporated into the 260 Item 3 Car Seat Back Rest of the Q1 Occupant Vehicle (identified as 1 in drawing description); MZ location, 170 Micro Control Node Z Height Detection means and MZ location, 190 Micro Control Node Z Heart Rate Detection means detection no longer sends actions of impacts received transmittals to 250 Item 7 Central Storage and Processing Unit.

250 Item 7 Central Storage and Processing Unit sends a wireless demand to 350 Micro Controller Node Z Engine Battery to close and confirm that 220 Engine Battery power to 120 Sensor C Height means and 140 Sensor E Heart Rate means detection mat is stopped.

350 Micro Controller Node Z Engine Battery wirelessly transmits this demand that power to 120 Sensor C Height means and 140 Sensor E Heart Rate means detection mat has stopped to the 210 Power Control Box of Q1 Occupant Vehicle (identified as 1 in drawing description).

210 Power Control Box, receives the demand to close 120 Sensor C Height means and 140 Sensor E Heart Rate means detection valve and to confirm that power has been closed.

210 Power Control Box closes the power from the receiving line of the 120 Sensor C Height means and 140 Sensor E Heart Rate means detection mat thus meaning that power valve to 120 Sensor C Height means and 140 Sensor E Heart Rate means detection mat is closed and is not delivering power any longer.

Power therefore is no longer flowing to the 120 Sensor C Height means and 140 Sensor E Heart Rate means mat and 210 Power Control Box relays a wireless transmission to 350 Micro Controller Node Z Engine Battery that valve is closed and power has ended.

350 Micro Controller Node Z Engine Battery by wireless transmission sends the confirmation that valve is closed to 120 Sensor C Height means and 140 Sensor E Heart Rate Detection means mat of Region O, Rear Driver Position of Q1 Occupant Vehicle (identified as 1 in drawing description).

250 Item 7 Central Storage and Processing Unit documents the confirmation by date, time, and region of occurrences and compares date to past actions of impacts as priorly recorded by the 250 Item 7 Central Storage and Processing Unit.

This concludes the process of action of impact as pertains to 120 Sensor C Height means and 140 Sensor E Heart Rate detection means and its intended use with in the SenCora Print System.

The description as described within the scope of the present invention is offered as an example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method with out departing form the integrity of current invention.

### 5^{th} Contact Sensor B is Comprised of (What is Made of) 280 Item 4 Floor Boards

With in the scope of the present invention the next sensor means to receive a point of impact is the SB location, also known as SB Location, Identified as 110 Sensors B Weight Detection means as to be incorporated into 280 Item 4 Floor Boards of Q1 Occupant Vehicle is depicted in FIG. 1 and FIG. 5.

SB location, also known as SB Location, 110 Sensor B Weight Detection means as depicted in FIG. 1 as to be incorporated into or onto 280 Item 4 Floor Boards, is also depicted as being located in Region's F, Front Drivers Position, Region X Front Passenger's Position, Region O Rear Drivers Position and Region G Rear Passenger's Position internally of the Q1 Occupant Vehicle (identified as 1 in drawing description).

SB location, also known as 110 Sensors B Weight Detection means, is applied to 280 Item 4 Floor Boards Region F Front Drivers Position, Region X Front Passenger's Position, Region O Rear Drivers Position and Region G Rear Passenger's Position are internally located with in Q1 Occupant Vehicle (identified as 1 in drawing description).

SB Location, 110 Sensor B Weight Detection means as being applied to 280 Item 4 Floor Boards, of the Q1 Occupant Vehicle (identified as 1 in drawing description) in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors' usability factor. This sensor technology as applied to 280 Item 4 Floor Boards of Q1 Occupant Vehicle (identified as 1 in drawing description) is recommended to be sandwiched between two thin flexible polyester sheets which have electronically conductive electrodes deposited in various patterns. Inside surface of one sheet forms a row pattern, while the inner surface forms employees a column pattern. The spacing between the rows and columns varies according to sensor application and can be as small as 0.5 mm.

The recommended environments for each sensor incorporated with in the scope of this invention is as follows or applied to each sensor according to manufacture recommendations. All components incorporated on to 110 Sensor B Weight Detection means of the Q1 Occupant Vehicle (identified as 1 in drawing description) system being identified as the SenCora Print System are low cost, highly effective, market available sensors and computer components.

It is recommended that sensors more particularly 110 Sensor B Weight Detection means are to be located on the interior side of the vehicle be made to endure and conform to temperatures of −40 degrees Celsius to +85 degrees Celsius. With a vibration stress lever being or reduced levels, able to with stand water spray, with a thermal shock factor of reduced rate of change as well as other protective factors that would enhance the life of each component under normal to extreme vehicle circumstances.

It is further recommended that sensors located with in the exterior of the vehicle is made to endure and conform to the recommendations temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the present invention once the entering occupant's body is seated properly as in the seated position of the Region G, Rear Passenger Position and comes into contact with the 280 Item 4 Floor Boards located with in the Q1 Occupant Vehicle (identified as 1 in drawing description) with in the impacted region, a wireless communication of the impacted action of impact caused by the seated occupant is then transmitted to the next means described as MZ location, also known as 160 Micro Controller Node Z Weight means. How is Sensor B Weight Detection means attached to the 280 Item 4 Floor Boards

FIG. 1 depicts SB location, also known as 110 Sensors B Weight Detection means, as to be applied to 280 Item 4 Floor Boards internally of Q1 Occupant Vehicle (identified as 1 in drawing description) to be in one manor the best described method for applying the present invention.

In perspective to SB location, also known as 110 Sensors B Weight Detection means, applied to 280 Item 4 Floor Boards (internally located within Q1 Occupant Vehicle) is recommended to be housed with in a thin, durable, flexible, plastic sensor mat that is or incorporated onto 280 Item 4 Floor Boards being applied just beneath the first layer of the 280 Item 4 Floor Boards or applied to the exterior surface of the 280 Item 4 Floor Boards internally of Q1 Occupant Vehicle (identified as 1 in drawing description) of Regions F Front Drivers Position, Region X Front Passenger's Position, Region O Rear Drivers Position and Region G Rear Passenger's Position internally located with in Q1 Occupant Vehicle and as being incorporated or applied to the 280 Item 4 Floor Boards by graphing, under laid, gluing, bolting or any other means necessary needed by those skilled in the art.

This SB location, Identified as 110 Sensor B Weight Detection means recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. This housing unit for the SB location, Identified as 110 Sensor B Weight Detection means and as being incorporated within 280 Item 4 Floor Boards of Q1 Occupant Vehicle.

### How Sensor B is Used as Applied to 280 Item 4 Floor Boards

110 Sensor B Weight Detection means as applied to 280 Item 4 Floor Boards (internally located within Q1 Occupant Vehicle) receives the occupants weight or pressure applied by the weight of occupant's feet: as occupant being seated on 240 Item 2 Car Seat or Couch, while simultaneously the occupant is applying pressure with his or her back to the 260 Item 3 Car Seat Back Rest of Q1 Occupant Vehicle located in Region G Rear Passenger Position of Q1 Occupant Vehicle (identified as 1 in drawing description).

280 Item 4 Floor Boards of vehicle are located in Regions F Front Drivers Position, Region X Front Passenger's Position, Region O Rear Drivers Position and Region G Rear Passenger's Position internally located with in Q1 Occupant Vehicle (identified as 1 in drawing description) and are incorporated with SB location, Sensor B Weight Detection means with in the 280 Item 4 Floor Boards of vehicle. Each 110 Sensor B Weight Detection means in its given region may share the same sensor mat but each sensor will have its own tracing path as not to touch or cross over a sensor trace path that is designed to detect a different sensor action.

110 Sensor SB location, Sensor B Weight Detection means regional sensor mat areas do not share additional sensor detection sensors.

SA location, 100 Sensor A Fingerprint Detection means, SC location, 120 Sensor C Height Detection means, SD location, 130 Sensor D Breathing Detection means and SE location, 140 Sensor E Heart Rate Detection means do not share the same sensor detection mats with SB location, 110 Sensor B Weight Detection means incorporated with in the 280 Item 4 Floor Boards of the Q1 Occupant Vehicle (identified as 1 in drawing description).

Occupant places his feet on 280 Item 4 Floor Boards of vehicle while in the seated position as applying pressure on 240 Item 2 Car Seat or Couch of Q1 Occupant Vehicle (identified as 1 in drawing description).

Occupant is sitting on 240 Item 2 Car Seat or Couch, while simultaneously the occupant is applying pressure with his or her back to the 260 Item 3 Car Seat Back Rest of Q1 Occupant Vehicle (identified as 1 in drawing description) located in Region G Rear Passenger Position of Q1 Occupant Vehicle.

Occupant is applying pressure to 280 Item 4 Floor Boards of vehicle or Couch of vehicle with his or her feet placed on the 280 Item 4 Floor Boards of vehicle as one normally sit in the seated position.

SB location, 110 Sensor B Weight incorporated into 280 Item 4 Floor Boards of vehicle of the Region G Rear Passenger Position of the vehicle is now detecting pressure of weight from the seated occupant's feet from with in the Q1 Occupant Vehicle.

Sensor SB location, 110 Sensor B Weight detects weight of occupant and transmits the detection of the impact of action by wireless radio transmission to MZ location, 160 Micro Control Node Z Weight Detection means.

160 Micro Control Node Z Weight Detection means is depicted FIG. 4.

MZ location, 160 Micro Control Node Z Weight Detection then transmits detected 280 Item 4 Floor Boards of vehicle weight detected action of impact deriving from Region G being Rear Passengers Position of Q1 Occupant Vehicle (identified as 1 in drawing description) is sent to 250 Item 7 Central Storage and Processing Unit.

250 Item 7 Central Storage and Processing Unit then further transmissions to MZ Location, 160 Micro Control Node Z Weight Detection is transmitted by way of wireless transmission such as radio transmission. MZ location, 160 Micro Control Node Z Weight Detection means is on a pitch (frequency) that can not be identified by any other Micro Controller Node Z means within the Q1 Occupant Vehicle (identified as 1 in drawing description).

MZ location, 160 Micro Control Node Z Weight Detection means then further transmits the received action of impact to 250 Item 7 Central Storage and Processing Unit for date, time and impact of region where action of impact occurred for comparable data filing.

250 Item 7 Central Storage and Processing Unit retains and transmits all actions of 110 Sensor B Weight Detections from Region G Rear Passengers Position of Q1 Occupant Vehicle to observing Q2 Policing Units and or 320 S1 Governing Authority Stations who request on board viewing of real time or stored actions of occurrences recorded by the 250 Item 7 Central Storage and Processing Unit located with in the Q1 Occupant Vehicle's SenCora Print System.

However, after the first twenty seconds of received action of impact, 110 Sensor B Weight Detections means housed with in a sensor detection mat incorporated into 280 Item 4 Floor Boards of the Region G Rear Passenger Position has detected a pressure or indicated action of impact. 110 Sensor B Weight Detections mat would no longer draw power from its self but would then power down causing a preprogrammed command for a continual power supply from the 220 Engine Battery to take over as a continual source of power to all 110 Sensor B Weight Detections means housed with in the sensor detection mat incorporated with in the 280 Item 4 Floor Boards of vehicle of Region G Rear Passengers Position of Q1 Occupant Vehicle (identified as 1 in drawing description).

The demand or alternative source of continual robust power will come from the direction of the 250 Item 7 Central Storage and Processing Unit. 250 Item 7 Central Storage and Processing Unit will receive transmission from 160 MZ location, Micro Control Node Z Weight Detection means of action of impact occuring from Region G Rear Passengers Position of Q1 Occupant Vehicle (identified as 1 in drawing description) where initial area of impact occurred.

250 Item 7 Central Storage and Processing Unit then receives this transmitted action of impact from 160 MZ location, Micro Control Node Z Weight Detection means occuring from the Region G Rear Passengers Position and sends out a wireless transmittal to 350 Micro Controller Node Z Engine Battery to awake PCB location, also known as 210 Power Control Box means.

350 Micro Controller Node Z Engine Battery relays to PCB location, also known as 210 Power Control Box means to awake and open power valve to 110 Sensor B Weight Detection mat located in Region G Rear Passengers Position of Q1 Occupant Vehicle (identified as 1 in drawing description).

PCB location, also known as 210 Power Control Box means responds by wireless demand and wakens to the response of 350 Micro Controller Node Z Engine Battery, thus opening the power valve to 110 Sensor B Weight Detection mat of Region G Rear Passengers Position of Q1 Occupant Vehicle (identified as 1 in drawing description).

PCB location, also known as 210 Power Control Box means is hard wired or as to be connected by identifiable means known as the 200 Electrical Highway Wire means to the PCB location, also known as 210 Power Control Box means as depicted FIG. 1 and FIG. 9.

Upon the PCB location, also known as 210 Power Control Box means receiving the demand to open power to 110 Sensor B Weight Detection hardwired power line also known as the 200 Electrical Highway Wire means of the 280 Item 4 Floor Boards of the Q1 Occupant Vehicle (identified as 1 in drawing description), power is released from the 220 Engine Battery through the PCB location, also known as 210 Power Control Box means.

With in the PCB location, also known as 210 Power Control Box means multiple sensor power lines representing each type of detection sensor is contained with in the PCB location, also known as 210 Power Control Box means release line.

Power is released from the 220 Engine Battery through the PCB location, also known as 210 Power Control Box means release line and is directed to flow through to the 110 Sensor B Weight Detection line of the 280 Item 4 Floor Boards located in Region G Rear Passengers Position of Q1 Occupant Vehicle (identified as 1 in drawing description) by demand of the PCB location, also known as 210 Power Control Box means.

200 Electrical Highway Wire means carries the hard wired commanded and transferred power flow to the PCB location, also known as 210 Power Control Box means to the 110 Sensor B Weight Detection line with in the PCB location, also known as 210 Power Control Box means. Each type of sensor power line through out the scope of the current invention is contained with in the PCB location, also known as 210 Power Control Box means.

200 Electrical Highway Wire means supplies power to the 110 Sensor B Weight Detection mat where impact of action such as a pressure of application and weight detection has occurred.

200 Electrical Highway Wire means is incased with in a durable plastic casing and has multiple sensor lines housed with in the same durable plastic casing. Once sensor power lines exits the PCB location, also known as 210 Power Control Box means and has been traced to the 280 Item 4 Floor Boards of region of impact the 110 Sensor B Weight Detection mat incorporated with in the 280 Item 4 Floor Boards of Region G Rear Passengers Position of the Q1 Occupant Vehicle, connects to the 210 Power Control line and is thinned out as beening incorporated into the 280 Item 4 Floor Boards comprising of the 110 Sensor B Weight Detection mat.

This insulated tracing 200 Electrical Highway Wire means line as pertains to all interior sensors that requires a more robust power supply will be provided the same method of insulation as being housed with in a durable plastic casing accommodation in order to deliver this more robust power supply when an action of impact beyond twenty seconds of initial impact is required.

110 Sensor B Weight Detection line runs from the PCB location, also known as 210 Power Control Box means to the 110 Sensor B Weight Detection mat region of impact being Region G Rear Passengers Position Region following the exampled path currency as being located with in the of Q1 Occupant Vehicle (identified as 1 in drawing description).

110 Sensor B Weight Detection hard wired power line runs from the PCB location, also known as 210 Power Control Box means that is located with in the dashboard of the Q1 Occupant Vehicle. 110 Sensor B Weight Detection line follows a path that leads to 110 Sensor B Weight Detection mat.

110 Sensor B Weight Detection line, thins out as to be incorporated into the 110 Sensor B Weight Detection mat.

110 Sensor B Weight Detection hard wire line delivers the needed more robust power supply to the 110 Sensor B Weight Detection mat of the 280 Item 4 Floor Boards detection mat.

110 Sensor B Weight Detection mat incorporated in the 280 Item 4 Floor Boards of Region G Rear Passengers Position of Q1 Occupant Vehicle (identified as 1 in drawing description) detects the continual impact of action as long as an action of impact is being applied to the 280 Item 4 Floor Boards located with in the Q1 Occupant Vehicle.

110 Sensor B Weight Detects and transmits weight action of impact by wireless means such as radio transmission means to 160 Micro Controller Node Z Weight Detection.

160 Micro Controller Node Z Weight Detection then transmits detected 110 Sensor B Weight Detection actions of impact deriving from Region G Rear Passengers Position of Q1 Occupant Vehicle to 250 Item 7 Central Storage and Processing Unit. 160 Micro Controller Node Z Weight Detection means is transmitted by way of wireless radio transmission and is on a pitch (frequency) that can not be identified by any other Micro Controller Node Z with in the Q1 Occupant Vehicle (identified as 1 in drawing description).

160 Micro Controller Node Z Weight Detection then further transmits the received action of impact to 250 Item 7 Central Storage and Processing Unit for date, time, and impacted region where action of impact occurred and comparable data is filed away for future viewing.

250 Item 7 Central Storage and Processing Unit retains and or transmits all actions of 110 Sensor B Weight Detection actions of impact from Region G Rear Passengers Position of Q1 Occupant Vehicle (identified as 1 in drawing description) to Q2 Policing Units (identified as 1 in drawing description) and or 320 S1 Governing Authorities who may request such information in either real time or delayed time for future viewing.

250 Item 7 Central Storage and Processing Unit sends out a wireless demand for confirmation that 110 Sensor B Weight Detection mat is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that 110 Sensor B Weight Detection mat is receiving power from the 220 Engine Battery.

350 Micro Controller Node Z Engine Battery further transmits the wireless demand to confirm that power valve was opened to 110 Sensor B Weight Detection to 210 Power Control Box.

PCB location, also known as 210 Power Control Box means receives wireless transmittal demand from 350 Micro Controller Node Z Engine Battery. PCB location, also known as 210 Power Control Box means sends back a wireless response to 350 Micro Control Node Z Engine Battery confirming that 110 Sensor B Weight Detection valve is open and receiving power fed to the Region G Rear Passengers Position of Q1 Occupant Vehicle (identified as 1 in drawing description), 110 Sensor B Weight Detection mat of Region G Rear Passengers Position of Q1 Occupant Vehicle (identified as 1 in drawing description)receiving an action of impact.

350 Micro Controller Node Z Engine Battery receives transmission from PCB location, also known as 210 Power Control Box means confirmation and further transmits the confirmation to 250 Item 7 Central Storage and Processing Unit.

250 Item 7 Central Storage and Processing Unit then records the exact time, date region of activity of each twenty seconds of impact received to region of activity.

When region (such as Region G Rear Passenger Position) is no longer impacted by an action of activity as to no indication of weight detection is detected from the 110 Sensor B Weight Detection mat incorporated into the 280 Item 4 Floor Boards of the Q1 Occupant Vehicle; 160 Micro Controller Node Z Weight Detection means no longer sends action of impact received transmittals to 250 Item 7 Central Storage and Processing Unit.

250 Item 7 Central Storage and Processing Unit sends a wireless demand to 350 Micro Controller Node Z Engine Battery to close and confirm that 220 Engine Battery power to 110 Sensor B Weight Detection is stopped.

350 Micro Controller Node Z Engine Battery, wirelessly transmits demand that power has stopped to the PCB location, also known as 210 Power Control Box means of Q1 Occupant Vehicle (identified as 1 in drawing description).

PCB location, also known as 210 Power Control Box means, receives the demand to close 110 Sensor B Weight Detection valve and to confirm that power has been closed.

PCB location, also known as 210 Power Control Box means closes the power from the receiving line of the 110 Sensor B Weight Detection mat thus meaning that power valve to 110 Sensor B Weight Detection mat is closed and is not delivering power any longer.

Power therefore is no longer flowing to the 110 Sensor B Weight Detection mat and PCB location, also known as 210 Power Control Box means relays a wireless transmission to 350 Micro Controller Node Z Engine Battery that valve is closed and power has ended.

350 Micro Controller Node Z Engine Battery by wireless transmission sends the confirmation that valve is closed to 110 Sensor B Weight Detection mat of Region G Rear Passenger Position of Q1 Occupant Vehicle (identified as I in drawing description).

250 Item 7 Central Storage and Processing Unit documents the confirmation by date, time, and region of occurrences and compares date to past actions of impacts as priorly recorded by the 250 Item 7 Central Storage and Processing Unit.

This concludes the process of action of impact as pertains to 110 Sensor B Weight Detection means and its intended use with in the SenCora Print System with the Q1 Occupant Vehicle.

### 6^{th} Contact General Ideal of the Invention

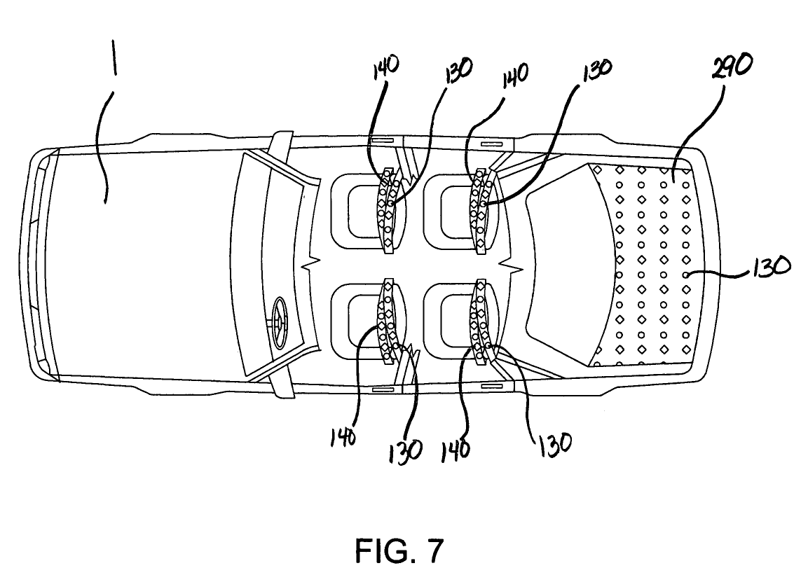

With in the scope of the present invention the next sensor means to receive a point of impact are SD location, also, Identified as 130 Sensor D Breathing Detection means and SE Location, Identified 140 Sensor E Heart Rate Detection means as being incorporated into the 230 Item 1 Seat Belt Harness Strap of Q1 Occupant Vehicle (identified as 1 in drawing description) is depicted in FIG. 1 and FIG. 7.

SD location, also known as SD Location, 130 Sensor D Breathing Detection means and SE Location, Identified 140 Sensor E Heart Rate Detection means depicted in FIG. 7 as being incorporated into 230 Item 1 Seat Belt Harness Strap, is also depicted as being located in Region's F, Front Drivers Position, Region X Front Passenger's Position, Region O Rear Drivers Position and Region G Rear Passenger's Position internally of the Q1 Occupant Vehicle (identified as 1 in drawing description).

SD location, also known as 130 Sensor D Breathing Detection means and SE Location, Identified 140 Sensor E Heart Rate Detection means is applied to 230 Item 1 Seat Belt Harness Strap of Regions F Front Drivers Position, Region X Front Passenger's Position, Region O Rear Drivers Position and Region G Rear Passenger's Position are internally located with in Q1 Occupant Vehicle (identified as 1 in drawing description).

SD location, also known as 130 Sensor D Breathing Detection means and SE Location, Identified 140 Sensor E Heart Rate Detection means, as being applied to 230 Item 1 Seat Belt Harness Strap, of the Q1 Occupant Vehicle in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors' usability factor. This sensor technology as applied to 230 Item 1 Seat Belt Harness Strap of Q1 Occupant Vehicle is recommended to be sandwiched between two thin flexible polyester sheets which have electronically conductive electrodes deposited in various patterns. The in-side surface of one sheet forms a row pattern, while the inner surface forms employees a column pattern. The spacing between the rows and columns varies according to sensor application and can be as small as 0.5 mm.

The recommended environments for each sensor incorporated with in the scope of this invention is as follows or applied to each sensor according to manufacture recommendations. All components incorporated on to 130 Sensor D Breathing Detection means and SE Location, Identified as 140 Sensor E Heart Rate Detection means of the Q1 Occupant Vehicle system being identified as the SenCora Print System are low cost, highly effective, market available sensors and computer components.

It is recommended that sensors more particularly 130 Sensor D Breathing Detection means and 140 Sensor E Heart Rate Detection means are to be located on the interior side of the vehicle be made to endure and conform to temperatures of −40 degrees Celsius to +85 degrees Celsius. With a vibration stress lever being or reduced levels, able to with stand water spray, with a thermal shock factor of reduced rate of change as well as other protective factors that would enhance the life of each component under normal to extreme vehicle circumstances.

It is further recommended that sensors located with in the exterior of the vehicle be made to endure and conform to the recommendations temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the present invention once the entering occupant's body is seated properly as in the seated position of the Region X, Front Passenger Position of vehicle and comes into contact with the 230 Item 1 Seat Belt Harness Strap located with in the Q1 Occupant Vehicle (identified as 1 in drawing description) with in the impacted region, a wireless communication of the impacted action of impact caused by the seated occupant is then transmitted to the next means described as MZ location, also known as 180 Micro Controller Node Z Breathing means.

FIG. 7 depicts SD location, also known as 130 Sensor D Breathing Detection means and SE Location, Identified 140 Sensor E Heart Rate Detection means, as being applied or incorporated onto 230 Item 1 Seat Belt Harness Strap internally located of Q1 Occupant Vehicle to be in one manor the best described method for applying the present invention.

In perspective to SD location, also known as 130 Sensor D Breathing Detection means and SE Location, Identified 140 Sensor E Heart Rate Detection means, applied to 230 Item 1 Seat Belt Harness Strap (internally located within Q1 Occupant Vehicle) is recommended to be housed with in a thin, durable, flexible, plastic sensor mat that is or incorporated onto or into the 230 Item 1 Seat Belt Harness Strap being applied just beneath the first layer of the 230 Item 1 Seat Belt Harness Strap or applied to the exterior surface of the 230 Item 1 Seat Belt Harness Strap internally of Q1 Occupant Vehicle of Regions F Front Drivers Position, Region X Front Passenger's Position, Region O Rear Drivers Position and Region G Rear Passenger's Position internally located with in Q1 Occupant Vehicle and as being incorporated or applied to the 230 Item 1 Seat Belt Harness Strap by graphing, under laid, gluing, bolting or any other means necessary needed by those skilled in the art.

### Sensor D Breathing and Sensor E Heart Rate as Applied to 230 Item 1 Seat Belt Harness Strap Process of Action

SD location, also known as 130 Sensor D Breathing Detection means and SE Location, Identified as 140 Sensor E Heart Rate Detection means as applied to 230 Item 1 Seat Belt Harness Strap (internally located within Q1 Occupant Vehicle) are designed to detect and receive the action of breathing by use of the 130 Sensors D Breathing Detection means designed to detect and receive the action of breathing and 140 Sensor E Heart Rate Detection means designed to detect and receive the action of heart rate. Both sensor detection types are incorporated onto the 230 Item 1 Seat Belt Harness Strap delivering a simultaneous action of detection occurring from the 230 Item 1 Seat Belt Harness Strap from region of impacted occurrence. 230 Item 1 Seat Belt Harness Strap incorporated with SD location, also known as 130 Sensors D Breathing Detection means and SE Location, Identified as 140 Sensor E Heart Rate Detection means are located in the regions of Regions F Front Drivers Position, Region X Front Passenger's Position, Region O Rear Drivers Position and Region G Rear Passenger's Position internally of the Q1 Occupant Vehicle.

130 Sensor D Breathing Detection means and 140 Sensor E Heart Rate Detection means located with in Q1 Occupant Vehicle (identified as 1 in drawing description) are incorporated into 230 Item 1 Seat Belt Harness Strap of vehicle and are located in Regions F Front Drivers Position, Region X Front Passenger's Position, Region O Rear Drivers Position and Region G Rear Passenger's Position, each sensor detection means in its given region may share the same sensor mat but each sensor will have its own tracing path as not to touch or cross over a sensor trace path that is designed to detect a different sensor action.

130 Sensor D Breathing Detection means and 140 Sensor E Heart Rate Detection means located with in Q1 Occupant Vehicle are the only two sensors that share the same sensor mat incorporated into 230 Item 1 Seat Belt Harness Strap.

Occupant is seated on 240 Item 2 Car Seat or Couch of vehicle as in a seated position located in Region X Front Passengers position of Q1 Occupant Vehicle.

Occupant is leaning with his or back against 260 Item 3 Car Seat Back Rest of vehicle as to apply pressure to 260 Item 3 Car Seat Back Rest of Region X Front Passengers position of Q1 Occupant Vehicle.

Occupant's feet are placed as to be applying pressure to 280 Item 4 Floor Board of Region X Front Passengers position of Q1 Occupant Vehicle (identified as 1 in drawing description).

Occupant reaches for 230 Item 1 Seat Belt Harness Strap as to secure it over his or her chest. 230 Item 1 Seat Belt Harness Strap is secure over the occupant's chest as to wear the seat belt securely.

Occupant fastens 230 Item 1 Seat Belt Harness Strap into the second locking mechanism of 230 Item 1 Seat Belt Harness Strap called the buckle, causing the 230 Item 1 Seat Belt Harness Strap to be securely locked into place over the occupant's chest and lap area.

Occupant has secured the 230 Item 1 Seat Belt Harness Strap into the locking mechanism buckle that locks the seat belt harness strap being in whole identified as 230 Item 1 Seat Belt Harness Strap; into its locked position.

Occupant is breathing as one normally breaths, causing an action of chest movement also known as exhaling and inhaling.

Occupant's heart rate is beating at a normal pace as occupant is strapped in securely by the 230 Item 1 Seat Belt Harness Strap. 230 Item 1 Seat Belt Harness Strap, crosses over the chest cavity of the occupant seating in Region X Front Passengers position of the Q1 Occupant Vehicle (identified as 1 in drawing description).

130 Sensor D Breathing Detection means and 140 Sensor E Heart Rate Detection means incorporated Item 1 Seat Belt Harness Strap of Region X Front Passenger Position of Q1 Occupant Vehicle (identified as 1 in drawing description) is now detecting vibrations of heart rate by indications of heart beat detections picked up by the 140 Sensor E Heart Rate Detection means and detections of breathing detections by the action of the occupant's chest movement due to the normal action of occupant inhaling and exhaling chest movements.

First twenty seconds of initial impact received by 130 Sensor D Breathing Detection means and 140 Sensor E Heart Rate Detection means incorporated into or onto the 230 Item 1 Seat Belt Harness Strap supplies its own power deriving from the 130 Sensor D Breathing Detection means and 140 Sensor E Heart Rate Detection means sensors individually built in battery.

However, after the first twenty seconds of initial received action of impact to 130 Sensor D Breathing Detection means and 140 Sensor E Heart Rate Detection means incorporated into or onto 230 Item 1 Seat Belt Harness Strap seated occupants breathing detection attributes and heart rate detection sensors attributes no longer draws power from its self (meaning the detecting sensors of Sensor E and Sensor D) but powers down causing a preprogrammed command for a continual power supply from the 220 Engine Battery to take over as a continual source of power.

130 Sensor D Breathing Detection means and 140 Sensor E Heart Rate Detection means detects and transmits both breathing and heart rate detection actions of impact to 180 Micro Controller Node Z Breathing and 190 Micro Controller Node Z Heart Rate for transmission and relaying of detected attributes detected from with in the 230 Item 1 Seat Belt Harness Strap. Micro Controller Z Node's 180 and 190 depicted locations to be viewed in FIG. 1 and FIG. 4.

MZ location, 180 Micro Control Node Z Breathing Detection means and MZ location, 190 Micro Controller Node Z Heart Rate means then transmits detected actions of impacts of 130 Sensor D Breathing Detection means and 140 Sensor E Heart Rate Detection means from Region X being Front Passenger's Position of Q1 Occupant Vehicle, to 250 Item 7 Central Storage and Processing Unit also located with in the Q1 Occupant Vehicle. MZ Location, 180 Micro Control Node Z Breathing Detection means and MZ Location, 190 Micro Controller Node Z Heart Rate means are transmitted by way of wireless radio transmission. MZ location, 180 Micro Control Node Z Breathing Detection means and MZ Location, 190 Micro Controller Node Z Heart Rate is on a pitch (frequency) that can not be identified by any other Micro Controller Node Z means within the Q1 Occupant Vehicle (identified as 1 in drawing description).

MZ location, 180 Micro Control Node Z Breathing Detection means and MZ location, 190 Micro Controller Node Z Heart Rate means then further transmits the received actions of impacts to 250 Item 7 Central Storage and Processing Unit for date, time, and impact of region where action of impact occurred for comparable data filing.

250 Item 7 Central Storage and Processing Unit retains and transmits all actions of impacts of sensors 130 Sensor D Breathing Detection means and 140 Sensor E Heart Rate Detection means from Region X Front Passengers Position of Q1 Occupant Vehicle (identified as 1 in drawing description) to observing Q2 Policing Units (identified as 2 in drawing description) and or 320 S1 Governing Authority Stations who request on board viewing of real time or stored actions of occurrences recorded by the 250 Item 7 Central Storage and Processing Unit located with in the Q1 Occupant Vehicle.

However, after the first twenty seconds of received action of impact, 130 Sensor D Breathing Detection means and 140 Sensor E Heart Rate Detection means housed with in 230 Item 1 Seat Belt Harness Strap sensor detection mat which has detected a continual indicated action of impact. 130 Sensor D Breathing Detection means and 140 Sensor E Heart Rate Detection means detections would no longer draw power from its self but would then power down causing a preprogrammed command for a continual power supply from the 220 Engine Battery to take over as a continual source of power to the area of impact being the 130 Sensor D Breathing Detection means and 140 Sensor E Heart Rate Detection means. Sensor D Breathing and Sensor E Heart Rate are housed with in the sensor detection mat incorporated with in the 230 Item 1 Seat Belt Harness Strap of Region X Front Passengers Position of Q1 Occupant Vehicle (identified as 1 in drawing description).

This demand or alternative source of continual robust power will come from the direction of the 250 Item 7 Central Storage and Processing Unit. 250 Item 7 Central Storage and Processing Unit will receive transmission from MZ location, 180 Micro Control Node Z Breathing Detection means and MZ location, 190 Micro Controller Node Z Heart Rate means of Region X Front Passengers Position of Q1 Occupant Vehicle (identified as 1 in drawing description) where initial area of impact of simultaneous actions of both sensor E and sensor D impacts have occurred.

250 Item 7 Central Storage and Processing Unit then receives these transmitted actions of impacts from MZ location, 180 Micro Control Node Z Breathing Detection means and MZ location, 190 Micro Controller Node Z Heart Rate means from Region X Front Passengers Position and sends out a wireless transmittal to 350 Micro Controller Node Z Engine Battery to awake the 210 Power Control Box.

350 Micro Controller Node Z Engine Battery relays to PCB location, also known as 210 Power Control Box means to awake and open power valve to 130 Sensor D Breathing Detection means and 140 Sensor E Heart Rate Detection means housed with in sensor detection mat located in Region X Front Passengers Position of Q1 Occupant Vehicle (identified as 1 in drawing description).

PCB location, also known as 210 Power Control Box means responds by wireless demand and wakens to the response of 350 Micro Controller Node Z Engine Battery, thus opening the power valve to 130 Sensor D Breathing Detection means and 140 Sensor E Heart Rate Detection means housed with in sensor detection mat of Region X Front Passengers Position of Q1 Occupant Vehicle.

PCB location, also known as 210 Power Control Box means is hard wired or as to be connected by identifiable means known as the 200 Electrical Highway Wire means (200 Electrical Highway Wire means is a hard wire electrical highway means that is laid out with in the Q1 Occupant Vehicle(identified as 1 in drawing description), designed to carry a continual source of power to all internally placed sensor mats with in the vehicle that require power beyond the initial twenty seconds of activity of impact) to PCB location, also known as 210 Power Control Box means.

Upon the PCB location, also known as 210 Power Control Box means receiving the demand to open power to 130 Sensor D Breathing Detection means and 140 Sensor E Heart Rate Detection means hard wired line, power is released from the 220 Engine Battery through the PCB location, also known as 210 Power Control Box means.

Within the PCB location, also known as 210 Power Control Box means multiple sensor power lines representing each type of detection sensor is contained with in the PCB location, also known as 210 Power Control Box means release line.

Power is released from the 220 Engine Battery to the PCB location, also known as 210 Power Control Box means release line and is directed to flow to the 130 Sensor D Breathing Detection means and 140 Sensor E Heart Rate Detection means mat by use of the (where the demand for a continual more robust power supply is needed) by demand of the PCB location, also known as 210 Power Control Box means.

200 Electrical Highway Wire means carries the hard wired commanded and transferred power flow to the PCB location, also known as 210 Power Control Box means then to the 130 Sensor D Breathing Detection means and 140 Sensor E Heart Rate Detection means electrical hard wire power lines with in the PCB location, also known as 210 Power Control Box means. The 200 Electrical Highway Wire means power line are located and exists the PCB location, also known as 210 Power Control Box means, for the purpose of carrying a more robust power supply to the sensor detections mats of each sensor demanding continual power. Each type of sensor hard wire power line through out the scope of the current invention is contained with in the PCB location, also known as 210 Power Control Box means.

200 Electrical Highway Wire means supplies power to the 130 Sensor D Breathing Detection means and 140 Sensor E Heart Rate Detection means mat where impacts of actions and detections has occurred.

200 Electrical Highway Wire means is incased with in a durable plastic casing and has multiple sensor lines housed with in the same durable plastic casing. Once sensor power lines exits the PCB location, also known as 210 Power Control Box means and has been traced to the 230 Item 1 Seat Belt Harness Strap region of impacts the 130 Sensor D Breathing Detection means and 140 Sensor E Heart Rate Detection means mat incorporated with in the 230 Item 1 Seat Belt Harness Strap of Region X Front Passenger Position of the Q1 Occupant Vehicle, the 210 Power Control Box line is thinned out and is incorporated into the 230 Item 1 Seat Belt Harness Strap comprising of both the 130 Sensor D Breathing Detection means and 140 Sensor E Heart Rate Detection means mat.

This insulated tracing line, identified as 200 Electrical Highway Wire means line as pertains to all interior sensors that requires a more robust power supply will be provided the method of insulation as being housed with in durable plastic casing accommodation in order to deliver this more robust power supply when actions of impact beyond twenty seconds of initial impact are required.

130 Sensor D Breathing Detection means and 140 Sensor E Heart Rate Detection means lines runs from the PCB location, also known as 210 Power Control Box means to the 130 Sensor D Breathing Detection means and 140 Sensor E Heart Rate Detection means detection mat region of impact being Region X Front Passenger Position following the exampled path of currency are located with in the of Q1 Occupant Vehicle (identified as 1 in drawing description). FIG. 1 depicts entire view of all componets in conection and relation to one another.

130 Sensor D Breathing Detection means and 140 Sensor E Heart Rate Detection means detection hard wired power line runs from the PCB location, also known as 210 Power Control Box means that is located with in the dashboard of the Q1 Occupant Vehicle. Sensors 130 Sensor D Breathing Detection means and 140 Sensor E Heart Rate Detection means 200 Electrical Highway Wire lines, follows a path that leads to the 130 Sensor D Breathing Detection means and 140 Sensor E Heart Rate Detection means detection mat of Region X Front Passengers Position of the Q1 Occupant Vehicle.

130 Sensor D Breathing Detection means and 140 Sensor E Heart Rate Detection means detection mat 200 Electrical Highway Wire line thins out as to be incorporated into the 130 Sensor D Breathing Detection means and 140 Sensor E Heart Rate Detection means detection mat.

130 Sensor D Breathing Detection means and 140 Sensor E Heart Rate Detection means detection hard wire electrical line delivers the needed more robust power supply to the 130 Sensor D Breathing Detection means and 140 Sensor E Heart Rate Detection means detection mat.

130 Sensor D Breathing Detection means and 140 Sensor E Heart Rate Detection means detection mat incorporated in the 230 Item 1 Seat Belt Harness Strap of Region X Front Passengers Position of Q1 Occupant Vehicle detects the continual impact of action as long as an action of impact is being applied to the 230 Item 1 Seat Belt Harness Strap of Q1 Occupant Vehicle (identified as 1 in drawing description).

130 Sensor D Breathing Detection means and 140 Sensor E Heart Rate Detection means detects and transmits actions of impact by wireless means such as radio transmission means to 180 Micro Control Node Z Breathing Detection means and MZ location, 190 Micro Controller Node Z Heart Rate means.

180 Micro Control Node Z Breathing Detection means and MZ location, 190 Micro Controller Node Z Heart Rate means detection then transmits detected 130 Sensor D Breathing Detection means and 140 Sensor E Heart Rate Detection means detection actions of impacts deriving from of Region X Front Passengers Position of Q1 Occupant Vehicle to 250 Item 7 Central Storage and Processing Unit. 180 Micro Control Node Z Breathing Detection means and MZ location, 190 Micro Controller Node Z Heart Rate means detection means is transmitted by way of wireless transmission means such as radio transmissions means that can not be identified by any other Micro Controller Node Z with in the Q1 Occupant Vehicle.

180 Micro Control Node Z Breathing Detection means and MZ location, 190 Micro Controller Node Z Heart Rate means detection then further transmits the received actions of impacts to 250 Item 7 Central Storage and Processing Unit for date, time, and impacted region where action of impact occurred where comparable data is filed away for future viewing.

250 Item 7 Central Storage and Processing Unit retains and or transmits all actions of 130 Sensor D Breathing Detection means and 140 Sensor E Heart Rate Detection means detected actions of impacts from Region X Front Passengers Position of Q1 Occupant Vehicle (identified as 1 in drawing description) to Q2 Policing Units (identified as 2 in drawing description) and or 320 S1 Governing Authorities who may request such information in either real time or delayed time for future viewing.

250 Item 7 Central Storage and Processing Unit sends out a wireless demand for confirmation that 130 Sensor D Breathing Detection means and 140 Sensor E Heart Rate Detection means mat is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that 130 Sensor D Breathing Detection means and 140 Sensor E Heart Rate Detection means mat is receiving power from the 220 Engine Battery.

350 Micro Controller Node Z Engine Battery further transmits the wireless demand to confirm that power valves was opened to 130 Sensor D Breathing Detection means and 140 Sensor E Heart Rate Detection means mat to 210 Power Control Box.

350 Micro Controller Node Z Engine sends confirmation that power valves was opened to 130 Sensor D Breathing Detection means and 140 Sensor E Heart Rate Detection means mat to the 210 Power Control Box.

PCB location, also known as 210 Power Control Box means receives wireless transmittal demand from 350 Micro Controller Node Z Engine Battery and 210 Power Control Box sends back a wireless response to 350 Micro Control Node Z Engine Battery confirming that power valve was opened to 130 Sensor D Breathing Detection means and 140 Sensor E Heart Rate Detection means valves are open and receiving power fed to the Region X Front Passengers Position of Q1 Occupant Vehicle (identified as 1 in drawing description), 130 Sensor D Breathing Detection means and 140 Sensor E Heart Rate Detection means mat.

350 Micro Controller Node Z Engine Battery receives transmission from PCB location, also known as 210 Power Control Box means has confirmed that power valves are opened to 130 Sensor D Breathing Detection means and 140 Sensor E Heart Rate Detection means mat. 350 Micro Controller Node Z Engine Battery then further transmits the confirmation to 250 Item 7 Central Storage and Processing Unit.

250 Item 7 Central Storage and Processing Unit then records the exact time, date region of activity of each twenty seconds of impact received as well as the continual sensor attribute transmittals occurring from Region X Front Passengers Position deriving from 230 Item 1 Seat Belt Harness Strap.

When Region X Front Passenger Position is no longer impacted by an action of activity as to no indication of breathing or heart rate detections are detected from the 130 Sensor D Breathing Detection means and 140 Sensor E Heart Rate Detection means mat incorporated into the 230 Item 1 Seat Belt Harness Strap of Q1 Occupant Vehicle (identified as 1 in drawing description); 180 Micro Control Node Z Breathing Detection means and MZ location, 190 Micro Controller Node Z Heart Rate means no longer sends actions of impacts received transmittals to 250 Item 7 Central Storage and Processing Unit.

250 Item 7 Central Storage and Processing Unit sends a wireless demand to 350 Micro Controller Node Z Engine Battery to close power and confirm that 220 Engine Battery power to 130 Sensor D Breathing Detection means and 140 Sensor E Heart Rate Detection means mat is stopped (as to no detection of actions of impacts are received) deriving from the 230 Item 1 Seat Belt Harness Strap of Q1 Occupant Vehicle (identified as 1 in drawing description).

350 Micro Controller Node Z Engine Battery, wirelessly transmits demand that power has stopped to the PCB location, also known as 210 Power Control Box means of Q1 Occupant Vehicle (identified as 1 in drawing description).

PCB location, also known as 210 Power Control Box means, receives the demand to close 130 Sensor D Breathing Detection means and 140 Sensor E Heart Rate Detection means valves and to confirm that power has been stopped or closed.

PCB location, also known as 210 Power Control Box means closes the power from the receiving line of the 130 Sensor D Breathing Detection means and 140 Sensor E Heart Rate Detection means mat thus meaning that power valve to 130 Sensor D Breathing Detection means and 140 Sensor E Heart Rate Detection means is closed and is not delivering power any longer.

Power therefore is no longer flowing to the 130 Sensor D Breathing Detection means and 140 Sensor E Heart Rate Detection means mat and PCB location, also known as 210 Power Control Box means relays a wireless transmission to 350 Micro Controller Node Z Engine Battery that valve is closed and power has stopped.

350 Micro Controller Node Z Engine Battery by wireless transmission sends the confirmation that valve is closed to 250 Item 7 Central Storage and Processing Unit and that 130 Sensor D Breathing Detection means and 140 Sensor E Heart Rate Detection means mat (incorporated into or onto 230 Item 1 Seat Belt Harness Strap) of Region X Front Passenger Position of Q1 Occupant Vehicle (identified as 1 in drawing description) power has been stopped.

250 Item 7 Central Storage and Processing Unit documents the confirmation by date, time, and region of occurrences and compares date to past actions of impacts as priorly recorded by the 250 Item 7 Central Storage and Processing Unit.

The description as described within the scope of the present invention is offered as an example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method with out departing form the integrity of the current invention.

### 7^{th} Contact Sensor A Applied to Item 12 Steering Wheel Grip Post,

With in the scope of the present invention the next sensor means that may receive a point of impact is the SA location, also known as 100 Sensors A Finger Print Detection Sensors means as applied to 310 Item 12 Steering Wheel Grip Post, depicted in FIG. 2.

SA location, also known as 100 Sensors A Finger Print Detection Sensors means as depicted in FIG. 2 as being incorporated into or onto 310 Item 12 Steering Wheel Grip Post, is also depicted as being located in Region F, Front Drivers Position internally located of the Q1 Occupant Vehicle (identified as 1 in drawing desription).

SA location, also known as 100 Sensors A Finger Print Detection Sensors means, is applied to 310 Item 12 Steering Wheel Grip Post of Region F Front Drivers Position internally located with in Q1 Occupant Vehicle (identified as 1 in drawing desription) as being the best mode to obtaining a finger sensor reading preprogrammed to detect finger print patterns by use of a Capacitance Scanning Mechanism.

SA location, also known as 100 Sensors A Finger Print Detection Sensors means, best mode of obtaining a finger print sensor reading as being incorporated into or onto 310 Item 12 Steering Wheel Grip Post, is preprogrammed to detect finger print patterns by use of a Capacitance Scanning Mechanism. Capacitance Scanning Mechanism is a marketable means that makes up a simple fingerprint-scanning device. Capacitance Scanner is a finger print sensor that detects finger print patterns. Capacitance Scanner is recognized as being the best, selected fingerprint-scanning device, by comparison with in the scope of this invention. The Capacitance Scanner is made up of one or more semiconductor chips, which has an array of tiny cells each cell includes two conductor plates, covered with an insulting layer. The cells are smaller than the width of one ridge of a fingernail. The sensor is connected to an integrator, an electrical circuit built around the inverting operational amplifier. The inverting amplifier is a complex semiconductor device, made up of a number of transistors, resistors and capacitors. With the amplifier, an inverting amplifier alerts on one current based on fluctuations in another current. The inverting amplifier thus, directly alerts the supply voltage. The alternation is based on the relative voltage of two inputs, called the inverting terminal and the non-inverting terminal. The non-inverting terminal is connected to reference voltage supply, (in this case power is drawn from the battery that is directly designed onto the Capacitance Finger Print Detector) and a feed back loop, which is also connected to amplifier out-put includes the two conductor plates. The two conductor plates from a basic capacitor, enhances an electrical component that can stored up charge. The surface of the finger acts as a third capacitance plate, separated by the insulating layers in the cell structure and in the case of the finger print valleys a pocket of air. Varying the distance between the capacitor plates (example by moving the finger closer or further away from the conductor plates) changes the total capacitor. Because of this quality the capacitor under a ridge would have a greater capacitance than the capacitor in a cell under the valley. The finger print voltage reads output and determines whether it is characteristic of a ridge or a valley. The processor can put together an overall picture of the fingerprint, similar to the image captured by an optical scanner.

100 Sensor A Finger Print Detection Senor as being applied into or onto 310 Item 12 Steering Wheel Grip Post means of the Q1 Occupant Vehicle in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors usability factor. The description as described within the scope of the present invention is offered as example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method.

The recommended environments for each sensor incorporated with in the scope of this invention is as follows or applied to each sensor according to manufacture recommendations. All components incorporated on to 310 Item 12 Steering Wheel Grip Post of the Q1 Occupant Vehicle system being identified as the SenCora Print System are low cost, highly effective, market available sensors and computer components.

It is recommended that sensors more particularly 100 Sensor A Finger Print Detection means are to be located on the interior side of the vehicle be made to endure and conform to temperatures of −40 degrees Celsius to +85 degrees Celsius. With a vibration stress lever being or reduced levels, able to with stand water spray, with a thermal shock factor of reduced rate of change as well as other protective factors that would enhance the life of each component under normal to extreme vehicle circumstances.

It is further recommended that sensors located with in the exterior of the vehicle be made to endure and conform to the recommendations temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

In respect to 100 Sensor A Finger Print Detection means being located internally, 100 Sensor A Finger Print Detection means is on a non-beaconing network as it is applied to 310 Item 12 Steering Wheel Grip Post, located in Region F, Front Drivers Position of vehicle. In this non-beaconing net-work 100 Sensor A Finger Print Detection means as incorporated into or onto 310 Item 12 Steering Wheel Grip Post and have their receivers continually active, requiring a more robust supply of power while other sensors with in its region remain asleep, transmitting only when an external stimulus is detected.

All sensor components described with in the scope of the current invention is described as being located either internally or externally of Q1 Occupant Vehicle (identified as 1 in drawing desription) and is recommended to have a 100% operational level of activity and a 10 to 15 year life span.

Within the scope of the present invention once the entering occupant's fingers or thumb comes into contact with the Capacitance Finger Print Detector means as being located on 310 Item 12 Steering Wheel Grip Post internally of Q1 Occupant Vehicle (identified as 1 in drawing desription) or receiving an action of impact, this contact causes wireless communication of impacted action of impact to be transmitted to the next means described as MZ location, also known as Micro Controller Nodes Z's means used to receive and further the transmissions of impacted actions as being the next point of contact.

FIG. 2 depicts SA location, also known as 100 Sensors A Finger Print Detection means, as being applied to 310 Item 12 Steering Wheel Grip Post internally of Q1 Occupant Vehicle to be in one manor the best described method for applying the present invention.

In perspective to 100 Sensor A Finger Print Detection means as applied to 310 Item 12 Steering Wheel Grip Post (internally located within Q1 Occupant Vehicle) is recommended to be housed with in a thin, durable, flexible, plastic sensor mat that is or incorporated onto 310 Item 12 Steering Wheel Grip Post or by being applied just beneath the first layer of the 310 Item 12 Steering Wheel Grip Post or applied to the exterior surface of the 310 Item 12 Steering Wheel Grip Post internally of Q1 Occupant Vehicle (identified as 1 in drawing desription) of Region F, Front Drivers Position by graphing, under laid, gluing, bolting or any other means necessary needed by those skilled in the art.

### How Sensor A is Used

100 Sensor A Finger Print Detection means as applied to 310 Item 12 Steering Wheel Grip Post (internally located within Q1 Occupant Vehicle) is gripped by the hand of the occupant hand or hands as to position him self as to hold the steering wheel grip post (as one would when driving a vehicle). The pressure of the hands, fingers and fingertips will grip and wrap the 310 Item 12 Steering Wheel Grip Post, therefore allowing a finger print action to be detected on the 310 Item 12 Steering Wheel Grip Post.

The Capacitance Finger Print Detection Unit operates on a wireless frequency means such as a radio frequency. When a hand gripping action and or finger print pressure is an action received to the 310 Item 12 Steering Wheel Grip Post of the Q1 Occupant Vehicle (identified as 1 in drawing desription) the incorporated finger print detection mat receives the impact of action applied to the 310 Item 12 Steering Wheel Grip Post and transfers finger print data collected at point of contact then transmits this finger print action of received impact to the MZ Location, Identified as the 150 Micro Controller Node Z Finger Print.

MZ Location, Identified as the 150 Micro Controller Node Z Finger Print governs over all external and internal finger print detection sensors of its type. Finger print detection locations governed by the MZ Location, Identified as the 150 Micro Controller Node Z Finger Print are external Door locations 23, Door A, 54, Door B, 34, Door C and 44, Door D as well the same 150 Micro Controller Node Z Finger Print governs internally placed finger print sensor detection area as being the 310 Item 12 Steering Wheel Grip of the Q1 Occupant Vehicle (identified as 1 in drawing desription).

MZ Location, Identified as the 150 Micro Controller Node Z Finger Print is programmed to receive transmissions of finger print detection or actions of activity of pressure applied as reporting a non-detection reading as well as the location of region activity occurred. The Mz Location, Identified as the 150 Micro Controller Node Z Finger Print then further transfers this action of received finger print detection and its relative data to the 250 Item 7 Central Storage and Processing Unit.

Transmission of MZ Location, Identified as the 150 Micro Controller Node Z Finger Print to the 250 Item 7 Central Storage and Processing Unit is transmitted in the form of wireless transmission means such as a radio transmission and is on a pitch (frequency) that is identified by no other Micro Controller Node Z with in the Q1 Occupant Vehicle (identified as 1 in drawing desription).

100 Sensor A Finger Print Detection means applied to 310 Item 12 Steering Wheel Grip Post will not require a pull of power from the more robust supply of power source identified as the 200 Engine Battery of the Q1 Occupant Vehicle (identified as 1 in drawing desription) with in the first full twenty seconds of initial impact to 100 Sensor A Finger Print Detection means located with in Region F Front Drivers Position of vehicle. Pressure detected action of impact occurring to the 310 Item 12 Steering Wheel Grip Post with in the first initial twenty seconds of initial sensor impact will be internally power supplied by the 100 Sensor A Finger Print Detection sensor's own battery supply designed directly onto the finger print detection sensor its self.

The following is a Process of Action as it pertains to internally located 100 Sensor A Finger Print Detection means.

Occupant hands are gripping 310 Item 12 Steering Wheel Grip Post of vehicle.

Occupant hands are gripping 310 Item 12 Steering Wheel Grip, as to be applying pressure with his or her hand to 310 Item 12 Steering Wheel Grip Post of located with in Region F Front Drivers Position of Q1 Occupant Vehicle (identified as 1 in drawing desription).

Occupant has his fingers wrapped around 310 Item 12 Steering Wheel Grip Post while he is seated on the 240 Item 2 Car Seat or Couch of Q1 Occupant Vehicle (identified as 1 in drawing desription).

100 Sensor A Finger Print Detection means incorporated into the 310 Item 12 Steering Wheel Grip Post located in Region F Front Drivers Position of Q1 Occupant Vehicle is now detecting pressure of finger print from the occupant's hand and finger area as occupant is gripping 310 Item 12 Steering Wheel Grip Post.

100 Sensor A Finger Print Detection means detects and transmits finger print detection of actions of impact by wireless transmission means such as by wireless radio transmission to 150 Micro Controller Node Z Finger Print.

150 Micro Controller Node Z Finger Print then transmits detected 100 Sensor A Finger Print Detection action of impact coming from Region F Front Drivers Position of Q1 Occupant Vehicle, to 250 Item 7 Central Storage and Processing Unit also located with in Q1 Occupant Vehicle (identified as 1 in drawing desription).

150 Micro Controller Node Z Finger Print Detection is transmitted by way of wireless radio transmission and is on a pitch (frequency) that can't be identified by any other Micro Controller Node Z with in the Q1 Occupant Vehicle (identified as 1 in drawing desription).

150 Micro Controller Node Z Finger Print then further transmits the received action of impact occurring from the Region F Front drivers Position to the 250 Item 7 Central Storage and Processing Unit so that the date, time and impact of region of action occurred along with comparable data filing for all actions of impact received to the internally located 310 Item 12 Steering Wheel Grip Post.

250 Item 7 Central Storage and Processing Unit retains and or transmits all actions of 100 Sensor A Finger Print Detections from the sensor A detection region of impact being Region F Front Drivers Position to observing Q2 Policing Units(identified as 2 in drawing desription) and or 320 S1 Governing Authorities who request on board viewing of real time or stored actions of occurrences that have taken place with the Q1 Occupant Vehicle (identified as 1 in drawing desription).

However, after the first twenty seconds of received action of impact, 100 Sensor A Finger Print Detection means housed with in a sensor detection mat has detected a pressure or indicated action of impact. 100 Sensor A Finger Print Detection mat would no longer draw power from its self but would then power down causing a preprogrammed command for a continual power supply from the 220 Engine Battery to take over as a continual source of power to all 100 Sensor A Finger Print Detections means housed with in the sensor detection mat incorporated by the 310 Item 12 Steering Wheel Grip Post of Region F Front Drivers Position of the Q1 Occupant Vehicle (identified as 1 in drawing desription).

The demand or alternative source of continual robust power will come from the direction of the 250 Item 7 Central Storage and Processing Unit. 250 Item 7 Central Storage and Processing Unit will receive transmission from 150 Micro Controller Node Z Finger Print from Region F Front Drivers Position of Q1 Occupant Vehicle (identified as 1 in drawing desription) where initial area of impact occurred.

250 Item 7 Central Storage and Processing Unit then receives this transmitted action of impact from 150 Micro Controller Node Z Finger Print Region F Front Drivers Position and sends out a wireless transmittal to 350 Micro Controller Node Z Engine Battery to awake PCB location, also known as 210 Power Control Box means.

350 Micro Controller Node Z Engine Battery relays to PCB location, also known as 210 Power Control Box means to awake and open power valve to 100 Sensor A Finger Print Detection mat located in Region F Front Drivers Position of the Q1 Occupant Vehicle (identified as 1 in drawing desription).

PCB location, also known as 210 Power Control Box means responds by wireless demand and wakens to the response of 350 Micro Controller Node Z Engine Battery, thus opening the power valve to 100 Sensor A Finger Print Detection mat of Region F Front Drivers Position of the Q1 Occupant Vehicle (identified as 1 in drawing desription).

PCB location, also known as 210 Power Control Box means is hard wired or as to be connected by identifiable means known as the 200 Electrical Highway Wire means to the PCB location, also known as 210 Power Control Box means.

Upon the PCB location, also known as 210 Power Control Box means receiving the demand to open power to 100 Sensor A Finger Print Detection hardwired line, power is released from the 220 Engine Battery through the 210 Power Control Box power line.

With in the PCB location, also known as 210 Power Control Box means multiple sensor power lines representing each type of detection sensor is contained with in the 210 Power Control Box release line.

Power is released from the 220 Engine Battery through the PCB location, also known as 210 Power Control Box means release line and is directed to flow through to the 100 Sensor A Finger Print Detection line by demand of the 210 Power Control Box.

200 Electrical Highway Wire means carries the hard wired commanded and transferred power flow to the PCB location, also known as 210 Power Control Box means to 100 Sensor A Finger Print Detection line with in the PCB location, also known as 210 Power Control Box means. Each type of internally located sensor power line through out the scope of the current invention is contained with in the Power Control Box.

200 Electrical Highway Wire means supplies power to the 100 Sensor A Finger Print Detection mat where impact of action such as a pressure of application and finger print detection has occurred.

200 Electrical Highway Wire means is incased with in a durable plastic casing and has multiple sensor lines housed with in the same durable plastic casing. Once sensor power lines exits the PCB location, also known as 210 Power Control Box means and has been traced to the steering Wheel mechanism of the steering wheel shaft that supports the Steering Wheel Grip Post incorporated with the 310 Item 12 Steering Wheel Grip Post of Region F Front Drivers Position of the Q1 Occupant Vehicle (identified as 1 in drawing desription), the 210 Power Control Box means line is thinned out and is incorporated in the 100 Sensor A Finger Print Detection mat.

This insulated tracing 200 Electrical Highway Wire means line as pertains to all interior sensors that requires a more robust power supply will be provided the method of insulation as being housed with in durable plastic casing accommodation in order to deliver this more robust power supply when an action of impact beyond twenty seconds of initial impact is required.

100 Sensor A Finger Print Detection line runs from the PCB location, also known as 210 Power Control Box means to the 100 Sensor A Finger Print Detection mat region of impact being Region F Front Drivers Position following the exampled path currency as being located with in the of Q1 Occupant Vehicle (identified as 1 in drawing desription).

100 Sensor A Finger Print Detection hard wired power line runs from the PCB location, also known as 210 Power Control Box means that is located with in the dashboard of the Q1 Occupant Vehicle (identified as 1 in drawing desription). 100 Sensor A Finger Print Detection line follows a path that leads to the 100 Sensor A Finger Print Detection mat.

100 Sensor A Finger Print Detection line thins out as to be incorporated into the 100 Sensor A Finger Print Detection mat.

100 Sensor A Finger Print Detection hard wire line delivers the needed more robust power supply to the 100 Sensor A Finger Print Detection mat.

100 Sensor A Finger Print Detection mat incorporated in the 310 Item 12 Steering Wheel Grip Post of Region F Front Drivers Position of the Q1 Occupant Vehicle (identified as 1 in drawing desription) detects the continual impact of action as long as an action of impact is being applied to the 310 Item 12 Steering Wheel Grip Post incorporating the Sensor A Finger Print Detection means of Region F Front Drivers Position of the Q1 Occupant Vehicle (identified as 1 in drawing desription).

100 Sensor A Finger Print Detects and transmits finger print pressure and actions of impact by wireless means such as radio transmission means to 150 Micro Controller Node Z Finger Print.

150 Micro Controller Node Z Finger Print then transmits detected 100 Sensor A Finger Print Detection actions of impact deriving from Region F Front Drivers Position of Q1 Occupant Vehicle to 250 Item 7 Central Storage and Processing Unit.

150 Micro Controller Node Z Finger Print means is transmitted by way of wireless radio transmission is on a pitch (frequency) that can not be identified by any other Micro Controller Node Z with in the Q1 Occupant Vehicle (identified as 1 in drawing desription).

150 Micro Controller Node Z Finger Print then further transmits the received action of impact to 250 Item 7 Central Storage and Processing Unit for date, time, and impacted region where action of impact occurred and comparable data is filed away for future viewing.

250 Item 7 Central Storage and Processing Unit retains and or transmits all actions of 100 Sensor A Finger Print Detection actions of impact from Region F Front Drivers Position of the Q1 Occupant Vehicle (identified as 1 in drawing desription) to Q2 Policing Units and or 320 S1 Governing Authorities who may request such information in either real time or delayed time for future viewing.

250 Item 7 Central Storage and Processing Unit sends out a wireless demand for confirmation that 100 Sensor A Finger Print Detection mat is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that 100 Sensor A Finger Print Detection mat is receiving power from the 220 Engine Battery.

350 Micro Controller Node Z Engine Battery further transmits the wireless demand to confirm that power valve was opened to 100 Sensor A Finger Print to PCB location, also known as 210 Power Control Box means.

PCB location, also known as 210 Power Control Box means receives this wireless transmittal demand from 350 Micro Controller Node Z Engine Battery. PCB location, also known as 210 Power Control Box means sends back a wireless response to 350 Micro Control Node Z Engine Battery confirming that 100 Sensor A Finger Print valve is open and receiving power fed to the Region F, 100 Sensor A Finger Print mat of Region F Front Drivers Position of Q1 Occupant Vehicle (identified as 1 in drawing desription) receiving an action of impact.

350 Micro Controller Node Z Engine Battery receives transmission from PCB location, also known as 210 Power Control Box means confirmation and further transmits the confirmation to 250 Item 7 Central Storage and Processing Unit.

250 Item 7 Central Storage and Processing Unit then records the exact time, date region of activity of each twenty seconds of impact received to region of activity.

When region (such as Region F Front Drivers Position) is no longer impacted by an action of activity as to no indication of finger print is detected from the 100 Sensor A Fingerprint mat incorporated into the 310 Item 12 Steering Wheel Grip Post of the Q1 Occupant Vehicle (identified as 1 in drawing desription); 150 Micro Controller Node Z Fingerprint no longer sends action of impact received transmittals to 250 Item 7 Central Storage and Processing Unit.

250 Item 7 Central Storage and Processing Unit sends a wireless demand to 350 Micro Controller Node Z Engine Battery to close and confirm that 220 Engine Battery power to 100 Sensor A Finger Print Detection mat is stopped.

350 Micro Controller Node Z Engine Battery wirelessly transmits this demand power has stopped to the PCB location, also known as 210 Power Control Box means of Q1 Occupant Vehicle (identified as 1 in drawing desription).

PCB location, also known as 210 Power Control Box means receives the demand to close 100 Sensor A Finger Print valve and to confirm that power has been closed.

PCB location, also known as 210 Power Control Box means closes the power from the receiving line of the 100 Sensor Finger Print mat thus meaning that power valve to 100 Sensor A Finger Print Detection mat is closed and is not delivering power any longer.

Power therefore is no longer flowing to the 100 Sensor A Finger Print mat and 210 Power Control Box relays a wireless transmission to 350 Micro Controller Node Z Engine Battery that valve is closed and power has ended.

350 Micro Controller Node Z Engine Battery by wireless transmission sends the confirmation that valve is closed to 100 Sensor A Finger Print Detection mat of Region F Front Drivers Position of Q1 Occupant Vehicle (identified as 1 in drawing desription).

250 Item 7 Central Storage and Processing Unit documents the confirmation by date, time, and region of occurrences and compares date to past actions of impacts as priorly recorded by the 250 Item 7 Central Storage and Processing Unit.

This concludes the process of action of impact as pertains to 100 Sensor A Finger Print Detection means and its intended use with in the SenCora Print System with the Q1 Occupant Vehicle (identified as 1 in drawing desription).

This concludes the process of action of impact as pertains to 100 Sensor A Finger Print Detection means and its intended use with in the SenCora Print System.

It is left to those skilled in the art of that the application of 100 Sensor A Finger Print Detection means as applied to 310 Item 12 Steering Wheel Grip Post of the Region F, Front Drivers Position interior of vehicle for proper application but as not to depart from the sincerity of the current invention.

### End of the 7^{th} Contact

### 8^{th} Contact Sensor's B, C and D and E are Comprised of (What is Made of) 290 Item 5 Trunk Board

With in the scope of the present invention the next sensor means that may receive a point of impact is the SB location, Identified as 110 Sensor B Weight Detection, 120 C Height Detection means, 130 Sensor D Breathing Detection means and 140 Sensor E Heart Rate Detection means as being incorporated into 290 Item 5 Trunk Board of Q1 Occupant Vehicle is depicted in FIG. 6 and FIG. 7.

SB location, also known as SB Location's 110 Sensor B Weight Detection, 120 Sensor C Height Detection means, 130 Sensor D Breathing Detection means and 140 Sensor E Heart Rate Detection means as depicted in FIG. 6 and FIG. 7as being incorporated 290 Item 5 Trunk Board of vehicle internally of the Q1 Occupant Vehicle (identified as 1 in drawing desription).

SB location, also known as 110 Sensor B Weight Detection, 120 Sensor C Height Detection means, 130 Sensor D Breathing Detection means and 140 Sensor E Heart Rate Detection means, is applied to 290 Item S Trunk Board of vehicle Region P Trunk of Vehicle are internally located with in Q1 Occupant Vehicle (identified as 1 in drawing desription) and are incorporated into the following sensor detection areas as being 110 Sensor B Weight Detection means located in Regions F Front Drivers Position, Region X Front Passengers Position, Region O Rear Drivers Position, Region G Rear Passenger Position and as being incorporated into 240 Item 2 Car Seat or Couch and 280 Item 4 Floor Boards, 120 Sensor C Height Detection means located in Region F Front Drivers Position, Region X Front Passengers Position, Region O Rear Drivers Position and Region G Rear Passenger Position incorporated into 260 Item 3 Car Seat Back Rest and 130 Sensor D Breathing Detection means and 140 Sensor E Heart Rate Detection means located in Region F Front Drivers Position, Region X Front Passengers Position, Region O Rear Drivers Position and Region G Rear Passenger Position incorporated into 240 Item 2 Seat Belt Harness Strap of Q1 Occupant Vehicle (identified as 1 in drawing desription).

110 Sensor B Weight Detection, 120 Sensor C Height Detection means, 130 Sensor D Breathing Detection means and 140 Sensor E Heart Rate Detection means as depicted in FIG. 5 as being applied to 290 Item 5 Trunk Board of vehicle, of the Q1 Occupant Vehicle (identified as 1 in drawing desription), these sensors in respect to size can be under standard market configurations and not set to the limits of size as described forth. Measurement and added functionality per sensor can be but not limited to measurements as the following example is described. Each sensor with in the scope of this invention sizes are approximately 2 mm×2.5 mm, has an AVR-like RISC core on it, 3K of memory, 8 bit On-chip ADC, FSK radio transmitter, Paged memory system, communication protocol accelerators, register windows, 32 KHz oscillator, SPI programming interface, RS323 compatible UART, 4-bit input port, 4-bit output, encrypted communication hardware support, memory-mapped active messages FLL based frequency synthesizer, Over sampled communication synchronization, as well as any additional components that will enhance the sensors' usability factor. These sensor technologies as applied to 290 Item 5 Trunk Board of vehicle Q1 Occupant Vehicle is recommended to be sandwiched between two thin flexible polyester sheets which have electronically conductive electrodes deposited in various patterns. Inside surface of one sheet forms a row pattern, while the inner surface forms employees a column pattern. The spacing between the rows and columns varies according to sensor application and can be as small as 0.5 mm.

The recommended environments for each sensor incorporated with in the scope of this invention is as follows or applied to each sensor according to manufacture recommendations. All components incorporated on to 110 Sensor B Weight Detection, 120 Sensor C Height Detection means, 130 Sensor D Breathing Detection means and 140 Sensor E Heart Rate Detection means as depicted in FIG. 6 and FIG. 7 identified as the SenCora Print System are low cost, highly effective, market available sensors and computer components.

It is recommended that sensors more particularly 110 Sensor B Weight Detection, 120 Sensor C Height Detection means, 130 Sensor D Breathing Detection means and 140 Sensor E Heart Rate Detection means as depicted in FIG. 6 and FIG. 7 as are to be located on the interior side of the vehicle be made to endure and conform to temperatures of −40 degrees Celsius to +85 degrees Celsius. With a vibration stress lever being or reduced levels, able to with stand water spray, with a thermal shock factor of reduced rate of change as well as other protective factors that would enhance the life of each component under normal to extreme vehicle circumstances.

It is further recommended that sensors located with in the exterior of the vehicle be made to endure and conform to the recommendation temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

Within the scope of the present invention once the entering occupant's body is laying on the Region P Trunk Board of the occupant vehicle as in a horizontal position and comes into contact with the 290 Item 5 Trunk Board of vehicle incorporated with sensor detection mat, located with in the Q1 Occupant Vehicle (identified as 1 in drawing depictions) Region P Trunk location, all sensors incorporated with in the Region P sensor detection area are impacted with an action of impact causing a wireless communication of the impacted actions of the occupant's weight and body pressure to be transmitted to the next means described location identified as MZ locations, also known as Micro Controller Node Z's. Each sensor receiving an impact of action will cause its related Micro Controller Node Z unit to receive its relative sensor transmission from the area of initial impact deriving from Region P Trunk of Q1 Occupant Vehicle (identified as 1 in drawing depictions).

The Micro Controller Node Z units that are activated and receiving an action of impact from the initial point of contact sensors being 160 Micro Controller Node Z Weight, 170 Micro Controller Node Z Height, 180 Micro Controller Node Z Breathing and 190 Micro Controller Node Z Heart Rate.

### How is Sensor B Weight Detection Means, Attached to 290 Item 5 Trunk Board of Vehicle

FIG. 5 depicts SB location, also known as 110 Sensor B Weight Detection, 120 Sensor C Height Detection means, 130 Sensor D Breathing Detection means and 140 Sensor E Heart Rate Detection, as being applied to 290 Item 5 Trunk Board of vehicle internally of Q1 Occupant Vehicle (identified as 1 in drawing depictions) to be in one manor the best described method for applying the present invention.

In perspective to SB location, also known as, 110 Sensor B Weight Detection, 120 Sensor C Height Detection means, 130 Sensor D Breathing Detection means and 140 Sensor E Heart Rate Detection means, applied to 290 Item 5 Trunk Board of vehicle (internally located within Q1 Occupant Vehicle) is recommended to be housed with in a thin, durable, flexible, plastic sensor mat that is or incorporated into or onto 290 Item 5 Trunk Board of vehicle as being applied just beneath the first layer of the 290 Item 5 Trunk Board of vehicle or applied to the exterior surface of the 290 Item 5 Trunk Board of vehicle internally of Q1 Occupant Vehicle (identified as 1 in drawing depictions) of the Region P Trunk of vehicle internally located with in Q1 Occupant Vehicle and as being incorporated or applied to the 290 Item 5 Trunk Board of vehicle by graphing, under laid, gluing, bolting or any other means necessary needed by those skilled in the art.

This SB location, Identified as 110 Sensor B Weight Detection, 120 Sensor C Height Detection means, 130 Sensor D Breathing Detection means and 140 Sensor E Heart Rate Detection means recommended as to be sandwiched between two thin flexible polyester sheets, which have electronically conductive electrodes deposited in various patterns. The inside surface, of one sheet forms a row pattern while the inner surface forms and employs a column pattern. The spacing between the rows and columns varies according to sensor application by those best skilled in the art. Row and column spacing can be as small as 0.5 mm. This housing unit for the SB location, Identified as 110 Sensor B Weight Detection means, 120 Sensor C Height Detection means, 130 Sensor D Breathing Detection means and 140 Sensor E Heart Rate Detection means is being incorporated within 290 Item 5 Trunk Board of vehicle of Q1 Occupant Vehicle.

Sensor C is further described as being incorporated within the sensor detection mat of Region P, Item 5 Trunk Board of Q1 Occupant Vehicle in the following described manor,

Sensors 110 Sensor B Weight Detection, 120 Sensor C Height Detection means, 130 Sensor D Breathing Detection means and 140 Sensor E Heart Rate Detection means is Used How as applied to 290 Item 5 Trunk Board of vehicle.

110 Sensor B Weight Detection, 120 Sensor C Height Detection means, 130 Sensor D Breathing Detection means and 140 Sensor E Heart Rate Detection means as applied to 290 Item 5 Trunk Board of vehicle (internally located within Q1 Occupant Vehicle) receives the occupants weight or pressure applied by the weight of occupant's body: as occupant lays on 290 Item 5 Trunk Board of vehicle, while simultaneously the occupant is applying pressure with his or her body to 110 Sensor B Weight Detection, 120 Sensor C Height Detection means, 130 Sensor D Breathing Detection means and 140 Sensor E Heart Rate Detection means of Q1 Occupant Vehicle (identified as 1 in drawing depictions) located in Region P Trunk Board of Q1 Occupant Vehicle.

290 Item 5 Trunk Board of vehicle is located with in Region P Trunk of Vehicle and is incorporated with 110 Sensor B Weight Detection, 120 Sensor C Height Detection means, 130 Sensor D Breathing Detection means and 140 Sensor E Heart Rate Detection means with in the 290 Item 5 Trunk Board of vehicle of vehicle. Each Sensor detection means in its given region may share the same sensor mat but each sensor will have its own tracing path as not to touch or cross over a sensor trace path that is designed to detect a different sensor actions.

110 Sensor B Weight Detection, 120 Sensor C Height Detection means, 130 Sensor D Breathing Detection means and 140 Sensor E Heart Rate Detection means regional sensor mat areas do not share additional sensor detection sensors.

110 Sensor B Weight Detection, 120 Sensor C Height Detection means, 130 Sensor D Breathing Detection means and 140 Sensor E Heart Rate Detection means do not share the same sensor detection mats with its sensor detection area incorporated with in the 290 Item 5 Trunk Board of vehicle of the Q1 Occupant Vehicle (identified as 1 in drawing depictions).

Occupant is laid on 290 Item 5 Trunk Board of vehicle of vehicle as in a horizontal position.

Occupant is laid on 290 Item 5 Trunk Board of vehicle, while simultaneously the occupant is applying pressure with his or her body to 110 Sensor B Weight Detection, 120 Sensor C Height Detection means, 130 Sensor D Breathing Detection means and 140 Sensor E Heart Rate Detection mat of the 290 Item 5 Trunk Board of vehicle of Q1 Occupant Vehicle (identified as 1 in drawing depictions) located in Region P Trunk Board Position of Q1 Occupant Vehicle (identified as 1 in drawing depictions).

Occupant is applying pressure to 290 Item 5 Trunk Board of vehicle of vehicle with his or her body placed on the 290 Item 5 Trunk Board of vehicle as one normally lays in the horizontal position.

110 Sensor B Weight Detection, 120 Sensor C Height Detection Sensors means, Sensor 130 Sensor D Breathing Detection means and 140 Sensor E Heart Rate Detection means incorporated into 290 Item 5 Trunk Board of vehicle of the Region P Trunk Board of vehicle is now detecting pressure of weight from the occupant's body weight of the Q1 Occupant Vehicle (identified as 1 in drawing depictions).

110 Sensor B Weight Detection, 120 Sensor C Height Detection Sensors means, 130 Sensor D Breathing Detection means and 140 Sensor E Heart Rate Detection means of occupant transmits the detection of the impact of action by wireless radio transmission to MZ location, 160 Micro Control Node Z Weight Detection means, MZ location, 170 Micro Controller Node Z Height and 180 MZ location, Micro Controller Node Z Breathing and 190 MZ location, Micro Controller Node Z Heart Rate.

MZ location, 160 Micro Control Node Z Weight Detection means, Mz location, 170 Micro Controller Node Z Height, 180 MZ location, Micro Controller Node Z Breathing and 190 MZ location, Micro Controller Node Z Heart Rate then transmits detected 290 Item 5 Trunk Board of vehicle weight detected action of impact deriving from Region P Trunk Board of vehicle position of Q1 Occupant Vehicle (identified as 1 in drawing depictions), to 250 Item 7 Central Storage and Processing Unit. These Micro Control Node Z means are transmitted by way of wireless radio transmission and are on a pitch (frequency) that can not be identified by any other Micro Controller Node Z means within the Q1 Occupant Vehicle.

MZ location, 160 Micro Control Node Z Weight Detection means, MZ location, 170 Micro Controller Node Z Height, 180 MZ location, Micro Controller Node Z Breathing and 190 MZ location, Micro Controller Node Z Heart Rate then further transmits the received action of impacts of actions deriving from impacted sensors 110 Sensor B Weight Detection, 120 Sensor C Height Detection Sensors means, 130 Sensor D Breathing Detection means and 140 Sensor E Heart Rate Detection means to 250 Item 7 Central Storage and Processing Unit for date, time and impact of region where action of impact occurred for comparable data filing.

250 Item 7 Central Storage and Processing Unit retains and transmits all actions of 110 Sensor B Weight Detections from Region P Trunk of vehicle of Q1 Occupant Vehicle (identified as 1 in drawing depictions) to observing Q2 Policing Units (identified as 2 in drawing depictions) and or 320 S1 Governing Authority Stations who request on board viewing of real time or stored actions of occurrences recorded by the 250 Item 7 Central Storage and Processing Unit located with in the Q1 Occupant Vehicle's SenCora Print System.

However, after the first twenty seconds of received action of impact, 110 Sensor B Weight Detection, 120 Sensor C Height Detection Sensors means, 130 Sensor D Breathing Detection means and 140 Sensor E Heart Rate Detection means housed with in a sensor detection mat has detected a pressure or indicated action of impact. Each sensor type described as impacted with an action of impact would no longer draw power from its self but would then power down causing a preprogrammed command for a continual power supply from the 220 Engine Battery to take over as a continual source of power to all sensor types described as impacted with and action of impact housed with in the sensor detection mat incorporated with in the 290 Item S Trunk Board of vehicle of vehicle of Region P Trunk Board of vehicle position of Q1 Occupant Vehicle (identified as 1 in drawing depictions).

The demand or alternative source of continual robust power will come from the direction of the 250 Item 7 Central Storage and Processing Unit. 250 Item 7 Central Storage and Processing Unit will receive transmission from Mz location, 160 Micro Control Node Z Weight Detection means, MZ location, 170 Micro Controller Node Z Height, 180 MZ location, Micro Controller Node Z Breathing and 190 MZ location, Micro Controller Node Z Heart Rate as actions deriving from the Region P Trunk of vehicle position of Q1 Occupant Vehicle (identified as 1 in drawing depictions) where initial area of impact occurred.

250 Item 7 Central Storage and Processing Unit then receives this transmitted action of impact from MZ location, 160 Micro Control Node Z Weight Detection means, MZ location, 170 Micro Controller Node Z Height, 180 MZ location, Micro Controller Node Z Breathing and 190 MZ location, Micro Controller Node Z Heart Rate Region P Trunk position and sends out a wireless transmittal to 350 Micro Controller Node Z Engine Battery to awake PCB location, also known as 210 Power Control Box means.

350 Micro Controller Node Z Engine Battery relays to PCB location, also known as 210 Power Control Box means to awake and open power valve 110 Sensor B Weight Detection, 120 Sensor C Height Detection means, 130 Sensor D Breathing Detection means and 140 Sensor E Heart Rate Detection mat located in Region P Trunk position of Q1 Occupant Vehicle.

PCB location, also known as 210 Power Control Box means responds by wireless demand and wakens to the response of 350 Micro Controller Node Z Engine Battery, thus opening the power valve to 110 Sensor B Weight Detection, 120 Sensor C Height Detection means, 130 Sensor D Breathing Detection means and 140 Sensor E Heart Rate Detection mat of Region P Trunk position of Q1 Occupant Vehicle (identified as I in drawing depictions).

210 Power Control Box is hard wired or as to be connected by identifiable means known as the 200 Electrical Highway Wire means to the PCB location, also known as 210 Power Control Box means.

Upon the PCB location, also known as 210 Power Control Box means receiving the demand to open power to 110 Sensor B Weight Detection, 120 Sensor C Height Detection means, 130 Sensor D Breathing Detection means and 140 Sensor E Heart Rate Detection hardwired line of the 290 Item 5 Trunk Board of vehicle of the Q1 Occupant Vehicle, power is released from the 220 Engine Battery through the PCB location, also known as 210 Power Control Box means.

Within the PCB location, also known as 210 Power Control Box means multiple sensor power lines representing each type of detection sensor is contained with in the 210 Power Control Box release line.

Power is released from the 220 Engine Battery through the PCB location, also known as 210 Power Control Box means release line and is directed to flow through to each sensor type being 110 Sensor B Weight Detection, 120 Sensor C Height Detection means, 130 Sensor D Breathing Detection means and 140 Sensor E Heart Rate Detection line hardwired to the 290 Item 5 Trunk Board of vehicle detection mat located in Region P Trunk of vehicle of Q1 Occupant Vehicle (identified as 1 in drawing depictions) by demand of the 210 Power Control Box.

200 Electrical Highway Wire means carries the hard wired commanded and transferred power flow to the PCB location, also known as 210 Power Control Box means to the 110 Sensor B Weight Detection, 120 Sensor C Height Detection means, 130 Sensor D Breathing Detection means and 140 Sensor E Heart Rate Detection line with in the PCB location, also known as 210 Power Control Box means each type of sensor power line through out the scope of the current invention is contained with in the 210 Power Control Box.

200 Electrical Highway Wire means supplies power to 110 Sensor B Weight Detection, 120 Sensor C Height Detection Sensors means, 130 Sensor D Breathing Detection means and 140 Sensor E Heart Rate Detection mat where impact of actions such as a pressure of application and weight detections has occurred.

200 Electrical Highway Wire means is incased with in a durable plastic casing and has multiple sensor lines housed with in the same durable plastic casing. Once sensor power lines exits the PCB location, also known as 210 Power Control Box means and has been traced to the 290 Item 5 Trunk Board of vehicle region of impact sensors 110 Sensor B Weight Detection, 120 Sensor C Height Detection Sensors means, 130 Sensor D Breathing Detection means and 140 Sensor E Heart Rate Detection mat incorporated with in the 290 Item 5 Trunk Board of vehicle of Region P Trunk of vehicle of the Q1 Occupant Vehicle, the PCB location, also known as 210 Power Control Box means power control line is thinned out and is incorporated into the 290 Item 5 Trunk Board of vehicle comprising each sensor type detection mat.

This insulated tracing line, identified as 200 Electrical Highway Wire means line as pertains to all interior sensors that requires a more robust power supply will be provided the method of insulation as being housed with in durable plastic casing accommodation in order to deliver this more robust power supply when an action of impact beyond twenty seconds of initial impact is required.

110 Sensor B Weight Detection, 120 Sensor C Height Detection means, 130 Sensor D Breathing Detection means and 140 Sensor E Heart Rate Detection line runs from the PCB location, also known as 210 Power Control Box means to each sensor type being 110 Sensor B Weight Detection, 120 Sensor C Height Detection means, 130 Sensor D Breathing Detection means and 140 Sensor E Heart Rate Detection mat region of impact of the Region P Trunk of vehicle following the exampled path of currency as being located with in the of Q1 Occupant Vehicle (identified as 1 in drawing depictions).

110 Sensor B Weight Detection hard wired power line runs from the PCB location, also known as 210 Power Control Box means that is located with in the dashboard of the Q1 Occupant Vehicle (identified as 1 in drawing depictions). Sensors 110 Sensor B Weight Detection, 120 Sensor C Height Detection means, 130 Sensor D Breathing Detection means and 140 Sensor E Heart Rate Detection line, follows a path that leads to sensor type detection mat incorporated into or onto 290 Item 5 Trunk Board of vehicle and located with in Region P Trunk of vehicle.

110 Sensor B Weight Detection, 120 Sensor C Height Detection means, 130 Sensor D Breathing Detection means and 140 Sensor E Heart Rate Detection lines, thins out as to be incorporated into the each sensor type described detection mat of 290 Item 5 Trunk Board of vehicle.

Sensors 110 Sensor B Weight Detection, 120 Sensor C Height Detection means, 130 Sensor D Breathing Detection means and 140 Sensor E Heart Rate Detection hard wire line delivers the needed more robust power supply to the each sensor type described as receiving an action of impact sensor detection mat of the 290 Item 5 Trunk Board of vehicle.

Sensors 110 Sensor B Weight Detection, 120 Sensor C Height Detection means, 130 Sensor D Breathing Detection means and 140 Sensor E Heart Rate Detection means of Region P Trunk Board Position of Q1 Occupant Vehicle detects the continual impact of action as long as an action of impact is being applied to the 290 Item 5 Trunk Board of vehicle of Q1 Occupant Vehicle (identified as 1 in drawing depictions).

110 Sensor B Weight Detection, 120 Sensor C Height Detection means, 130 Sensor D Breathing Detection means and 140 Sensor E Heart Rate Detection actions of impact are transmitted by wireless means such as radio transmission means to Micro Controller Node Z's being MZ location, 160 Micro Control Node Z Weight Detection means, MZ location, 170 Micro Controller Node Z Height and 180 MZ location, Micro Controller Node Z Breathing, 190 MZ location, Micro Controller Node Z Heart Rate.

MZ location, 160 Micro Control Node Z Weight Detection means, MZ location, 170 Micro Controller Node Z Height and 180 MZ location, Micro Controller Node Z Breathing, 190 MZ location, Micro Controller Node Z Heart Rate then transmits detected sensors 110 Sensor B Weight Detection, 120 Sensor C Height Detection means, 130 Sensor D Breathing Detection means and 140 Sensor E Heart Rate Detection actions of impact deriving from of Region P Trunk of vehicle Q1 Occupant Vehicle (identified as 1 in drawing depictions) to 250 Item 7 Central Storage and Processing Unit. MZ location, 160 Micro Control Node Z Weight Detection means, MZ location, 170 Micro Controller Node Z Height and 180 MZ location, Micro Controller Node Z Breathing, 190 MZ location, Micro Controller Node Z Heart Rate Detection means is transmitted by way of wireless radio transmission that is on a pitch (frequency) that can not be identified by any other Micro Controller Node Z with in the Q1 Occupant Vehicle.

MZ location, 160 Micro Control Node Z Weight Detection means, MZ location, 170 Micro Controller Node Z Height and 180 MZ location, Micro Controller Node Z Breathing, 190 MZ location, Micro Controller Node Z Heart Rate then further transmits the received action of impact to 250 Item 7 Central Storage and Processing Unit for date, time, and impacted region where action of impact occurred and comparable data is filed away for future viewing.

250 Item 7 Central Storage and Processing Unit retains and or transmits all actions of 110 Sensor B Weight Detection, 120 Sensor C Height Detection means, 130 Sensor D Breathing Detection means and 140 Sensor E Heart Rate Detection actions of impact from Region P Trunk of vehicle of Q1 Occupant Vehicle (identified as 1 in drawing depictions) to Q2 Policing Units (identified as 1 in drawing depictions) and or 320 S1 Governing Authorities who may request such information in either real time or delayed time for future viewing.

250 Item 7 Central Storage and Processing Unit sends out a wireless demand for confirmation that sensors 110 Sensor B Weight Detection, 120 Sensor C Height Detection means, 130 Sensor D Breathing Detection means and 140 Sensor E Heart Rate Detection mat is receiving power from the 220 Engine Battery. This wireless demand is sent to 350 Micro Controller Node Z Engine Battery.

350 Micro Controller Node Z Engine Battery receives demand from 250 Item 7 Central Storage and Processing Unit to supply confirmation that sensors 110 Sensor B Weight Detection, 120 Sensor C Height Detection means, 130 Sensor D Breathing Detection means, 140 Sensor E Heart Rate Detection mat is receiving power from the 220 Engine Battery.

350 Micro Controller Node Z Engine Battery further transmits the wireless demand to confirm that power valve was opened to sensors 110 Sensor B Weight Detection, 120 Sensor C Height Detection means, 130 Sensor D Breathing Detection means and 140 Sensor E Heart Rate Detection to 210 Power Control Box.

210 Power Control Box receives the wireless transmittal demand from 350 Micro Controller Node Z Engine Battery. 210 Power Control Box sends back a wireless response to 350 Micro Control Node Z Engine Battery confirming that sensors 110 Sensor B Weight Detection, 120 Sensor C Height Detection means, 130 Sensor D Breathing Detection means and 140 Sensor E Heart Rate Detection valve is open and receiving power fed to the Region P Trunk position of Q1 Occupant Vehicle (identified as 1 in drawing depictions) sensors 110 Sensor B Weight Detection, 120 Sensor C Height Detection means, 130 Sensor D Breathing Detection means and 140 Sensor E Heart Rate Detection sensor mat of Region P Trunk of vehicle of Q1 Occupant Vehicle (identified as 1 in drawing depictions) is receiving and action of impact.

350 Micro Controller Node Z Engine Battery receives transmission from PCB location, also known as 210 Power Control Box means confirmation and further transmits this confirmation that sensors 110 Breathing Detection means and 140 Sensor E Heart Rate Detection Sensor B Weight Detection, 120 Sensor C Height Detection means, 130 Sensor D valve is open and is receiving power fed to the Region P Trunk of vehicle position to 250 Item 7 Central Storage and Processing Unit.

250 Item 7 Central Storage and Processing Unit then records the exact time, date region of activity of each twenty seconds of impact received to Region P Trunk activity received.

When Region P Trunk of vehicle is no longer impacted by an action of activity as to no indication of weight or pressure detection is detected from sensors 110 Sensor B Weight Detection, 120 Sensor C Height Detection means, 130 Sensor D Breathing Detection means and 140 Sensor E Heart Rate Detection valve is open and receiving power fed to the Region P Trunk position of Q1 Occupant Vehicle detection mat incorporated into the 290 Item 5 Trunk Board of vehicle of the Q1 Occupant Vehicle; MZ location, 160 Micro Control Node Z Weight Detection means, Mz location, 170 Micro Controller Node Z Height and 180 Mz location, Micro Controller Node Z Breathing, 190 MZ location, Micro Controller Node Z Heart Rate means no longer sends action of impact received transmittals to 250 Item 7 Central Storage and Processing Unit.

250 Item 7 Central Storage and Processing Unit sends a wireless demand to 350 Micro Controller Node Z Engine Battery to close and confirm that 220 Engine Battery power to impacted sensors 110 Sensor B Weight Detection, 120 Sensor C Height Detection means, 130 Sensor D Breathing Detection means and 140 Sensor E Heart Rate Detection mat has stopped.

350 Micro Controller Node Z Engine Battery wirelessly transmits this demand that power has stopped to detection mat belonging to sensors 110 Sensor B Weight Detection, 120 Sensor C Height Detection means, 130 Sensor D Breathing Detection means and 140 Sensor E Heart Rate Detection and sends this transmission to 210 Power Control Box of Q1 Occupant Vehicle (identified as 1 in drawing depictions).

PCB location, also known as 210 Power Control Box means, receives the demand to close sensors 110 Sensor B Weight Detection, 120 Sensor C Height Detection means, 130 Sensor D Breathing Detection means and 140 Sensor E Heart Rate Detection valve and to confirm that power has been closed.

PCB location, also known as 210 Power Control Box means closes the power from the receiving line of sensor 110 Sensor B Weight Detection, 120 Sensor C Height Detection means, 130 Sensor D Breathing Detection means and 140 Sensor E Heart Rate Detection mat, thus meaning that power valve to described sensors detection mat is closed and is not delivering power any longer.

Power therefore is no longer flowing to 110 Sensor B Weight Detection, 120 Sensor C Height Detection means, 130 Sensor D Breathing Detection means and 140 Sensor E Heart Rate Detection mat and 210 Power Control Box relays a wireless transmission to 350 Micro Controller Node Z Engine Battery that valve is closed and power has ended.

350 Micro Controller Node Z Engine Battery by wireless transmission sends the confirmation that valve is closed to sensors 110 Sensor B Weight Detection, 120 Sensor C Height Detection means, 130 Sensor D Breathing Detection means and 140 Sensor E Heart Rate Detection mat of Region P Trunk position of Q1 Occupant Vehicle (identified as 1 in drawing depictions).

250 Item 7 Central Storage and Processing Unit documents the confirmation by date, time, and region of occurrences and compares date to past actions of impacts as priorly recorded by the 250 Item 7 Central Storage and Processing Unit.

The description as described within the scope of the present invention is offered as an example to be the best means necessary for the assembling of the SenCora Print System. However, it is strongly recommended that the manufacture apply the components and sensor types that would best draw a higher efficiency known to manufacture recommendations as pertains to the present invention identified as the SenCora Print System and Method with out departing form the integrity of current invention.

### 9^{th} Contact Before External Information Exchanged

With in the scope of the present invention the next item to receive a point of impact is the 250 Item 7 Central Storage and Processing Unit means.

250 Item 7 Central Storage and Processing Unit means the next contact before information is transmitted externally of Q1 Occupant Vehicle (identified as 1 in drawing depictions).

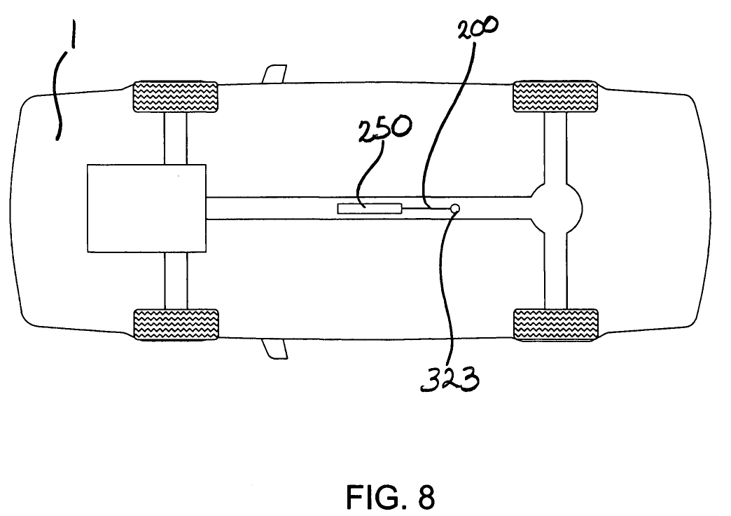

250 Item 7 Central Storage and Processing Unit means as depicted in FIG. 8 as being incorporated into the skeletal system or fame of Q1 Occupant Vehicle (identified as 1 in drawing depictions).

250 Item 7 Central Storage and Processing Unit means receives, stores and transmits all internal sensor detections from SB location, also known as 110 Sensor B Weight Detection, 120 Sensor C Height Detection means, 130 Sensor D Breathing Detection means, 140 Sensor E Heart Rate Detection means, applied to 290 Item 5 Trunk Board of vehicle Region P Trunk of Vehicle and is internally located with in Q1 Occupant Vehicle, 110 Sensor B Weight Detection means located in Regions F Front Drivers Position, Region X Front Passengers Position, Region O Rear Drivers Position, Region G Rear Passenger Position and that are incorporated into 240 Item 2 Car Seat or Couch, 280 Item 4 Floor Boards, 120 Sensor C Height Detection means located in Region F Front Drivers Position, Region X Front Passengers Position, Region O Rear Drivers Position and Region G Rear Passenger Position incorporated into 260 Item 3 Car Seat Back Rest and 130 Sensor D Breathing Detection means, 140 Sensor E Heart Rate Detection means located in Region F Front Drivers Position, Region X Front Passengers Position, Region O Rear Drivers Position and Region G Rear Passenger Position incorporated into 240 Item 2 Seat Belt Harness Strap of Q1 Occupant Vehicle. As referenced by paragraph [0000].

250 Item 7 Central Storage and Processing Unit means receives, stores and transmits all external sensor detections from SF location, also known as 340 Sensors F Door Counter Sensor means applied to exterior vehicle door jams of Q1 Occupant Vehicle (identified as 1 in drawing depictions) further located and identified as Door 44, Door D, Region G, Rear Passenger Position, Door 23, Door A, Region F, Front Drivers Position, Door 34, Door C, Region O, Rear Drivers Position and Door 54, Door B, Region X, Front Passengers Position placed externally of Q1 Occupant Vehicle (identified as 1 in drawing depictions) door jams.

250 Item 7 Central Storage and Processing Unit means receives, stores and transmits all external sensor detections from SA location, also known as 100 Sensors A Finger Print Detection means as locations of 100 Sensors A Finger Print Detection means are depicted in FIG. 2 as depicted as being presumally located externally of Door 44, Door D, Region G, Rear Passenger Position, Door 23, Door A, Region F, Front Drivers Position, Door 34, Door C, Region O, Rear Drivers Position and Door 54, Door B, Region X, Front Passengers Position.

250 Item 7 Central Storage and Processing Unit means general description consist of the following components but as not to be limited by the description set forth; 250 Item 7 Central Storage and Processing Unit is a high performance Single Board Computer compliant with PC/104 standard and compatible with the PC/AT architecture. It could be supplied with a 486DX 75 MHzor or 66 MHz. The peripherals integrated on board are: SVGA, Ethernet controller, four serial ports, IDE ctrl, FDC, one parallel port (only in alternative to FDC), AT Keyboard port, Real Time Clock and Watch-dog. The System memory is 32MB DRAM. The Bios is located in a FlashEprom and is reprogrammable on-board. The Set-up parameters are saved on EPROM allowing the module to operate with out batteries. The module works with a single +5 V has a power consumption of 1240 ma depending on the processor type. Other peripherals integrated on the module are: AT keyboard port, Real Time Clock and Watch-dog.

Specification Techniques or manufactures recommended description, Embedded Enhanced Bios, Memory Flash-Bios has a capacity of 1 Mega bit, 128 KB of which are used by the Bios and its extensions. The remaining 896KB can be used as Read-Only Disk and to store the OS and the user's program/data. SSD support as Read or R/W disk, Watch-dog management, Set-up in Flash in order to avoid Set-up corruption in field, Virtual Peripheral Support (V.P.S.); this mode allows boot strap from the parallel or serial ports and redirect Keyboard, Video disk onto the serial/parallel ports before booting the operating system. It is also possible to redirect any of these peripherals as default setting.

The above embedded enhanced bios description is recommended to be selected by the judgment of the manufacture skilled in his or her field.

Module's Accessories: TP Ethernet module, Parallel-FDC adaptor module, 2 mm to 2.54 mm IDE cable, IDE to ATA adaptor kit and Cable Kit. The described Module Accessories description is recommended to be selected by the best judgment of the manufacture skilled in his or her field.

Options consist of Custom BIOS, Fast BIOS BOOT, Extended Operating Temperature Range and Custom Connectors. The described option is recommended to be selected by the best judgment of the manufacture skilled in his or her field.

On Board Solid State Disk, Supported Devices, Standard Disk On Chip (DOC), 32 Pin DIL devices are additional recommended Physical Characteristics.

Dimensions of the 250 Item 7 Central Storage and Processing Unit: may consist of but are not limited to the following dimensions as being 90×96 mm (3.6″×3.8″) by those skilled in the art, having a thickness of: 15 mm (0.6″), Power Supply single +5 V, Power consumption: 75 MHz 32MB DRAM: 1.24A@5V typical, 66 MHz 32 MB DRAM: 1.19 A@5V typical or best implemented by those skilled in the art.

Operational Temperature: 0 to 70 C, max 95% humidity N,C.. Extended Temperature Range.

the above physical characteristics and on board solid state disk description is recommended to be selected by the best judgment of the manufacture skilled in his or her field.

The recommended environments for the 250 Item 7 Central Storage and Processing Unit incorporated with in the Q1 Occupant Vehicle (identified as 1 in drawing depictions) or Q2 Policing Unit (identified as 2 in drawing depictions) as described with in the scope of the present invention is as follows or applied to each vehicle according to manufacture recommendations. All components incorporated with in each vehicle type as depicted in FIG. 8 identified as the SenCora Print System are low cost, highly effective, market available central processing units and computer components. 250 Item 7 Central Storage and Processing Unit incorporated with in the Q1 Occupant Vehicle is to be understood as to be central compent that makes up the SenCora Print System.

It is recommended that 250 Item 7 Central Storage and Processing Unit incorporated with in the Q1 Occupant Vehicle (identified as 1 in drawing depictions) or Q2 Policing Unit (identified as 2 in drawing depictions) as depicted in FIG. 1, FIG. 8 and FIG. 9 as are located on the interior side of the vehicle are be made to endure and conform to temperatures of −40 degrees Celsius to +85 degrees Celsius. With a vibration stress lever being or reduced levels, able to with stand water spray, with a thermal shock factor of reduced rate of change as well as other protective factors that would enhance the life of each component under normal to extreme vehicle circumstances.

It is further recommended that 250 Item 7 Central Storage and Processing Unit incorporated with in the Q1 Occupant Vehicle (identified as 1 in drawing depictions) or Q2 Policing Unit (identified as 2 in drawing depictions) if being externally placed of the vehicle be made to endure and conform to the recommendation temperatures of −40 degrees Celsius to +125 degrees Celsius. Vibration stress per component with in the SenCora Print System should be able to with stand server to extreme vibration conditions. Each sensor and component should be able to with stand water and saltwater sprays, oils, brake fluids, solvents, and fuels, ect. Thermal shock of high-temperature operation plus frequent cold-water splashing as well as being equipped with a variance of other protective factors that would enhance the life of each component under normal to extreme vehicle circumstances.

All components described with in the scope of the current invention located internally or externally is recommended to have a 100% operational level of activity and a 10 to 15 year life span.

With in the scope of the present invention once the entering occupant enters the Q1 Occupant Vehicle equipped with the SenCora Print System the following Sensors are impacted by the occupant entering and the vehicle. The following sensors types incorporated externally and internally of Q1 Occupant Vehicle (identified as 1 in drawing depictions) are impacted by action of direct contact by the occupant, as being SF location, also known as 340 Sensors F Door Counter Sensor means, entrance of occupant causes an impact of action to 300 Item 6 Exterior Vehicle Door Handles also known as door location, Door 23, Door A, Region F, Front Drivers Position, occupant sitting causes an impact of action to 110 Sensor B Weight Detection mat incorporated with in the 240 Item 2 Car Seat or Couch, occupant places his feet causing an impact of action to 280 Item 4 Floor Boards of vehicle located in Region F Front Drivers Position, occupant leaning with his back causing an impact of action to 120 Sensor C Height means and 140 Sensor E Heart Rate means incorporated into 260 Item 3 Car Seat Back Rest of Region F, Front Drivers Position, occupant places over his chest causing an impact of action to 130 Sensor D Breathing means and 140 Sensor E Heart Rate means both incorporated into Item 1 Seat Belt Harness Strap and SA location, also known as 100 Sensors A Finger Print Detection Sensors means as applied to 310 Item 12 Steering Wheel Grip Post located in Region F, Front Drivers Position. Once occupant enters and occupies the occupant vehicle and all sensors incorporated with in the occupant vehicle are impacted with an action of impact a wireless communication of the impact caused by the occupant is transmitted to corresponding Micro Controller Nodes for further data transfer of information. Impacted sensor actions caused by the occupant of the vehicle are transmitted to the next means described and identified as MZ locations, also known as Micro Controller Node Z's. Each sensor receiving an impact of action will cause its related Micro Controller Node Z unit to receive its relative sensor transmit ion from the area of initial impact deriving from each impacted sensor and region of impact.

The Micro Controller Node Z units are activated and receiving an action of impact from the initial point of contact and are transmitted to MZ Micro Controller Node Z Door Counter, MZ Micro Controller Node Z Fingerprint, 160 Micro Controller Node Z Weight, 170 Micro Controller Node Z Height, 180 Micro Controller Node Z Breathing and 190 Micro Controller Node Z Heart Rate.

### 250 Item 7 Central Storage and Processing Means Attached to the Vehicle

FIG. 8 depicts 250 Item 7 Central Storage and Processing Unit, as being applied to the skeletal system internally located of the Q1 Occupant Vehicle to be in one manor the best described method for applying the present invention. Depicted in FIG. 8

In perspective to 250 Item 7 Central Storage and Processing Unit, applied to the skeletal system (internally located within Q1 Occupant Vehicle). 250 Item 7 Central Storage and Processing Unit can be applied to or incorporated onto the skeleton system by graphing, under laid, gluing, bolting or any other means necessary needed by those skilled in the art.

The 250 Item 7 Central Storage and Processing Unit means is recommended as to be sandwiched between the skeleton frame of the occupant vehicle and the interior surface of the Q1 Occupant Vehicle (identified as 2 in drawing depictions) as to be incorporated into the furniture fixtures of the interior surface frunishings of the Q1 Occupant Vehicle.

As described in prior paragraphs [0000], [0000], [0000] and [0000] the 250 Item 7 Central Storage and Processing Unit is recommended to be contained by the following method but as to be understood that the containment of the 250 Item 7 Central Storage and Processing Unit and the application there of is left to those skilled in the present art.

(Refer to Paragraphs that Discuss Attachment by Bonding, Glue ect.)

250 Item 7 Central Storage and Processing Unit means is applied to skeleton system of Q1 Occupant Vehicle (identified as 1 in drawing depictions) and collects, stores and transmits all sensor actions of impacts applied by the occupant's body that have occurred externally or internally of the vehicle.

250 Item 7 Central Storage and Processing Unit means is located between the skeleton frame of the occupant vehicle and the interior surface of the Q1 Occupant Vehicle (identified as 1 in drawing depictions) as to be incorporated into the furniture fixtures of the interior surface furnishings of the Q1 Occupant Vehicle (identified as 1 in drawing depictions).

250 Item 7 Central Storage and Processing Unit means collects, receives, stores, data files and transmits all impacted sensor actions that have occurred with in the occupant vehicle.

Sensor data collected by 250 Item 7 Central Storage and Processing Unit means can there for be transmitted, accessed (as to be extracted) by external forces identified as Q2 Policing Vehicles (identified as 2 in drawing depictions) and or 320 S1 Governing Authority Stations.

First point of data extraction can occur from Q2 Policing Units (identified as 2 in drawing depictions) who are policing vehicles that are equipped with the SenCora Print System designed to receive, view and transmit all sensor activities that are or have occurred with in the Q1 Occupant Vehicle (identified as 1 in drawing depictions) equipped with the SenCora Print System.

Q2 Policing Units (identified as 2 in drawing depictions) equipped with the SenCora Print System gains access (as to extract) Q1 Occupant Vehicle (identified as 2 in drawing depictions) (equipped with the SenCora Print System) sensor activities via wireless transmission means.

Q2 Policing Unit's 250 Item 7 Central Storage and Processing Unit means releases a request to access the 250 Item 7 Central Storage and Processing Unit means located with in the Q1 Occupant Vehicle (identified as 2 in drawing depictions).

Q2 Policing Unit's 250 Item 7 Central Storage and Processing Unit means wireless transmittal request contains such information that allows an entrance to the Q1 Occupant Vehicle's 250 Item 7 Central Storage and Processing Unit means.

Information contained within the transmittal request to enter Q1 Occupant's Vehicle (identified as 1 in drawing depictions) from the Q2 Policing Unit (identified as 2 in drawing depictions) is as follows. Policing Officers identifying code, sensor request type to be viewed and data transmission outlining time and date information was requested by Q2 Policing Unit's 250 Item 7 Central Storage and Processing Unit means.

Q1 Occupant Vehicle's 250 Item 7 Central Storage and Processing Unit means receives the wireless transmission means and proceeds forward with initial information extracted from Q1 Occupant Vehicle's 250 Item 7 Central Storage and Processing Unit means.

Second point of data extraction may occur by external wireless transfer of requested information deriving from the 320 S1 Governing Authority Station.

320 S1 Governing Authority Stations are governing authority stations that are equipped with the SenCora Print System and are placed in stationary locations as to receive, view and transmit sensor activities that are or have occurred with in the Q1 Occupant Vehicle (identified as 1 in drawing depictions) equipped the SenCora Print System as well as the Q2 Policing Units (identified as 2 in drawing depictions) equipped with the SenCora Print System.

The 320 S1 Governing Authority Station is equipped with the SenCora Print System. 320 S1 Governing Authority Station is equipped with the SenCora Print System gains access (as to extract) Q1 Occupant Vehicle (identified as 1 in drawing depictions) and Q2 Policing Units (identified as 2 in drawing depictions) (equipped with the SenCora Print System) sensor activities via wireless transmission means.

320 S1 Governing Authority Station's 250 Item 7 Central Storage and Processing Unit means releases a request to access the 250 Item 7 Central Storage and Processing Unit means located with in the Q1 Occupant Vehicle (identified as 1 in drawing depictions) as well as the Q2 Policing Unit's (identified as 2 in drawing depictions) vehicle.

320 S1 Governing Authority Station's 250 Item 7 Central Storage and Processing Unit means wireless transmittal request contains such information that allows an entrance into the Q1 Occupant Vehicle (identified as 2 in drawing depictions) and the Q2 Policing Unit's 250 Item 7 Central Storage and Processing Unit means.

Information contained within the transmittal request from the 320 S1 Governing Authority Station to enter Q1 Occupant Vehicle (identified as 1 in drawing depictions) and the Q2 Policing Unit's (identified as 2 in drawing depictions) vehicle is as follows. 320 S1 Governing Authority Station's identifying code, sensor request type to be viewed and data transmission outlining time and date information was requested by both 320 S1 Governing Authority and Q2 Policing Unit's 250 Item 7 Central Storage and Processing Unit means.

320 S1 Governing Authority Station's 250 Item 7 Central Storage and Processing Unit means receives the wireless transmission means and proceeds forward with initial information extracted from both the Q1 Occupant Vehicle's (identified as lin drawing depictions) and Q2 Policing Vehicle's 250 Item 7 Central Storage and Processing Unit means.

Process of Action from Internal Q1 Occupant Vehicle Activities to External Q2 Policing, S2 Transmission Towers and 320 S1 Governing Authorities.

With in the scope of the present invention entering occupant enters Q1 Occupant Vehicle (identified as 1 in drawing depictions) equipped with the SenCora Print System impacting the following sensors. The following sensor types incorporated externally and internally of Q1 Occupant Vehicle (identified as 1 in drawing depictions) and are impacted by action of direct contact by the occupant, as being externally located SF location, also known as 340 Sensors F Door Counter Sensor means, externally located SA location, also known as 100 Sensor A Finger Print Detection means, entrance of occupant causes an impact of action to 300 Item 6 Exterior Vehicle Door Handles also known as door location, Door 23, Door A, Region F, Front Drivers Position, occupant sitting causes an internally located impact of action to 110 Sensor B Weight Detection means incorporated with in the 240 Item 2 Car Seat or Couch, occupant places his feet causing an internally located impact of action to 110 Sensor B Weight Detection means incorporated with in the 280 Item 4 Floor Boards of vehicle located in Region F Front Drivers Position, occupant leaning with his back causing an internally located impact of action to 120 Sensor C Height means and 140 Sensor E Heart Rate means incorporated into 260 Item 3 Car Seat Back Rest of Region F, Front Drivers Position, occupant places over his chest causing an internally located impact of action to 130 Sensor D Breathing means and 140 Sensor E Heart Rate means incorporated into 230 Item 1 Seat Belt Harness Strap and SA location, also known as 100 Sensors A Finger Print Detection Sensors means as applied to 310 Item 12 Steering Wheel Grip Post located in Region F, Front Drivers Position. Once occupant enters and occupies the occupant vehicle and all sensors incorporated with in the occupant vehicle are impacted with an action of impact a wireless communication of the impact caused by the occupant sensor activities can be accessed by the Q2 Policing Unit and or the 320 S1 Governing Authority Station.

Each of the described sensors impacted by an action of impact has occurred externally and internally of the Q1 Occupant Vehicle (identified as 1 in drawing depictions) and is recorded with in the 250 Item 7 Central Storage and Processing Unit of the Q1 Occupant Vehicle.

Q2 Policing Units (identified as 2 in drawing depictions) who are policing vehicles equipped with the SenCora Print System are designed to receive, view and transmit all sensor activities that are or have occurred with in the Q1 Occupant Vehicle (identified as 1 in drawing depictions) as being fully equipped with the SenCora Print System consisting of the 250 Item 7 Central Storage and Processing Unit.

Q2 Policing Units is in range location of Q1 Occupant Vehicle.

Range location of Q1 Occupant Vehicle (identified as 1 in drawing depictions) and Q2 Policing Unit (identified as 2 in drawing depictions) is best determined by those skilled in the art as range location is determined by a variation of wireless means that may be best implemented with in the scope of the current invention by those skilled in the present art.

Q2 Policing Vehicle's (identified as 2 with in drawing description) 250 Item 7 Central Storage and Processing Unit request sensor data attributes from Q1 Occupant Vehicle's (identified as 1 with in drawing description) 250 Item 7 Central Storage and Processing Unit, depicted by Path 12.

Q2 Policing Units (identified as 2 in drawing depictions) equipped with the SenCora Print System gains access (as to extract) Q1 Occupant Vehicle (equipped with the SenCora Print System) sensor activities via wireless transmission means depicted by Path 12.

Q2 Policing Unit's 250 Item 7 Central Storage and Processing Unit means releases a request to access the 250 Item 7 Central Storage and Processing Unit means located with in the Q1 Occupant Vehicle (identified as 1 in drawing depiction) also depicted by Path 12.

Q2 Policing Unit's 250 Item 7 Central Storage and Processing Unit means wireless transmittal request contains such information that allows an entrance into the Q1 Occupant Vehicle's 250 Item 7 Central Storage and Processing Unit means.

Information contained within the transmittal request to enter Q1 Occupant's Vehicle's 250 Item 7 Central Storage and Processing Unit sent by Q2 Policing Unit's 250 Item 7 Central Storage and Processing Unit is as follows. Policing Officers identifying code, sensor request type to be viewed and data transmission outlining time and date information was requested by Q2 Policing Unit's 250 Item 7 Central Storage and Processing Unit means.

Q1 Occupant Vehicle's 250 Item 7 Central Storage and Processing Unit means sends via wireless transmission means and proceeds forward with releasing initial attribute detected information extracted from Q1 Occupant Vehicle's 250 Item 7 Central Storage and Processing Unit means.

Q2 Policing Officer's identifying code, sensor request type to be viewed and data transmission outlining time and date information was received via wireless transmission is received by Q1 Occupant Vehicle's 250 Item 7 Central Storage and Processing Unit means. Path 12 shows the indicated route of sensor attribute request via wireless request means from the Q2 Policing Unit's (identified as 2 in drawing depictions) 250 Item 7 Central Storage and Processing Unit to Q1 Occupant Vehicle's (identified as 1 in drawing depictions) 250 Item 7 Central Storage and Processing Unit.

Q2 Policing Officer's identifying code, sensor request type to be viewed and data transmission outlining time and date information is downloaded and stored with in the Q1 Occupant Vehicle's 250 Item 7 Central Storage and Processing Unit for Q1 Occupant Vehicle's owner's future viewing to be obtained by request of records from Department of Motor Vehicle request.

Q2 Policing Vehicle (identified as 2 with in drawing description) 250 Item 7 Central Storage and Processing Unit receives sensor data attributes from Q1 Occupant Vehicle (identified as 1 with in drawing description) 250 Item 7 Central Storage and Processing Unit, depicted by Path 8.

Q1 Occupant Vehicle's (identified as 1 in drawing depictions) 250 Item 7 Central Storage and Processing Unit releases last received occupant sensor detected attributes request as being downloaded to Q2 Policing Unit's 250 Item 7 Central Storage and Processing Unit as; externally located SF location, 340 Sensors F Door Counter Sensor means, Door 23, Door A, Region F, Front Drivers Position, Door Status Open, Date and Time, externally located SA location, 100 Sensor A Finger Print Detection means, entrance of occupant to 300 Item 6 Exterior Vehicle Door Handles door location, Door 23, Door A, Region F, Front Drivers Position, finger print detection code or finger print pattern match priorly stored, internally located action to 110 Sensor B Weight Detection mat incorporated with in the 240 Item 2 Car Seat or Couch, Approximate Weight, internally located impact of action to 280 Item 4 Floor Boards of vehicle located in Region F Front Drivers Position, approximate weight, internally located impact of action to 120 Sensor C Height means and 140 Sensor E Heart Rate means incorporated into 260 Item 3 Car Seat Back Rest of Region F, Front Drivers Position, Approximate Height and Heart Rate per beat, internally located impact of action to 130 Sensor D Breathing means and 140 Sensor E Heart Rate means incorporated into 230 Item 1 Seat Belt Harness Strap, Indicated breathing detection and SA location, 100 Sensors A Finger Print Detection Sensors means as applied to 310 Item 12 Steering Wheel Grip Post located in Region F, Front Drivers Position, finger print detection code or finger print pattern match pre-stored and personal data of owner of vehicle released via wireless transmission to 250 Item 7 Central Storage and Processing Unit to the Q2 Policing Unit (identified as 2 in drawing depictions).

Q2 Policing Unit observing officer views the received sensor detections obtained from the 250 Item 7 Central Storage and Processing Unit of the Q1 Occupant Vehicle (identified as 1 in drawing depiction) as depicted in Path 8.

Q2 Policing Unit (identified as 2 in drawing depictions) observing officer views received sensor detections obtained from the 250 Item 7 Central Storage and Processing Unit of the Q1 Occupant Vehicle (identified as 1 in drawing depictions) on a viewing monitor with in the Q2 Policing Unit (identified as 2 in drawing depictions).

Q2 Policing Unit observing officer views the received sensor detections obtained from the 250 Item 7 Central Storage and Processing Unit of the Q1 Occupant Vehicle (identified as 1 in drawing depictions) on a viewing monitor with in the Q2 Policing Vehicl (identified as 2 in drawing depictions), as to determine whether or not it is safe to approach the Q1 Occupant Vehicle (identified as 1 in drawing depictions) based on detected sensor attributes observed by Q2 Policing Unit observance of Q1 Occupant Vehicle attribute detections:such as heart rate and breathing detections. These attributes if observed to be above normal or indicated as being to fast for a normal human being, would give the Q2 Policing Unit (identified as 2 in drawing depictions) officer in observance of such attributes indication that it may not be safe to approach the Q1 Occupant Vehicle (identified as 2 in drawing depictions) alone.

Q2 Policing Unit officer would then observe other action impacted sensor readings such as approximate weight, height and detectable finger print patterns or assigned fingerprint codes to determine seating position and projected size of the individual or individuals they may need to approach as seated with in the Q1 Occupant Vehicle (identified as 1 in drawing depictions).

Approximated height ranges, breathing detection range, setting locations, weight range settings, assigned numeric finger print numbers for finger print coding (for non finger print pattern identified and heart rate range settings are implemented by those skilled in the present art.

Q2 Policing Vehicle (identified as 2 with in drawing description) 250 Item 7 Central Storage and Processing Unit sends via wireless communication means to 330 S2 Transmission and Relay Tower requesting that 320 S1 Governing Authority Station verify all requested sensor data attributes and personal Q1 Occupant Vehicle (identified as 1 with in drawing description) owner and family data history, as to be matched with detection readings as transmitted from with in the 250 Item 7 Central Storage and Processing Unit located with in the Q1 Occupant Vehile, depicted by Path 10 from Q2 Policing Vehilce's (identified as 2 with in drawing description) 250 Item 7 Central Storage and Processing Unit.

Q2 Policing Vehicle's (identified as 2 with in drawing description) 250 Item 7 Central Storage and Processing Unit wireless communication means to 330 S2 Transmission and Relay Tower requesting that 320 S1 Governing Authority Station to verify all requested sensor data attributes and personal Q1 Occupant Vehicle (also identified as 1 with in drawing description) owner and family data history be matched with detection readings; where said information is also depicted as Path 10 as from Q2 Policing Vehicle (also identified as 2 with in drawing description). Relayed as said attribute information transmitted via wireless means are as displayed on the viewing monitor of the Q2 Policing Units view monitor as externally located SF location, 340 Sensors F Door Counter Sensor means, Door 23, Door A, Region F, Front Drivers Position, Door Status Open, Date and Time, externally located SA location, 100 Sensor A Finger Print Detection means, entrance of occupant to 300 Item 6 Exterior Vehicle Door Handles door location, Door 23, Door A, Region F, Front Drivers Position, finger print detection code or finger print pattern match priorly stored, internally located action to 110 Sensor B Weight Detection mat incorporated with in the 240 Item 2 Car Seat or Couch, Approximate Weight, internally located impact of action to 280 Item 4 Floor Boards of vehicle located in Region F Front Drivers Position, approximate weight, internally located impact of action to 120 Sensor C Height means and 140 Sensor E Heart Rate means incorporated into 260 Item 3 Car Seat Back Rest of Region F, Front Drivers Position, Approximate Height and Heart Rate per beat, internally located impact of action to 130 Sensor D Breathing means and 140 Sensor E Heart Rate means incorporated into 230 Item 1 Seat Belt Harness Strap, Indicated breathing detection and SA location, 100 Sensors A Finger Print Detection Sensors means as applied to 310 Item 12 Steering Wheel Grip Post located in Region F, Front Drivers Position, finger print detection code or finger print pattern match pre-stored and personal data of owner of vehicle; trans mitted to 330 S2 Transmission and Relay Tower depicted by Path 10.

The 330 S2 Transmission and Relay Tower further sends to 320 S1 Governing Authority Station to verification request of sensor data attributes and personal Q1 Occupant Vehicle (also identified as 1 with in drawing description) owner and family data history be matched with detection readings (filed with in the Q1 Occupant Vehicles 250 Item 7 Cnetral Storage and Processing Unit as down loaded by the Q2 Policing Unit's 250 Item 7 Cnetral Storage and Processing Unit); where said information is identified as Path 14 from 330 S2 Transmission and Relay Tower.

320 S1 Governing Authority Station responds to Q2 Policing Vehicle's (also identified as 2 with in drawing description) 250 Item 7 Central Storage and Processing Unit by sending completed identity match information as well any new finding to 330 S2 Transmission and Relay Tower Depicted in Path 9 from 320 S1 Governing Authority Station as depicted by Path 9.

330 S2 Transmission and Relay Tower transmits completed identity match information as well any new finding to Q2 Policing Vehicle's (also identified as 2 with in drawing description) 250 Item 7 Central Storage and Processing Unit for review identified by Path 19.

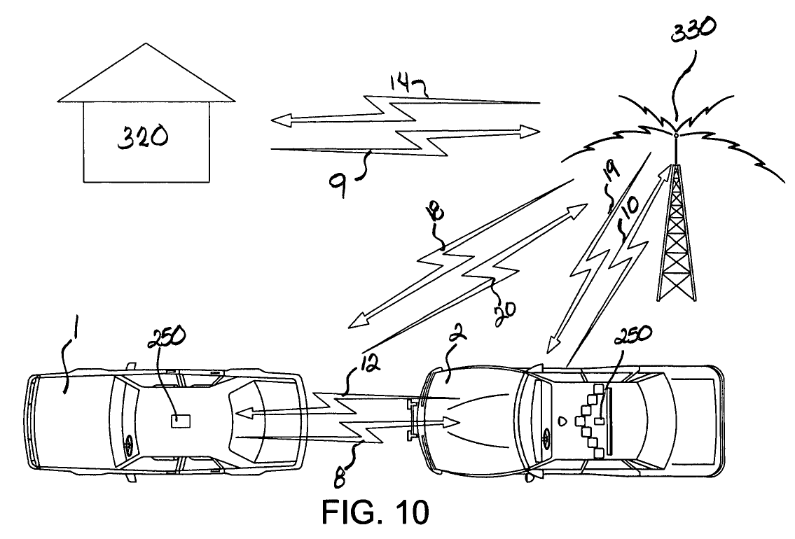

Q2 Policing Unit identifies that Q1 Occupant Vehicle is fleeing the area of observation as obdserved in FIG. 10.

Q2 Policing Vehicle's (also identified as 2 with in drawing description) 250 Item 7 Central Storage and Processing Unit request that 320 S1 Governing Authority Station disables the 203 Ignition On, Ignition Off Demand of the Q1 Occupant Vehicle (also identified as 1 with in drawing description) this request sent to 330 S2 Transmission and Relay Tower transmitting identified as depicted by Path 10.

330 S2 Transmission and Relay Tower further relays to 320 S1 Governing Authority Station request to disable the 203 Ignition On, Ignition Off Demand of the Q1 Occupant Vehicle (also identified as 1 with in drawing description) identified by Path 14.

320 S1 Governing Authority Station receives request from 330 S2 Transmission and Relay Tower to disable 203 101 identified as the Ignition Off Demand of the Q1 Occupant Vehicle (also identified as 1 with in drawing description) also depicted as Path 14.

320 S1 Governing Authority Station receives request from 330 S2 Transmission and Relay Tower to disable 203 101 identified as the Ignition Off Demand of the Q1 Occupant Vehicle (also identified as 1 with in drawing description) and grants the request to disable Q1 Occupant Vehicle also depicted as Path 14.

320 S1 Governing Station sends the granted response to disarm 203 101, Ignition On, Ignition Off of the Q1 Occupant Vehicle (also identified as I with in drawing description) and sends granted response to 330 S2 Transmission and Relay Tower to be forwarded to Q2 Policing Vehicle's (also identified as 2 with in drawing description) 250 Item 7 Central Storage and Processing Unit whom initial request was made as depicted by Path 9.

330 S2 Transmission and Relay Tower forwards request to disables the 203 Ignition On, Ignition Off Demand of the Q1 Occupant Vehicle (also identified as 1 with in drawing description) to both Q2 Policing Vehicle's (also identified as 2 with in drawing description) 250 Item 7 Central Storage and Processing Unit and Q1 Occupant Vehicle's (also identified as 1 with in drawing description) 250 Item 7 Central Storage and Processing Unit as depicted by both Path 19 and Path 18.

330 S2 Transmission and Relay Tower downloads request to disable the 203 Ignition On, Ignition Off Demand of Q1 Occupant Vehicle's (also identified as 1 with in drawing description) and Q2 Policing Vehicle's (also identified as 2 with in drawing description) 250 Item 7 Central Storage and Processing Units identified by Path 19 and Path 18.

Q1 Occupant Vehicle's (also identified as 1 with in drawing description) and Q2 Policing Vehicle's (also identified as 2 with in drawing description) 250 Item 7 Central Storage and Processing Units both receives the demand to disarm the 203 Ignition On, Ignition Off Demand of the Q1 Occupant Vehicle (also identified as 1 with in drawing description) as relayed by 330 S2 Transmission and Relay Tower in response Q1 Occupant Vehicle (also identified as 1 with in drawing description) comes to a rolling stop.

This concludes actions as they pertain to the SenCora Print System and its intended use. Please note that the internal devices, methods and means of delivery are left to those skilled in the present art and are to be conyed as such. This system is designed to use means of devices that are and can be interchangeable for its current use in today's society but used with in the current invention as intended objective.

I claim:

1. I claim in claim I An On Board Human Sensor Attribute Detection and Relay System incorporated by mounting, gluing, bolting or any other attachment method selected by those of the present art comprising of (A) means for various sensor detection, located with in predetermined positions with in a mobile or stationary object, as to receive and transmit actions of impact as pressure is applied or detected by said means for various sensor detection. (B) means for data transfer, located in predetermined locations internally of a mobile or stationary device, used to receive and transmit actions of impact as pressure is applied or detected by said means for various sensor detection where such received and transmitted actions are further transmitted to the means for data storage and data transmission. (C) means for data storage and data transmission, located in a predetermined location of a mobile or stationary device, used to collect received and transmitted actions of impact as pressure is applied or detected by said means for various sensor detection. (D) means for signal transfer, located in various externally placed locations outside a mobile or stationary object, and used to receive and transmit data from the means for data storage and data transmission, to a predetermined destination. (E) means for data collection review and response located at a stationary or mobile point, used to receive data transmitted by the means for signal transfer, located in various externally placed locations outside a mobile or stationary object, where said transmitted collected data is reviewed and responded to by reverse direction of travel of said means for data collection, reviewed and responded to. (F) Power Control Box, (G) Ingnition On Ignition Off feature, used to switch on or off and mobile or stationary object ignition.

2. In claim I where An On Board Human Sensor Attribute Detection and Relay System incorporated by mounting, gluing, bolting or any other attachment method selected by those of the present art comprising of means for various sensor detection, operating on both wireless and wire bound system and being located with in predetermined positions with in a mobile or stationary object, as to receive and transmit actions of impact as pressure is applied or detected by said means for various sensor detection is a various sensor means more particularly comprised of (a) finger print detection means; to detect attributes of human detectable fingerprint where such fingerprint detection sensors are located within, onto and or beneath the surface of door handles in various locations and steering wheel grip post of mobile or stationary object; (b) means for detecting approximate weight of occupants and as being particularly, operating on both wireless and wire bound system and located within, onto and or beneath the surface of the seating, chair; couch and trunk board of mobile and or stationary object. (c) means for detecting height detection as to detect approximate height of seated occupants where such height detection sensors are operating on both wireless and wire bound system and located within, onto and or beneath the surface of the chair backrest; couch backrest and trunk board of mobile and or stationary object; (d) means for detecting breathing detection as to detect indication of occurrences of breathing where such breathing detection sensors operating on both wireless and wire bound system and are located within, onto and or beneath the surface of harness straps and trunk of mobile or stationary object; (e) means for detecting heart rate detection means to detect indications of occupant heart rate where such heart rate detection sensors are operating on both wireless and wire bound system and located within, onto and or beneath the surface of harness straps, seating, chair or couch and trunk board of mobile or stationary object; (f) means for detecting door detection as to determine if vehicle doors are open or closed where such height detection sensors operating on wireless system and are located on the surface of the door jams of mobile or stationary door objects.

3. In claim I where An On Board Human Sensor Attribute Detection and Relay System incorporated by mounting, gluing, bolting or any other attachment method selected by those of the present art comprising of (B) means for data transfer, identified as micro controller nodes operating on wireless system and located in predetermined locations internally of a mobile or stationary device, used to receive and transmit actions of impact as pressure is applied or detected by said means for various sensor detection where such received and transmitted actions are further transmitted to the means for data storage and data transmission that transfers data by wireless means obtained from impacted means for various sensor detection points located internally of a mobile or stationary object.

4. In claim II where An On Board Human Sensor Attribute Detection and Relay System incorporated by mounting, gluing, bolting or any other attachment method selected by those of the present art comprising of means for data storage and data transmission is identified as central storage and processing unit operating as connects to both wireless and wire bound system and located in a predetermined location of a mobile or stationary device, used to collect received and transmitted actions of impact as pressure is applied or detected by said means for various sensor detection and is a means for data storage and data transmission comprised of a computer device that collects, records and transmits actions received as transmitted by the means for data transfer when the various sensor detection is impacted with an action of impact or indicated detection has been detected from the sensor region.

5. In claim II where, wireless system located with in a mobile or stationary object carries detected signals from means for various sensor detection, located in predetermined locations with in a mobile or stationary object to means for data storage and data transmission, located with in the mobile or stationary object.

6. In claim III where, wireless system located with in a mobile or stationary object carries detected signals to means for data storage and data transmission identified as central storage and processing unit located in a mobile or stationary object out side a mobile or stationary object.

7. In claim I where, means for data collection review and response, identified as a governing authority station receives wireless system transmittal from means for data storage and data transmission identified as central storage and processing unit located with in a mobile or stationary object.

8. In claim XIIII where, wireless system located with in a mobile or stationary object carries detected signals to means for data collection review and response, identified as a governing authority station located at a stationary or mobile point, used to receive data transmitted by the means for signal transfer, and as located in various externally placed locations outside a mobile or stationary object, where said transmitted collected data is reviewed and responded to by reverse direction of travel of said means for data collection, review and response.

9. In claim II where An On Board Human Sensor Attribute Detection and Relay System incorporated by mounting, gluing, bolting or any other attachment method selected by those of the present art comprising of wireless system as to carry detected signals to means for various sensor detection also identified further known as (b) means for detecting approximate weight of occupants and as being particularly, operating on both wireless and wire bound system and located within, onto and or beneath the surface of the seating, chair; couch and trunk board of mobile and or stationary object. (c) means for detecting height detection as to detect approximate height of seated occupants where such height detection sensors are operating on both wireless and wire bound system and located within, onto and or beneath the surface of the chair backrest; couch backrest and trunk board of mobile and or stationary object; (d) means for detecting breathing detection as to detect indication of occurrences of breathing where such breathing detection sensors operating on both wireless and wire bound system and are located within, onto and or beneath the surface of harness straps and trunk of mobile or stationary object; (e) means for detecting heart rate detection means to detect indications of occupant heart rate where such heart rate detection sensors are operating on both wireless and wire bound system when additional power is needed and as being located within, onto and or beneath the surface of harness straps, seating, chair or couch and trunk board as to relay power to the means for data storage and data transmission identified as a central storage and processing unit of mobile or stationary object.

10. In claim I where An On Board Human Sensor Attribute Detection and Relay System incorporated by mounting, gluing, bolting or any other attachment method selected by those of the present art comprising of means for data storage and data transmission is connected to a wire bound system that carries a more robust power supply to the means for data storage and data transmission identified as central storage processing unit located with in a mobile or stationary object.

11. In claim I where An On Board Human Sensor Attribute Detection and Relay System incorporated by mounting, gluing, bolting or any other attachment method selected by those of the present art comprising of wire bound system as to deliver a more robust power supply to the means for various sensor detection also identified further known as (b) means for detecting approximate weight of occupants and as being particularly, operating on both wireless and wire bound system and located within, onto and or beneath the surface of the seating, chair; couch and trunk board of mobile and or stationary object. (c) means for detecting height detection as to detect approximate height of seated occupants where such height detection sensors are operating on both wireless and wire bound system and located within, onto and or beneath the surface of the chair backrest; couch backrest and trunk board of mobile and or stationary object; (d) means for detecting breathing detection as to detect indication of occurrences of breathing where such breathing detection sensors operating on both wireless and wire bound system and are located within, onto and or beneath the surface of harness straps and trunk of mobile or stationary object; (e) means for detecting heart rate detection means to detect indications of occupant heart rate where such heart rate detection sensors are operating on both wireless and wire bound system when additional power is needed and as being located within, onto and or beneath the surface of harness straps, seating, chair or couch and trunk board of mobile or stationary object.

12. In claim II where An On Board Human Sensor Attribute Detection and Relay System incorporated by mounting, gluing, bolting or any other attachment method selected by those of the present art comprising of wire bound system is connected to a power control box as to carry a more robust power supply to power control box.

13. In claim II where An On Board Human Sensor Attribute Detection and Relay System incorporated by mounting, gluing, bolting or any other attachment method selected by those of the present art comprising of power control box system, connects and contains multiple wiring connected to a wire bound system as to carry a more robust power supply to the means for various sensor detection also identified as (b) means for detecting approximate weight of occupants and as being particularly, operating on both wireless and wire bound system and located within, onto and or beneath the surface of the seating, chair; couch and trunk board of mobile and or stationary object. (c) means for detecting height detection as to detect approximate height of seated occupants where such height detection sensors are operating on both wireless and wire bound system and located within, onto and or beneath the surface of the chair backrest; couch backrest and trunk board of mobile and or stationary object; (d) means for detecting breathing detection as to detect indication of occurrences of breathing where such breathing detection sensors operating on both wireless and wire bound system and are located within, onto and or beneath the surface of harness straps and trunk of mobile or stationary object; (e) means for detecting heart rate detection means to detect indications of occupant heart rate where such heart rate detection sensors are operating on both wireless and wire bound system and located within, onto and or beneath the surface of harness straps, seating, chair or couch and trunk board of mobile or stationary object.

14. In claim II where An On Board Human Sensor Attribute Detection and Relay System incorporated by mounting, gluing, bolting or any other attachment method selected by those of the present art comprising of means for signal transfer identified as transfer towers operates on wireless system and located in various externally placed locations outside a mobile or stationary object, and used to receive and transmit data from the means for data storage and data transmission, to a predetermined destination connects to the means for data storage and data transmission also operating on wireless system means as to carry said data stored to the means for data collection identified as a governing authority station for review and response of said data to collect received and transmitted actions of impact as pressure is applied or detected by said means for various sensor detection. Where said transmitted collected data is reviewed and responded to by reverse direction of travel of said means for data collection, review and response back to the means for signal transfer.

15. In claim I, Ignition On Ignition Off features responds to means for data storage and data transmission identified as central storage processing unit located with in a mobile or stationary object by wire bound response.

16. In claim I, means for data storage and data transmission delivers demand to Ignition On Ignition Off feature as to shut down or turn on.

17. In claim I means for data storage and data transmission receives demand for Ignition On Ignition Off feature to shut down or turn on from governing authority station via wireless system.
